(19) United States
(12) Patent Application Publication
(10) Pub. No.: US 2019/0324646 A1
(43) Pub. Date: Oct. 24, 2019

(54) MEMORY ACCESS DEVICE, IMAGE-PROCESSING DEVICE, AND IMAGING DEVICE

(71) Applicant: OLYMPUS CORPORATION, Tokyo (JP)

(72) Inventors: Shinsuke Homma, Tokyo (JP); Tomonori Yonemoto, Tokyo (JP); Junichi Shimoyama, Tokyo (JP); Akira Ueno, Tokyo (JP); Tsutomu Kuroki, Tokyo (JP); Tomomi Hirano, Tokyo (JP)

(73) Assignee: OLYMPUS CORPORATION, Tokyo (JP)

(21) Appl. No.: 16/458,499

(22) Filed: Jul. 1, 2019

Related U.S. Application Data
(63) Continuation of application No. PCT/JP2017/001385, filed on Jan. 17, 2017.

(51) Int. Cl. G06F 3/06; G06F 13/16; H04N 5/232

(52) U.S. Cl. CPC G06F 3/064; G06F 3/0604; H04N 5/23229; G06F 3/0673; G06F 13/1668; G06F 3/0659

(57) ABSTRACT

A memory access device for controlling accesses to a memory having a plurality of banks by a plurality of processing blocks including at least one high-priority processing block, connected to a common data bus, and outputting access requests for requesting access to the memory has a memory controller connected to the data bus to control access to the connected memory in response to the access requests while outputting operation information of the memory; and an access selection unit configured to change a designation sequence of the banks according to the operation information at the time when the high-priority processing block continuously accesses the plurality of banks and output the access requests in the changed sequence, wherein the access selection unit is configured to further change the designation sequence according to the changing operation information during a period while the access requests are not accepted by the memory controller.

The present invention relates to a memory access device, an image-processing device, and an imaging device. The present application is a continuation application based on PCT International Application No. PCT/JP2017/001385, filed on Jan. 17, 2017. The content of the PCT International Application is incorporated herein by reference.

### BACKGROUND

### Field of the Technology

In an imaging device such as a still-image camera, a video camera, a medical endoscopic camera, and an industrial endoscopic camera, various types of image-processing are performed by an image-processing device such as a system Large Scale Integration (LSI) mounted thereto. In the image-processing device, a plurality of processing blocks configured to perform the various image processing of the imaging device are incorporated thereto, and each of the plurality of processing blocks is connected to a data bus provided inside the system LSI. Various system LSIs such as the image-processing devices incorporated in the imaging device and the like are configured to incorporate the plurality of processing blocks by sharing a single Dynamic Random Access Memory (DRAM) connected thereto. Each of the plurality of processing blocks is configured to access the DRAM by a Direct Memory Access (DMA) transmission via a data bus. At this time, each of the processing blocks is configured to output an access request to the DRAM by the DMA transmission (that is, a DMA request) and information relating to the access to the DRAM such as addresses and access directions (that is, write-in or read-out).

In the image-processing device configured to have the plurality of processing blocks sharing the single DRAM, an arbitration circuit (that is, a DMA arbitration circuit) configured to arbitrate the access requests of the DMA transmissions output from the incorporated plurality of processing blocks is provided. The arbitration circuit is configured to control the actual access with respect to the DRAM while suitably arbitrating the access requests of the DMA transmissions output from the incorporated plurality of processing blocks. Basically, the arbitrating circuit is configured to determine if the processing block accepts (permit) the access request with respect to the DRAM according to a priority level indicating priority orders of the plurality of processing blocks. Accordingly, the system LSI can secure a data stream in the data bus connected to the DRAM, that is, to secure the bus bandwidth by determining the priority level of the processing block configured to access to the DRAM with a high degree of urgency and in a high frequency as a high value. Thus, it is possible to satisfy the performance of the imaging device including the system LSI as a whole system.

There is a limitation in a normal DRAM that a memory region (bank) having the address which is once accessed enters a bank-busy state such that it is necessary to provide a predetermined period (a definite period) before accessing a given bank again. Accordingly, in the image-processing device configured by the plurality of processing blocks sharing the single DRAM, when either of the plurality of processing blocks attempts to access the bank in the bank-busy state, the receipt of the access request output from the processing block is delayed until a timing when the bank-busy state has ended. The access to the DRAM by the processing block which is determined to have a high priority level is the same as the situation above. Thus, in the image-processing device, if the situation in which delay for accepting the access request output from each of the plurality of processing blocks frequently occurs, it is difficult to secure a target bus bandwidth even for a processing block having a high priority level. This is the cause of a defect of the imaging device system having the image-processing device.

Therefore, technology relating to a semiconductor memory device (a multiport memory) is disclosed in Japanese Unexamined Patent Application, First Publication No. 2003-272378. In Japanese Unexamined Patent Application, First Publication No. 2003-272378, a semiconductor memory device having a control circuit (that is, an arbitration circuit) configured to output a busy signal with respect to a port inputting an access request, when the access request is made for accessing the given bank in a core operation. According to the semiconductor memory device disclosed in Japanese Unexamined Patent Application, First Publication No. 2003-272378, it is possible to determine that it costs more time to access the bank in the busy state than that in the normal state, by the notice function of the busy signal from the external of the semiconductor memory device.

### SUMMARY

According to a first aspect of the present invention, a memory access device configured to control access to a memory by a plurality of processing blocks connected to a common data bus, wherein the plurality of processing blocks are configured to output access requests for requesting accesses to the memory whose address space is divided into a plurality of banks, has at least one processing block designated as a high-priority processing block configured to have a higher priority to perform a high priority processing than other processing blocks among the plurality of processing blocks; a memory controller connected to the data bus, the memory controller being configured to control access to the connected memory in response to the accepted access requests while outputting operation information indicating an operation state of the memory; and an access selection unit configured to change a designation sequence of the banks among the plurality of banks according to the operation information at the time when the high-priority processing block continuously accesses the plurality of banks of the memory and output the access requests of the high-priority processing block designating the banks among the plurality of banks in the changed sequence to the memory controller, wherein the access selection unit is configured to further change the designation sequence of the banks according to the changing operation information during a period when the access requests output by the access selection unit are not accepted by the memory controller.

According to a second aspect of the present invention, in the memory access device according to the first aspect, the access selection unit may be configured to change the designation sequence of the banks among the plurality of banks according to the operation information when the high-priority processing block continuously accesses each of the plurality of banks.

According to a third aspect of the present invention, in the memory access device according to the first aspect or the second aspect, the memory controller may be configured to output a plurality of operation information indicating the operation states of the memory, and the access selection unit may be configured to change the designation sequence of the banks among the plurality of banks according to the plurality of operation information.

According to a fourth aspect of the present invention, the memory access device according to any of the first aspect to the third aspect may further have a buffer configured to temporarily store data transmitted between the high-priority processing block and the memory in correspondence with each of the plurality of banks and parallelly request transmission of the stored data in correspondence with each of the plurality of banks, wherein the access selection unit is configured to change the designation sequence of the banks among the plurality of banks according to the operation information when the data is parallelly transmitted to the plurality of banks from the buffer as requested.

According to a fifth aspect of the present invention, in the memory access device according to the fourth aspect, the buffer and the access selection unit may be configured in the high-priority processing block.

According to a sixth aspect of the present invention, in the memory access device according to the fourth aspect, the buffer and the access selection unit may be configured outside of the high-priority processing block.

According to a seventh aspect of the present invention, in the memory access device according to any of the first aspect to the sixth aspect, the memory controller may be configured to output the operation information indicating a predetermined period during which access to the given bank is unavailable after the access request is accepted.

According to an eighth aspect of the present invention, in the memory access device according to any of the first aspect to the seventh aspect, the operation information may indicate whether the bank is in a predetermined period during which access to the given bank is unavailable in each of the plurality of banks, and the access selection unit may be configured to change the designation sequence of the banks among the plurality of banks so as to avoid the access to the bank which is in the predetermined period during which access to the given bank is unavailable according to the operation information.

According to a ninth aspect of the present invention, in the memory access device according to any of the first aspect to the eighth aspect, the operation information may indicate a necessary time until the predetermined period during which access to the given bank is unavailable elapses in each of the plurality of banks, and the access selection unit may be configured to change the designation sequence of the banks among the plurality of banks according to the operation information so as to refrain from avoiding the access to the given bank when the necessary time is shorter than a predetermined threshold value, and avoid the access to the given bank when the necessary time is equal to or longer than the predetermined threshold value.

According to a tenth aspect of the present invention, in the memory access device according to any of the first aspect to the ninth aspect, the memory controller may have an arbitration unit configured to arbitrate the access requests output from the plurality of processing blocks; and a memory access unit configured to control access to the memory, and the operation information may be output by either or both of the arbitration unit and the memory access unit, in response to the access requests accepted by the arbitration unit.

According to an eleventh aspect of the present invention, an image-processing device has a plurality of processing blocks connected to a common data bus, the plurality of processing blocks being configured to output access requests for requesting accesses to a memory whose address space is divided into a plurality of banks, and at least one processing block among the plurality of processing blocks being designated as a high-priority processing block configured to have a higher priority to perform a high priority processing than other processing blocks among the plurality of processing blocks; a memory controller connected to the data bus, the memory controller being configured to control access to the connected memory in response to the accepted access requests while outputting operation information indicating an operation state of the memory; and an access selection unit configured to change a designation sequence of the banks among the plurality of banks according to the operation information at the time when the high-priority processing block continuously accesses the plurality of banks of the memory and output the access requests of the high-priority processing block designating the banks among the plurality of banks in the changed sequence to the memory controller, wherein the access selection unit is configured to further change the designation sequence of the banks according to the changing operation information during a period when the access requests output by the access selection unit are not accepted by the memory controller.

According to a twelfth aspect of the present invention, an imaging device has an image sensor configured to capture an object, generate an image signal and output the image signal; an image-processing device configured to perform image processing with respect to the image signal so as to generate an image of the object; a memory configured to store data processed during the image processing; and a display configured to display the image of the object, wherein the image-processing device has: a plurality of processing blocks connected to a common data bus, the plurality of processing blocks being configured to output access requests for requesting accesses to a memory whose address space is divided into a plurality of banks, and at least one processing block among the plurality of processing blocks being designated as a high-priority processing block configured to have a higher priority to perform a high priority processing than other processing blocks among the plurality of processing blocks; a memory controller connected to the data bus, the memory controller being configured to control access to the connected memory in response to the accepted access requests while outputting operation information indicating an operation state of the memory; and an access selection unit configured to change a designation sequence of the banks among the plurality of banks according to the operation information at the time when the high-priority processing block continuously accesses the plurality of banks of the memory and output the access requests of the high-priority processing block designating the banks among the plurality of banks in the changed sequence to the memory controller, and wherein the access selection unit is configured to further change the designation sequence of the banks according to the changing operation information during a period when the access requests output by the access selection unit are not accepted by the memory controller.

### BRIEF DESCRIPTION OF DRAWINGS

FIG. 1 is a schematic block diagram showing a configuration of an imaging device having an image-processing device with a memory access device according to a first embodiment of the present invention.

FIG. 2 is a schematic block diagram showing a configuration of the memory access device according to the first embodiment of the present invention.

FIG. 3 is a flow chart showing processing procedures for changing access sequences to banks in the memory access device according to the first embodiment of the present invention.

FIG. 4 is a timing chart showing access timings to DRAM in the memory access device according to the first embodiment of the present invention.

FIG. 5 is a flow chart showing processing procedures for changing access sequences to banks in the memory access device according to a second embodiment of the present invention.

FIG. 6 is a timing chart showing access timings to DRAM in the memory access device according to the second embodiment of the present invention.

FIG. 7 is a schematic block diagram showing a configuration of an imaging device having an image-processing device with a memory access device according to a third embodiment of the present invention.

FIG. 8 is a schematic block diagram showing a configuration of an imaging device having an image-processing device with a memory access device according to a fourth embodiment of the present invention.

FIG. 9 is a flow chart showing processing procedures for changing access sequences to banks in the memory access device according to the fourth embodiment of the present invention.

FIG. 10 is a schematic block diagram showing a configuration of an imaging device having an image-processing device with a memory access device according to a fifth embodiment of the present invention.

FIG. 11 is a flow chart showing processing procedures for changing access sequences to banks in the memory access device according to the fifth embodiment of the present invention.

FIG. 12 is a timing chart showing access timings to DRAM in the memory access device according to the fifth embodiment of the present invention.

FIG. 13 is a flow chart showing processing procedures for changing access sequences to banks in the memory access device according to a sixth embodiment of the present invention.

FIG. 14 is a timing chart showing access timings to DRAM in the memory access device according to the sixth embodiment of the present invention.

FIG. 15 is a timing chart showing an example of operation timings of a memory controller configuring the memory access device of the present invention.

### DETAILED DESCRIPTION OF THE EMBODIMENTS

### First Embodiment

Embodiments of the present invention will be described by referring to the enclosed figures. In the description below, a case in which a memory access device according to a first embodiment of the present invention is included in an image-processing device equipped in an imaging device such as a camera configured to capture still images or a camera configured to capture videos.

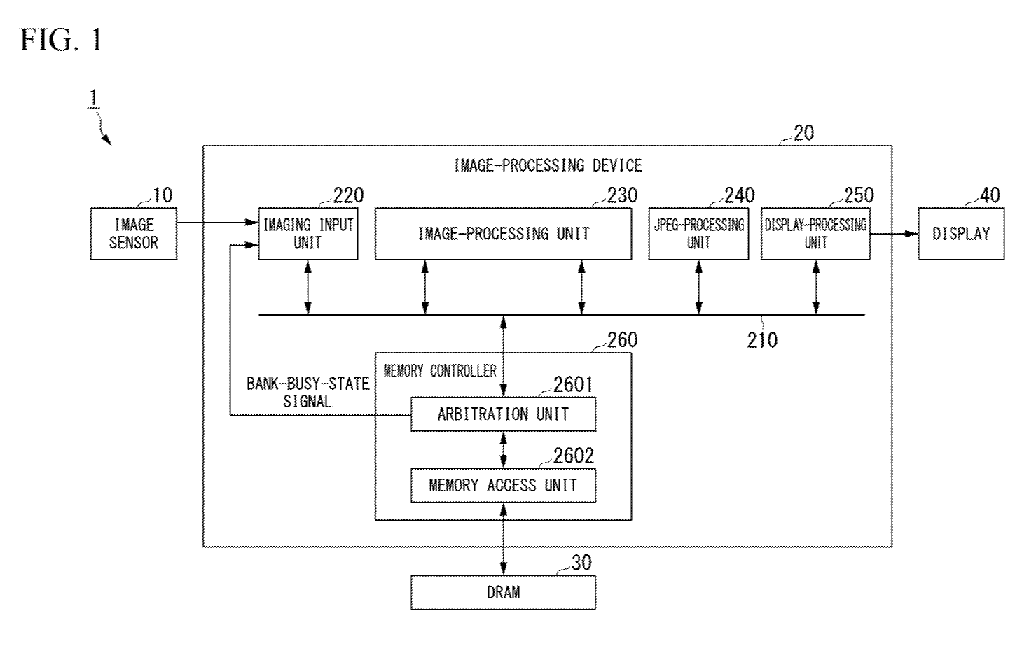

FIG. 1 is a schematic block diagram showing a configuration of an imaging device having an image-processing device with a memory access device according to a first embodiment of the present invention. As shown in FIG. 1, an imaging device 1 has an image sensor 10, an image-processing device 20, a Dynamic Random Access Memory (DRAM) 30, and a display 40. The image-processing device 20 has an imaging input unit 220, an image-processing unit 230, a JPEG-processing unit 240, a display-processing unit 250, and a memory controller 260. In the image-processing device 20, each of the imaging input unit 220, the image-processing unit 230, the JPEG-processing unit 240, the display-processing unit 250, and the memory controller 260 is connected to a common data bus 210. The memory controller 260 has an arbitration unit 2601 and a memory access unit 2602.

The imaging device 1 is configured to capture the still image or the video of an object by the image sensor 10. The imaging device 1 is configured to control the display 40 to display a display image in corresponding to the captured still image. Also, the imaging device 1 is configured to control the display 40 to display the display image in corresponding to the captured video. Further, the imaging device 1 is configured to control a recording medium (not shown) to store a storage image in corresponding to the captured still image and the video.

The image sensor 10 is a solid-state imaging device configured to perform a photoelectric conversion with respect to an optical image of the object formed by a lens (not shown) included in the imaging device 1. For example, the image sensor is the solid-state imaging device represented by a Charge Coupled Device (CCD) image sensor, a Complementary Metal-Oxide Semiconductor (CMOS) image sensor, and the like. The image sensor 10 is configured to output a pixel signal in response to the captured optical image of the object to the imaging input unit 220 included in the image-processing device 20.

The DRAM 30 is a memory (data storage unit) configured to store the various data to be processed in the image-processing device 20 included in the imaging device 1. The DRAM 30 is connected to the data bus 210 via the memory controller 260 of the image-processing device 20. The DRAM 30 is configured to store the data of the images in each processing stage in the image-processing device 20. For example, the DRAM 30 is configured to store the pixel data output by the imaging input unit 220 corresponding to the pixel signal output from the image sensor 10. For example, the DRAM 30 is configured to store the image data of the images (still images, videos, display images) generated by the image-processing unit 230 included in the image-processing device 20, the images (storage images, display images) generated by the JPEG-processing unit 240 included in the image-processing device 20, and the like.

The display 40 is a display device configured to display the display images output from the display-processing unit 250 included in the image-processing device 20. The display 40 can be various display devices configured to display the display images with different sizes, that is, with different pixels. For example, the display 40 can be a small display device included in the imaging device 1 and operating as a view finder for confirming the captured object, such as a Thin Film Transistor (TFT) Liquid Crystal Display (LCD) configured to display the VGA (640×480) image, or an Electronic View Finder (EVF), and the like. Also, for example, the display 40 can be a large display device attachable and detachable to the imaging device 1 and configured to display the display images in corresponding to the still images and the videos for confirmation such as a High Definition Television (HDTV) configured to display the full HD (1920x1080) image, or a Ultra High Definition Television (UHDTV) configured to display the 4K2K (3840x2160) image, and the like.

The image-processing device 20 is configured to generate the still images and the videos by performing predetermined image processing to the pixel signals output from the image sensor 10. The image-processing device 20 is configured to generate the display images in corresponding to the generated still images and the videos. The image-processing device 20 is configured to control the display 40 to display the generated display images. The image-processing device 20 can also generate the storage images in corresponding to the generated still images and the videos and the image-processing device 20 can control the recording medium (not shown) to store the generated storage images.

In the image-processing device 20, each of the imaging input unit 220, the image-processing unit 230, the JPEG-processing unit 240, and the display-processing unit 250 is the processing block configured to realize the processing functions of the image processing executed in the image-processing device 20. In the image-processing device 20, each of the imaging input unit 220, the image-processing unit 230, the JPEG-processing unit 240, and the display-processing unit 250 is configured to access the DRAM 30 by a Direct Memory Access (DMA) transmission via the data bus 210. In the image-processing device 20, the memory access device is configured by a combination of the processing blocks and the memory controller 260.

In the image-processing device 20, all of the combination of the imaging input unit 220 and the memory controller 260, the combination of the image-processing unit 230 and the memory controller 260, the combination of the JPEG-processing unit 240 and the memory controller 260, and the combination of the display-processing unit 250 and the memory controller 260 may not be the memory access device according to the first embodiment of the present invention. In the image-processing device 20, a priority order is set to each processing block for indicating a priority sequence to access the DRAM when the image processing is executed, that is, a priority sequence of the DMA transmission. The priority sequence may be different due to the operations performed by the imaging device 1, that is, the operation modes of the imaging device 1. For example, in a case when the operation mode of the imaging device 1 is set to a capture mode for capturing the object, capturing the object and displaying the display images for confirming the captured object, that is, displaying the live view images (through-the-lens images) are required to be performed in real time. In this case, in the image-processing device 20, if the access to the DRAM 30 of the processing blocks by the DMA transmission for realizing the functions need to be processed in real time is kept waiting, a failure will occur in the operation of the imaging device 1 as a system. Accordingly, the image-processing device 20 is configured to set the priority orders of the processing blocks for realizing the functions need to be processed in real time to be high so as to avoid (deny) the DMA transmission of the processing blocks with the high priority orders from being wait. More specifically, the imaging input unit 220 and the display-processing unit 250 in the image-processing device 20 are configured to have the high priority orders. In this case, in the image-processing device 20, the combination of the imaging input unit 220 and the memory controller 260 and the combination of the display-processing unit 250 and the memory controller 260 are the memory access devices according to the first embodiment of the present invention.

In order to make the description below easy to understand, only the combination of the imaging input unit 220 and the memory controller 260 will be described as the memory access device (hereinafter “memory access device 200”) according to the first embodiment of the present invention.

The memory controller 260 is configured to arbitrate access requests (DMA requests) to the DRAM 30 by the DMA transmission from the processing blocks in the image-processing device 20 connected to the data bus 210, and the memory controller 260 is configured to receive and accept the access request to the DRAM 30 from either of the processing blocks. The arbitration unit 2601 is an arbitration circuit (DMA arbitration circuit, arbiter) configured to arbitrate the access request to the DRAM 30 from each of the processing blocks included in the memory controller 260. The arbitration unit 2601 is configured to determine the processing block whose access request to the DRAM 30 is accepted (permitted) among the processing blocks outputting the access request signals according to the priority order of the processing blocks included in the image-processing device 20. The arbitration unit 2601 is configured to output an access reception signal (DMA permission signal) for noticing the acceptance of the access request to the processing block whose access request is accepted (permitted) as a result of the arbitration of the access requests to the DRAM 30 from the processing blocks.

The memory controller 260 is configured to control the delivery of the data between the DRAM 30 and the processing block whose access request is accepted via the data bus 210. The memory access unit 2602 in the memory controller 260 is a DRAM controller configured to perform the data delivery with respect to the DRAM 30 in response to the request of the processing block whose access request is accepted, that is, the memory controller 2602 is the DRAM controller configured to perform the DMA transmission. The memory access unit 2602 is configured to control the DRAM 30 according to information (access information) relating to the access to the DRAM 30 such as addresses and access directions (write in or read out) output by the processing block whose access request is accepted by the arbitration unit 2601. The memory access unit 2602 is configured to transmit (write in) the data output to the data bus 210 from the processing block whose access request is accepted to the DRAM 30, and the memory access unit 2602 is configured to output the data acquired (read out) from the DRAM 30 to the processing block whose access request is accepted.

The memory controller 260 is provided with a function of noticing information indicating operation states of the connected DRAM 30 according to the control with respect to the DRAM 30 in response to the request from the processing block whose access request is accepted. More specifically, the memory controller 260 is provided with the function of noticing the information regarding whether the memory regions (banks) of the DRAM 30 are in a bank-busy state in which the memory regions (banks) of the DRAM 30 cannot be accessed for a predetermined period (a definite period) by each bank of the DRAM 30. The memory controller 260 is configured to output the information (hereinafter “operation information”) indicating the operation state of the DRAM 30 to the imaging input unit 220 which is the processing block configuring the memory access device 200 together with the memory controller 260. In the memory controller 260, either of the arbitration unit 2601, the memory access unit 2602, or other configuration element which is not shown may be configured to output the operation information of the DRAM 30 if they are able to detect the operation state of the connected DRAM 30. As shown in FIG. 1, a configuration of the imaging device 1 including the arbitration unit 2601 in the memory controller 260 for outputting the operation state (hereinafter “bank-busy-state signal”) to the imaging input unit 220 is shown, wherein the operation state indicates whether each bank of the DRAM 30 is in the bank-busy state, and the imaging input unit 220 configures the memory access device 200 together with the memory controller 260.

The operation information of the DRAM 30 output by the memory controller 26 is not limited to the operation state (bank-busy-state signal) indicating whether or not the DRAM 30 is in the bank-busy state, and other information indicating the operation state of the DRAM 30 may be included therein. Another information indicating the operation state of the DRAM 30 may be information instead of the operation information indicating whether or not the DRAM 30 is in the bank-busy state, or information added to the operation information indicating whether or not the DRAM 30 is in the bank-busy state. The other operation information of the DRAM 30 may be output by either of the configuration elements such as the arbitration unit 2601 and the memory access unit 2602 included in the memory controller 260 or other configuration elements which are not shown. In a case when the memory controller 260 is configured to notice the operation state of the DRAM 30 by using various operation information, for example, the memory controller 260 outputs both of the operation information indicating whether or not the DRAM 30 is in the bank-busy state and the other operation information of the DRAM 30, each of the operation information may be output by the same configuration element or by different configuration elements.

The imaging input unit 220 is the processing block configured to make the data of the pixel signal output from the image sensor 10 to be stored (written in) the DRAM 30. The imaging input unit 220 is also the processing block configuring the memory access device 200 according to the first embodiment of the present invention. The imaging input unit 220 is configured to access the DRAM 30 by the DMA transmission when the imaging input unit 220 makes the data of the pixel signal to be stored (written in) the DRAM 30. The imaging input unit 220 is the processing block (hereinafter “high-priority processing block”) to access the DRAM 30 with priority by the DMA transmission having a high priority order.

The imaging input unit 220 is configured to temporarily store the data of the pixel signal (hereinafter “input image data”) output from the image sensor 10. When the imaging input unit 220 outputs the stored input image data to the DRAM 30 and make the DRAM 30 to store (write in) the input image data, firstly, the imaging input unit 220 outputs the access request signal (DMA request signal) for requesting the access to the DRAM 30, the address (DMA address) designating the memory region (including the bank) of the DRAM 30 to which the input image data is to be stored, and the access direction signal (DMA write signal) indicating the access direction when writing to the DRAM 30 to the memory controller 260. At this time, the imaging input unit 220 is configured to change the sequence of designating the banks of the DRAM 30 for storing the input image data according to the bank-busy-state signals output from the memory controller 260.

More specifically, the imaging input unit 220 is configured to change the sequence of designating the banks according to the address together with the access request signal output to the memory controller 260 rather than designating the banks of the DRAM 30 according to a predetermined sequence, so as to avoid accessing to the banks of the DRAM 30 which are in the bank-busy state indicated by the bank-busy-state signal. For example, the imaging input unit 220 is configured to change the sequence of designating the banks of the DRAM 30 according to the output address so as to designate the banks of the DRAM 30 which are not in the bank-busy state indicated by the bank-busy-state signal at first, that is, the banks different from the banks which have been accessed by other processing block and in the bank-busy state.

After the access signal output by the imaging input unit 220 is accepted by the memory controller 260, that is, after the access reception signal (DMA permission signal) from the memory controller 260 is input to the imaging input unit 220, the imaging input unit 220 outputs the input image data corresponding to the designated address among the temporarily stored input image data to the memory controller 260 and the DRAM 30 to make the DRAM 30 to store (write in) the input image data. Accordingly, the imaging input unit 220 can avoid an access limitation in the DRAM 30 that it is necessary to take the predetermined period (a definite period) for accessing the given bank so as to access the DRAM 20 sequentially and thus secure the bus bandwidth for making the DRAM 30 to store (write in) the image data therein.

The imaging input unit 220 may be configured to output data of the image generated by performing predetermined image processing with respect to the pixel signals output from the image sensor 10 as the input image data, to the DRAM 30 via the memory controller 260. In the case of such a configuration, the imaging input unit 220 may be configured to perform the image processing with respect to the temporarily stored input image data at the timing of outputting the temporarily stored input image to the DRAM 30, or the imaging input unit 220 may be configured to perform the image processing with respect to the pixel signal output from the image sensor 10 and then temporarily store the processed pixel signal. The image processing performed by the imaging input unit 220 with respect to the pixel signal output from the image sensor 10 is the preprocessing such as the defect correction, the shading compensation, and the like. However, according to the scope of the present invention, the image processing performed by the imaging input unit 220 with respect to the pixel signal output from the image sensor 10 is not particularly limited.

The image-processing unit 230 is the processing block configured to acquire (read out) the input image data stored in the DRAM 30, generate data of still image (hereinafter “still image data”) and data of video (hereinafter “video data”) by performing predetermined image processing to the acquired input image data, and make the DRAM 30 to store the generated still image data and the video data. The image-processing unit 230 is configured to access the DRAM 30 by the DMA transmission when acquiring (reading out) the input image data from the DRAM 30 and making the DRAM 30 to store (write in) the still image data and the video data.

The image-processing unit 230 is configured to firstly output the access request signals (DMA request signals) for accessing the DRAM 30, the addresses (DMA addresses) designating the memory regions (including the banks) of the DRAM 30 for acquiring the input image data, and the access direction signals (DMA read signals) indicating the access direction of reading the data from the DRAM 30 to the memory controller 260, when the image-processing unit 230 acquires (reads out) the input image data from the DRAM 30. Then, the image-processing unit 230 is configured to temporarily store the input image data read from the DRAM 30 and output by the memory controller 260 after the output access request signals are accepted by the memory controller 260, that is, after the access reception signals (DMA permission signals) are input from the memory controller 260. The image-processing unit 230 is configured to perform the predetermined image processing with respect to the stored input image data to generate the still image data and the video data and temporarily store the generated still image data and the video data.

When the image-processing unit 230 outputs the stored still image data and the video data to the DRAM 30 to control the DRAM 30 to store the still image data and the video data, the image-processing unit 230 is configured to firstly output the access request signals (DMA request signals) for accessing the DRAM 30, the addresses (DMA addresses) designating the memory regions (including the banks) of the DRAM 30 for acquiring the input image data, and the access direction signals (DMA write signals) indicating the access direction of writing the data to the DRAM 30 to the memory controller 260. Then, the image-processing unit 230 is configured to output the still image data and the video data to the memory controller 260 and the DRAM 30, and the image-processing unit 230 is configured to control the DRAM 30 to store (write) the still image data and the video data after the access request signals are output and accepted by the memory controller 260, that is, after the access reception signals (DMA permission signals) are input from the memory controller 260.

The image-processing unit 230 may be configured to perform the image processing with respect to the temporarily stored input image data, or perform the image processing with respect to the input image data read from the DRAM 30 by the memory controller 260 to generate the still image data and the video data and then temporarily store the still image data and the video data, at the time when outputting the still image data and the video data to the DRAM 30. The image processing performed with respect to the input image data by the image-processing unit 230 may be various image-processing with respect to the still image data and the video data such as the noise reduction processing, the YC conversion processing, the resize processing and the like. According to the present invention, the image processing with respect to the input image data by the image-processing 230 is not particularly limited thereto.

The image-processing unit 230 can configure the memory access device according to the first embodiment of the present invention by being combined with the memory controller 260. However, the image-processing unit 230 in the imaging device 1 only has to perform the DMA transmission during the period when other processing blocks with high priority are not accessing the DRAM 30 due to less time constraint for the DMA transmission of the input image data, the still image data, and the video data (there is no necessary to perform the DMA transmission with priority) in the image-processing unit 230. That is, the image-processing unit 230 is the processing block with a lower priority (hereinafter “low-priority processing block”) than that of the imaging input unit 220. Accordingly, the image-processing unit 230 of the imaging device 1 is not configured as the processing block for configuring the memory access device according to the first embodiment of the present invention.

The JPEG-processing unit 240 is the processing block configured to acquire (read) the still image data stored in the DRAM 30, generate the data of the storage image (hereinafter “storage image data”) by performing the Joint Photographic Experts Group (JPEG) compression processing with respect to the acquired still image data for recording the still images, and control the DRAM 30 to store (write) the generated storage image data. The JPEG-processing unit 240 is configured to access the DRAM 30 by the DMA transmission at the time of acquiring (reading) the still image data from the DRAM 30 and at the time of storing (writing) the storage image data to the DRAM 30. The JPEG-processing unit 240 is configured to perform the access by the DMA transmission in the same manner with that of the image-processing unit 230.

Similar to the image-processing unit 230, the JPEG-processing unit 240 may be configured to perform the JPEG compression processing with respect to the temporarily stored still image data, or perform the JPEG compression processing with respect to the still image data read from the DRAM 30 by the memory controller 260 to generate the storage image data and then temporarily store the storage image data, at the time of outputting the storage image data to the DRAM 30. Also, the JPEG-processing unit 240 may be configured to perform the JPEG decompression processing for generating the still image data corresponding to the storage image data stored in the recording medium (not shown).

Similar to the image-processing unit 230, the JPEG-processing unit 240 can configure the memory access device according to the first embodiment of the present invention by being combined with the memory controller 260. However, similar to the image-processing unit 230, the JPEG-processing unit 240 in the imaging device 1 is the low-priority processing block configured to access the DRAM 30 by the DMA transmission with low priority due to less time constraint for acquiring (reading) the still image data from the DRAM 30 and storing (writing) the storage image data to the DRAM 30. Accordingly, the JPEG-processing unit 240 of the imaging device 1 is not configured as the processing block for configuring the memory access device according to the first embodiment of the present invention.

The display-processing unit 250 is the processing block configured to acquire (read) the still image data and the video data stored in the DRAM 30 and control the display 40 to display the display image corresponding to the acquired still image data and the video data. The display-processing unit 250 is configured to access the DRAM 30 by the DMA transmission at the time of acquiring (reading) the still image data and the video data from the DRAM 30. The display-processing unit 250 is configured to access the DRAM 30 by the DMA transmission in the same manner with that of the image-processing unit 230 and the JPEG-processing unit 240.

The display-processing unit 250 may be configured to perform the predetermined display processing with respect to the still image data and the video data read from the DRAM 30 and output by the memory controller 260 to generate the display image, and output the generated display image to the display 40. In such a configuration, the display-processing unit 250 may be configured to perform the display processing at the time of outputting the temporarily stored still image data and the video data to the display 40, or the display-processing unit 250 may be configured to perform the display processing with respect to the still image data and the video data read from the DRAM 30 and output by the memory controller 260 and then temporarily store the processed still image data and the video data. The display processing performed with respect to the still image data and the video data by the display-processing unit 250 may be, for example, the processing of transforming the size of the display image to the image size displayed by the display 40, the processing of superimposing the On Screen Display (OSD) image for showing various information corresponding to the still images and the videos such as the capturing data and time and the like. However, in the present invention, the display processing with respect to the still image data and the video data performed by the display-processing unit 250 is not particularly limited thereto.

The display-processing unit 250 can configure the memory access device according to the first embodiment of the present invention by being combined with the memory controller 260. For example, in the case in which the display-processing unit 250 is the high-priority processing block configured to access the DRAM 30 with priority by the high-priority DMA transmission due to the operation mode of the imaging device 1, the display-processing unit 250 can configure the memory access device according to the first embodiment of the present invention by being combined with the memory controller 260. More specifically, in the case in which the operation mode of the imaging device 1 is the capturing mode for capturing the image of the object, the display-processing unit 250 is the processing block which has to sequentially acquire (read) the still image data and the video data from the DRAM 30 by the DMA transmission for making the display 40 to sequentially display the display images (live view images: through-the-lens images). In this case, similar to the imaging input unit 220, the display-processing unit 250 becomes the high-priority processing block so as to change the sequences for designating the banks of the DRAM 30 in order to read the still image data and the video data according to the bank-busy-state signals output from the memory controller 260, and the display-processing unit 250 becomes the processing block so as to configure the memory access device according to the first embodiment of the present invention. In this case, the display-processing unit 250 is configured to access the DRAM 30 by the DMA transmission in the same manner with that of the imaging input unit 220.

More specifically, the display-processing unit 250 is configured to firstly output the access request signals (DMA request signals) for accessing the DRAM 30, the addresses (DMA addresses) designating the memory regions (including the banks) of the DRAM 30 for acquiring the still image data and the video data, and the access direction signals (DMA read signals) indicating the access direction of reading the data from the DRAM 30, to the memory controller 260, when the display-processing unit 250 acquires (reads out) the still image data and the video data from the DRAM 30. At this time, similar to the imaging input unit 220, the display-processing unit 250 is configured to change the designating sequence for the banks of the DRAM 30 according to the addresses output to the memory controller 260 together with the access request signals rather than designating the banks of the DRAM 30 according to the predetermined sequence, so as to avoid accessing the bank of the DRAM 30 which is in the bank-busy state indicated by the bank-busy-state signal. For example, similar to the imaging input unit 220, the display-processing unit 250 is configured to change the designating sequence for the banks according to the output addresses so as to firstly designate the banks of the DRAM 30 which is not in the bank-busy state indicated by the bank-busy-state signals. That is, similar to the imaging input unit 220, the display-processing unit 250 is configured to change the designating sequence of the banks due to the output addresses so as to designate the banks different from the banks which are already accessed by other processing blocks to be in the bank-busy state.

The display-processing unit 250 is configured to temporarily store the still image data and the video data read from the DRAM 30 and output by the memory controller 260 after the output access request signals are accepted by the memory controller 260; that is, after the access reception signals (DMA permission signals) are input from the memory controller 260. The display-processing unit 250 is configured to output the display image corresponding to the stored still image data and the video data to the display 40 and control the display 40 to display the display image. Accordingly, the display-processing unit 250 can access the DRAM 30 in the sequence to avoid the access limitations in the DRAM 30 and secure the bus bandwidth for outputting the display image corresponding to the still image data and the video data to the display 40 and making the display 40 to display the display image, wherein the DRAM 30 has the access limitations such that it is necessary to leave a predetermined period (a definite period) when accessing the given bank in the DRAM 30.

However, as described above, in the imaging device 1, in order to make the description easy to understand, the combination of the display-processing unit 250 and the memory controller 260 is not regarded as the memory access device according to the first embodiment of the present invention.

According to such a configuration, the imaging device 1 is configured to capture the still image and the video of the object by the image sensor 10 and make the display 40 to display the display image corresponding to the captured still image and the video. The imaging device 1 can be also configured to make the recording medium (not shown) to store the storage image corresponding to the still image and the video captured by the image sensor 10.

Among the plurality of processing blocks disposed in the imaging device 1, when the access request by the DMA transmission with respect to the DRAM 30 is made, the processing block configured to change the designation sequence of the banks by the addresses output to the memory controller 260 together with the access request signals is combined with the memory controller 260 to configure the memory access 200 according to the first embodiment of the present invention. In other words, in the image-processing device 20, the processing block configured to access the DRAM 30 with high priority by the DMA transmission with high priority is combined with the memory controller 260 to configure the memory access device 200.

As described above, according to the first embodiment, the combination of the imaging input unit 220 and the memory controller 260 are regarded as the memory access device (memory access device 200) according to the first embodiment of the present invention.

However, as described above, in the imaging device 1, the processing block regarded as the high-priority processing block varies due to the operation mode of the imaging device 1. Accordingly, in the imaging device 1, the processing block which is combined with the memory controller 260 to configure the memory access device according to the first embodiment of the present invention varies by each operation mode of the imaging device 1. For example, it is possible that the image-processing unit 230 and the JPEG-processing unit 240 which are described as the low-priority processing blocks in the description above are regarded as the high-priority processing blocks so as to configure the memory access device according to the first embodiment of the present invention by being combined with the memory controller 260. More specifically, when the operation mode of the imaging device 1 is the high-speed consecutive capture mode for consecutively capturing a plurality of still images in a high-speed, the imaging input unit 220 is regarded as the processing block (high-priority processing block) necessary to make the input image data of each frame output from the image sensor 10 to be consecutively stored (written) in the DRAM 30 by the DMA transmission. However, in the high-speed consecutive capture mode, the memory capacity of the DRAM 30 becomes the factor to limit the number (consecutively capturing number) of the still images which can be consecutively captured and if the memory capacity for storing a single still image is small, it is possible to increase the consecutively capturing number. In the imaging device 1, it is considerable that the necessary memory capacity of the DRAM 30 for the storage image data processed by the JPEG compression processing of the JPEG-processing unit 240 is smaller than that of the input image data output from the image sensor 10. Accordingly, in the imaging device 1, by making the priority of the image-processing unit 230 and the JPEG-processing unit 240 to be high, even if not equivalent to that of the imaging input unit 220, it is considerable to decrease the necessary memory capacity of the DRAM 30 for storing the single still image. In this case, in the imaging device 1, each of the image-processing unit 230 and the JPEG-processing unit 240 may operate in the same manner as in the high-priority processing block, that is, each of the image-processing unit 230 and the JPEG-processing unit 240 may be configured to change the designation sequence of the banks by the addresses output together with the access request signals to the memory controller 260 in the DMA transmission. That is, in the imaging device 1, each of the image-processing unit 230 and the JPEG-processing unit 240 may configure the memory access device according to the first embodiment of the present invention by being combined with the memory controller 260.

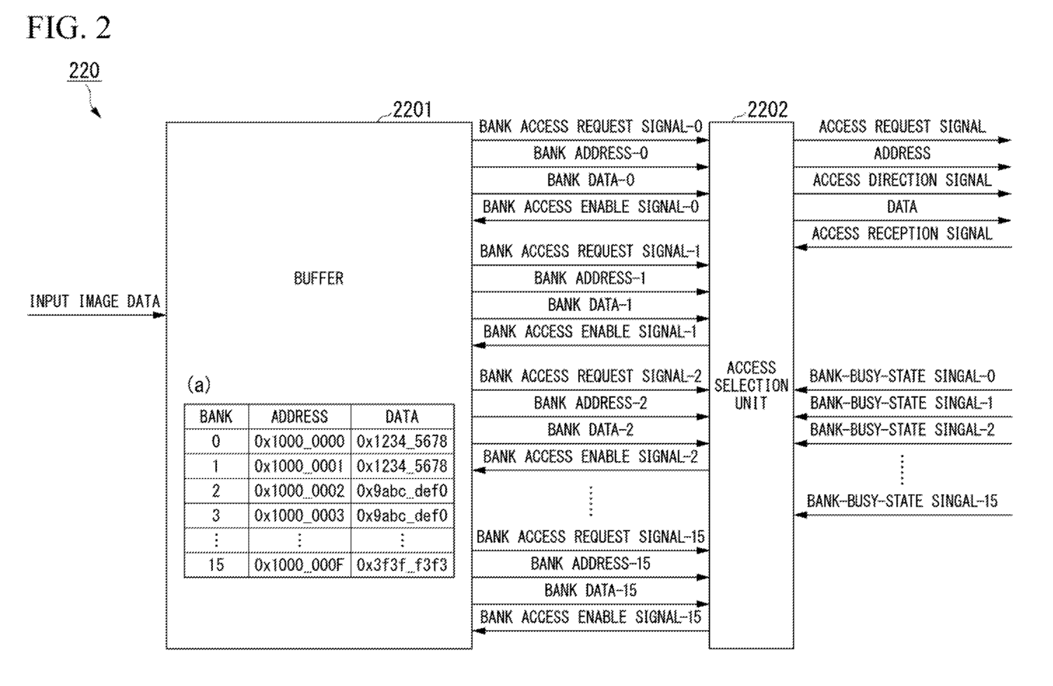

Next, the configuration and the operation of the memory access device 200 according to the first embodiment of the present invention will be described. FIG. 2 is the schematic block diagram showing a configuration of the memory access device 200 according to the first embodiment of the present invention. In FIG. 2, the schematic configuration of the imaging input unit 220 being the high-priority processing block to configure the memory access device 200 in the configuration of the imaging device 1 shown in FIG. 1 is shown. The imaging input unit 220 includes a buffer 2201 and an access selection unit 2202. In FIG. 2, among the configuration elements of the imaging input unit 220, only the configuration element configured to realize the function of changing the designating sequence of the banks of the DRAM 30 when the input image data output from the image sensor 10 is stored in the DRAM 30. That is, in FIG. 2, the configuration elements for realizing the functions of the imaging input unit equipped in the general imaging device are omitted.

In FIG. 2, the schematic configuration of the imaging input unit 220 corresponding to the DRAM 30 which is configured from 16 banks including the bank-0 to the bank-15 is shown. In FIG. 2, in order to identify the corresponding bank (the bank-0 to the bank-15) of the DRAM 30, with respect to each signal input to or output from the buffer 2201 and the access selection unit 2202, a “number” showing the corresponding bank is affixed to the hyphen “-” after the name of each signal. For example, in FIG. 2, the bank access request signals transmitted between the buffer 2201 and the access selection unit 2202 are identified as the “bank access request signal-0” to the “bank access request signal-15”. Similarly, the bank addresses, the bank data, and the bank access enable signals transmitted between the buffer 2201 and the access selection unit 2202 are identified as the “bank address-0” to the “bank address-15”, the “bank data-0” to the “bank data-15”, and the “bank access enable signal-0” to the “bank access enable signal-15”, respectively. For example, in FIG. 2, the bank-busy-state signals from the memory controller 260 and input to the access selection unit 2202 are identified as the “bank-busy-state signal-0” to the “bank-busy-state signal-15”.

The buffer 2201 is configured as the memory unit for temporarily storing (buffering) the input image data output from the image sensor 10 to the imaging input unit 220. The buffer 2201 is configured to temporarily store the input image data in the format corresponding to the banks configured in the DRAM 30. In FIG. 2, a configuration example of the memory region of the buffer 2201 is shown in the part (a) inside the buffer 2201. More specifically, since the DRAM 30 is configured by 16 banks, in the part (a) inside the buffer 2201 in FIG. 2, the configuration example of the memory region is shown that the data (input image data) and the address (bank address) corresponding to each of the 16 banks of the DRAM 30 including the bank-0 to the bank-15 are in correspondence with each other.

The buffer 2201 is configured to output each input image data which is buffered to the access selection unit 2202. At this time, the buffer 2201 is configured to request the transmission of the input image data corresponding to each bank configuring the DRAM 30 parallelly. More specifically, the bank access request signals for requesting the transmission of the input image data to each bank configuring the DRAM 30 and the bank addresses for designating the banks of the DRAM 30 to transmit the input image data are output to the access selection unit 2202 parallelly. The buffer 2201 is configured to output the bank data corresponding to the accepted bank access request signal, that is, the temporarily stored input image data to the access selection unit 2202 after the output bank access request signal is accepted by the access selection unit 2202 and the bank access enable signal is input to the buffer 2201.

More specifically, in the schematic configuration shown in FIG. 2, the buffer 2201 is configured to output the “bank access request signal-0” to the “bank access request signal-15” for requesting the transmission of the input image data to each of the bank-0 to the bank-15 configuring the DRAM 30 and the “bank address-0” to the “bank address-15” to the access selection unit 2202 parallelly. Then, after either of the parallelly output “bank access request signal-0” to the “bank access request signal-15” is accepted by the access selection unit 2202, the buffer 2201 is configured to output either of the “bank data-0” to the “bank data-15” respectively corresponding to the “bank access enable signal-0” to the “bank access enable signal-15” output from the access selection unit 2202 to the access selection unit 2202.

The access selection unit 2202 is configured to control the delivery of the data (input image data) for the transmission to the DRAM 30 by the DMA transmission in response to the transmission request of the input image data parallelly requested by the buffer 2201. At this time, the access selection unit 2202 is configured to change the designation sequence of the banks when transmitting the input image data to the DRAM 30 according to the bank-busy-state signal output from the memory controller 260. More specifically, the access selection unit 2202 firstly selects the bank to accept the transmission of the input image data parallelly requested by the buffer 2201 according to the bank-busy-state signal-0 to the bank-busy-state signal-15 corresponding to the banks configured in the DRAM 30. Then, the access selection unit 2202 is configured to output the access request signal for requesting the DMA transmission of the input image data with respect to the selected bank, the address for designating the selected bank, and the access direction signal to the memory controller 260.

Thereafter, the access selection unit 2202 is configured to output the bank access enable signal indicating the acceptance for the transmission of the input image data with respect to the selected bank, in other words, the bank access enable signal corresponding to the selected bank to the buffer 2201, when the output access request is accepted by the memory controller 260 and the access reception signal is input from the memory controller 260. Accordingly, the bank data corresponding to the selected bank, that is, the input image data corresponding to the address output together with the access request signal output to the memory controller 260 are output from the buffer 2201 to the access selection unit 2202. The access selection unit 2202 is configured to output the bank data as the data transmitted (written) to the DRAM 30 which is output from the buffer 2201 to the memory controller 260 via the data bus 210. Accordingly, the memory controller 260 is configured to transmit (write) the data to the DRAM 30, wherein the data is output to the data bus 210 by the imaging input unit 220 accepting the access request, that is, the access selection unit 2202.

In a case in which each of the bank-busy-state signal-0 to the bank-busy-state signal-15 indicates that the state is not the bank-busy state, the access selection unit 2202 is configured to designate the bank-0 to the bank-15 in this sequence and output the bank data which is sequentially output from the buffer 2201 to the memory controller 260 as the data transmitted (written) to the DRAM 30. However, in the case in which any of the bank-busy-state signal-0 to the bank-busy-state signal-15 indicates the bank-busy state, as described above, the access selection unit 2202 is configured to change the designation sequence of the banks when transmitting the bank data sequentially output from the buffer 2201 to the DRAM 30 so as to avoid the access to the bank in the bank-busy state.

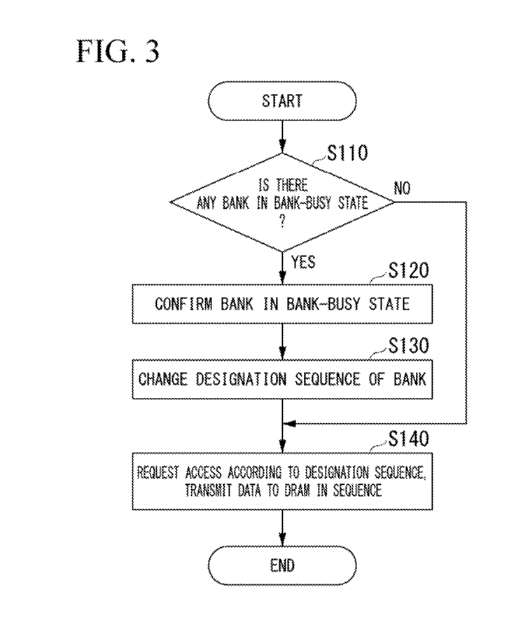

Here, the processing of changing the designation sequence of the banks when the access selection unit 2202 transmits the bank data to the DRAM 30 will be described. FIG. 3 is a flow chart showing the procedures of the processing of changing the banks to access, that is, the processing of changing the designation sequence of the banks in the memory access device 200 according to the first embodiment of the present invention. In the description below, the case in which the bank-busy-state signal corresponding to each bank of the DRAM 30 is sequentially output to the memory controller 260 will be described.

When the input image data output to the imaging input unit 220 from the image sensor 10 is buffered in the buffer 2201, the buffer 2201 is configured to parallelly output the bank access signals for requesting the transmission of the buffered input image data to each bank configured in the DRAM 30 together with the bank address to the access selection unit 2202. Accordingly, the access selection unit 2202 determines whether there is any bank in the bank-busy state according to the bank-busy-state signal output from the memory controller 260 (Step S110).

In the Step S110, if it is determined that there is no bank in the bank-busy state, that is, all of the banks configured in the DRAM 30 are not in the bank-busy state (“NO” in Step S110), the access selection unit 2202 proceeds to Step S140.

On the other hand, if it is determined that the bank in the bank-busy state exists (“YES” in Step S110), the access selection unit 2202 confirms the bank in the bank-busy state (Step S120).

Subsequently, the access selection unit 2202 changes the designation sequence of the banks according to the confirmation results in Step S120 (Step S130). More specifically, the access selection unit 2202 changes the designation sequence of the banks to be designated according to the predetermined sequence so as to postpone the sequence of the bank in the bank-busy state to the back and firstly designate the bank not in the bank-busy state.

Subsequently, the access selection unit 2202 outputs the access requests to the memory controller 260 in the designation sequence of the banks in the DRAM 30, and the access selection unit 2202 sequentially transmits the input image data buffered in the buffer 2201 to the DRAM 30 (Step S140). More specifically, when it is determined that there is no bank in the bank-busy state in Step S110, the access selection unit 2202 outputs the access requests to the memory controller 260 in the predetermined designation sequence of the banks in the DRAM 30, and sequentially transmits the bank data (input image data) corresponding to each bank to the DRAM 30. On the other hand, when it is determined that the bank in the bank-busy state exists in Step S110, the access selection unit 2202 outputs the access requests to the memory controller 260 in the changed sequence changed in Step S130, and sequentially transmits the bank data (input image data) corresponding to each bank to the DRAM 30.

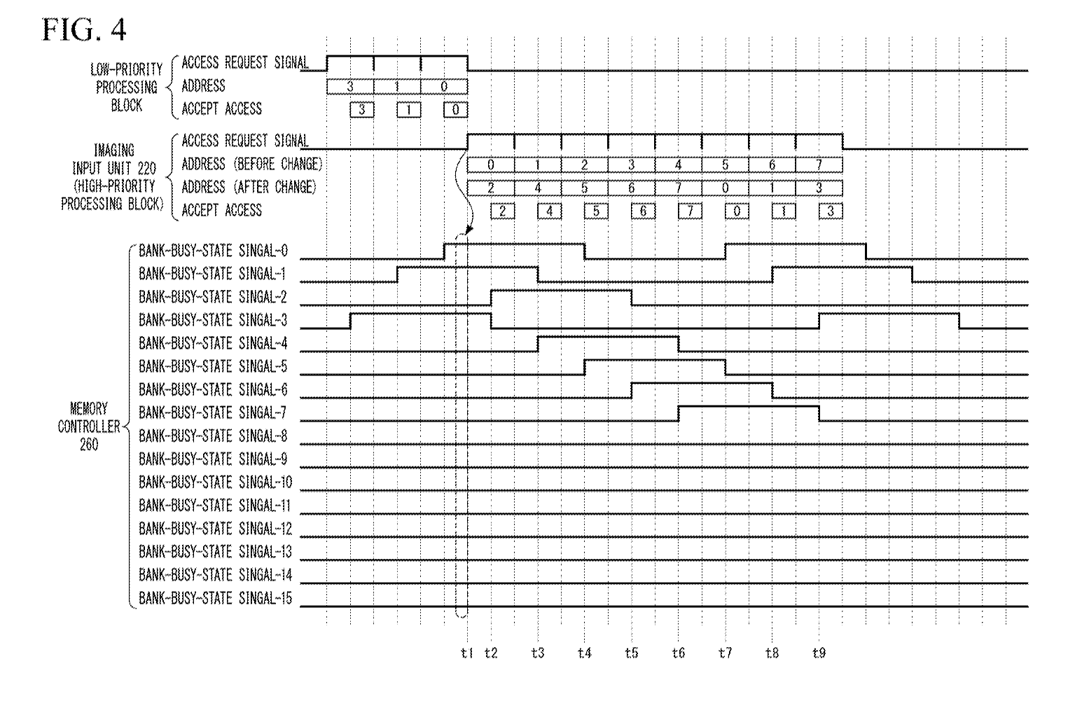

An example of the operation for transmitting the data to the DRAM 30 in the image-processing device 20 will be described. FIG. 4 is a timing chart showing the example of accessing the DRAM 30, that is, the example of designating the banks by the memory access device 200 according to the first embodiment of the present invention. In FIG. 4, the example of the timing when each of the high-priority processing block such as the imaging input unit 220 and the low-priority processing block (for example, the image-processing unit 230 and the JPEG-processing unit 240) outputs the access requests to the DRAM 30 by the DMA transmission. More specifically, in FIG. 4, the example of the timing when each of the imaging input unit 220 and the low-priority processing blocks outputs the “access request signals” for requesting the access to the DRAM 30 and the “bank addresses” for designating the banks is shown. The access request signals at a “High” level indicate the request for accessing the DRAM 30, and the access request signals at a “Low” level indicate that there is no request for accessing the DRAM 30. In FIG. 4, the banks to which the access requests output from each of the imaging input unit 220 and the low-priority processing blocks are accepted are shown as “ACCEPT ACCESS”. As described above, in the imaging input unit 220, the access selection unit 2202 equipped in the imaging input unit 220 is configured to change the designation sequence of the banks according to the bank-busy-state signal output from the memory controller 260. Thus, in FIG. 4, as the addresses output by the imaging input unit 220, the addresses before the access selection unit 2202 changes the sequence are shown as the “ADDRESSES (BEFORE CHANGE)”, and the addresses after the access selection unit 2202 changes the sequence are shown as the “ADDRESSES (AFTER CHANGE)”. In FIG. 4, the “bank-busy-state signals” corresponding to each bank of the DRAM 30 and output by the memory controller 260 are shown. The “bank-busy-state signals” at a “High” level indicate the bank-busy state, and the “bank-busy-state signals” at a “Low” level indicate a state rather than the bank-busy state.

The timing chart shown in FIG. 4 is an example of the timing in the case in which the imaging input unit 220 makes the access requests for consecutively designating the eight banks configured in the DRAM 30 having 16 banks configured therein. In the description below, it is described that the sequence for the access selection unit 2202 to designate the banks of the DRAM 30 is predetermined to be the sequence from the bank-0 to the bank-1, subsequently to the bank-2, . . . , and to the bank-7 as shown as “ADDRESS (BEFORE CHANGE)”. In the description below, it is described that the memory controller 260 is configured to consecutively output the bank-busy-state signal corresponding to each bank.

In the example of the timing chart shown in FIG. 4, the memory controller 260 is configured to accept the access requests to the banks designated by the low-priority processing block in response to the access request signal output from the low-priority processing block and control the data delivery to the DRAM 30, that is, the memory controller 260 performs the DMA transmission. When the memory controller 260 controls the data delivery in response to the access request from the low-priority processing block, the banks of the DRAM 30 which are designated by the low-priority processing block enter the bank-busy state, wherein the bank-busy state is canceled after a certain period so as to be able to accept the access request to the given bank again. The memory controller 260 sets the bank-busy-state signal corresponding to the bank entering the bank-busy state due to accept the access request to the “High” level. In the example of the timing chart shown in FIG. 4, the bank-busy-state signal-3, the bank-busy-state signal-1, and the bank-busy-state signal-0 corresponding to the bank-3, the bank-1, and the bank-0 respectively which are designated by the low-priority processing block are set to the “High” level consecutively. The memory controller 260 is configured to set each bank-busy-state signal to the “Low” level after the certain period when the bank-busy-state in each bank is canceled.

Subsequently, in the example of the timing chart shown in FIG. 4, the imaging input unit 220 makes the access requests to consecutively designate 8 banks from the timing t1. At this time, in the imaging input unit 220, before the initial access request to the DRAM 30 is output at the timing t1, the access selection unit 2202 determines the sequence for designating the banks according to the bank-busy-state signals corresponding to each bank and output from the memory controller 260. In the example of the timing chart shown in FIG. 4, the bank-busy-state signals output from the memory controller 260 immediately before the timing t1 indicate that the bank-0, the bank-1, and the bank-3 are in the bank-busy state. Accordingly, the access selection unit 2202 is configured to determine the sequence for designating the banks so as to postpone access to the banks in the bank-busy-state and firstly accesses the banks which are not in the bank-busy-state. In the example of the timing chart shown in FIG. 4, the access selection unit 2202 determines to designate the banks in the sequence from the bank-2 to the bank-4, the bank-5, the bank-6, the bank-7, the bank-0, the bank-1, and the bank-3 at last.

The sequence of the access selection unit 2202 for designating each bank is not limited to the sequence in the example of the timing chart shown in FIG. 4. In other words, the sequence for the access selection unit 2202 to designate each bank only has to include all of the bank-0 to the bank-7 while avoiding the access to the banks in the bank-busy state. For example, in the same manner as in the example of the timing chart shown in FIG. 4, in the case in which the bank-busy-state signals output from the memory controller 260 immediately before the timing t1 indicate that the bank-0, the bank-1, and the bank-3 are in the bank-busy state, the access selection unit 2202 may determine the sequence to designate each bank as the sequence from the bank-4 to the bank 5, the bank-6, the bank-7, the bank-9, the bank-1, the bank-2, and the bank 3 at last.

The imaging input unit 220 (the access selection unit 2202) is configured to sequentially output the access request signals for consecutively designating the 8 banks in the determined sequence to the memory controller 260. Accordingly, the memory controller 260 is configured to accept the access requests to the banks which are designated by the imaging input unit 220 and not in the bank-busy state in response to each access request signal output from the imaging input unit 220 to control the data delivery to the DRAM 30, that is, the memory controller 260 performs the DMA transmission. In the example of the timing chart shown in FIG. 4, it is shown the timing when the memory controller 260 accepts the access requests to each bank designated by the imaging input unit 220 and performs the DMA transmission at each of the timing t2 to the timing t9. At this time, when the memory controller 260 accepts the access requests to each bank designated by the imaging input unit 220, the memory controller 260 sets the bank-busy-state signals corresponding to each bank entering the bank-busy state due to accept the access request to the “High” level. Since the bank-busy state of each bank is canceled after the certain period, the memory controller 260 is configured to set the bank-busy-state signals corresponding to each bank to the “Low” level when the bank-busy state is canceled.

According to such configuration and operation, the memory access device 200 according to the first embodiment of the present invention is configured to perform the data delivery (DMA transmission) while avoiding the access to the banks configured in the DRAM 30 which are in the bank-busy state. Accordingly, in the memory access device 200 according to the first embodiment of the present invention, the efficiency of the access to the DRAM 30 by the imaging input unit 220 can be improved, and the bus band width for the imaging input unit 220 to store (write) the input image data into the DRAM 30 can be secured.

In the case in which the memory access device 200 according to the first embodiment of the present invention does not change the sequence for designating the banks and the memory access device 200 outputs the access request signals in the predetermined sequence, that is, the sequence from the bank-0 to the bank-1, the bank-2, the bank-3, . . . , and the bank-7 at last, the memory controller 260 is configured to accept the access requests after the bank-busy state of the bank-0 designated by the low-priority processing block is canceled. In the example of the timing chart shown in FIG. 4, for example, at the timing t4, the memory controller 260 accepts the access request to the bank-0. The operation timing in the case in which the sequence to designate the banks is not changed, is equivalent to the operation timing in the conventional memory access device configured to output the access request signals without avoiding access to the banks in the bank-busy state.

On the other hand, in the memory access device 200 according to the first embodiment of the present invention, as the example of the timing chart shown in FIG. 4, at the timing t2, the memory controller 260 accepts the access requests to the bank-9 by making the access requests to the banks in the sequence in which access to the banks in the bank-busy state are avoided. In other words, the memory access device 200 according to the first embodiment of the present invention can accept the access request to the bank-0 at an earlier timing than that of the conventional memory access device. Accordingly, the memory access device 200 according to the first embodiment of the present invention can shorten the period until the data transmission due to the consecutive access requests (the DMA transmission of consecutively designating the 8 banks configured in the DRAM 30) is finished.

According to the present first embodiment, a memory access device (the memory access device 200) is configured to have a plurality of processing blocks (the imaging input unit 220, the image-processing unit 230, the JPEG-processing unit 240, and the display-processing unit 250) connected to a common data bus (the data bus 210), wherein the plurality of processing blocks are configured to output access requests for requesting access to a memory (the DRAM 30) whose address space is divided into a plurality of banks, a memory controller (the memory controller 260) connected to the data bus 210, wherein the memory controller is configured to arbitrate the access requests output from the plurality of processing blocks and control access to the connected DRAM 30 in response to the accepted access requests while outputting operation information (the bank-busy-state signal) indicating an operation state of the DRAM 30; and an access selection unit (the access selection unit 2202) configured to change a designation sequence of the banks among the plurality of banks according to the operation information and output the access requests of a high-priority processing block designating the banks among the plurality of banks in the changed sequence, wherein at least one processing block (for example, the imaging input unit 220) among the plurality of processing blocks is designated as the high-priority processing block configured to perform a high priority processing.

According to the present first embodiment, the memory access device 200 is configured to further have a buffer (the buffer 2201) configured to temporarily store data (for example, the input image data) transmitted between the high-priority processing block and the DRAM 30 in correspondence with each of the plurality of banks and parallelly request transmission of the stored input image data (the bank data) in correspondence with each of the plurality of banks, wherein the access selection unit 2202 is configured to change the designation sequence of the banks according to the bank-busy-state signals when transmitting the input image data (the bank data) to each of the plurality of banks as parallelly requested by the buffer 2201.

According to the present first embodiment, the memory access device 200 is configured to have the buffer 2201 and the access selection unit 2202 to be configured inside the high-priority processing block (for example, the imaging input unit 220).

According to the present first embodiment, the memory access device 200 is configured that the access selection unit 2202 changes the designation sequence of the banks so as to avoid the access to the bank which is in the period when the given bank is inaccessible (in the bank-busy state) according to the bank-busy-state signal, wherein the bank-busy-state signal is the information (the operation information) indicating whether it is in the period when it is impossible to access the given bank (in the bank-busy state) by each bank.

According to the present first embodiment, the memory access device 200 is configured to have the memory controller 260 including an arbitration unit (the arbitration unit 2601) configured to arbitrate the access requests output from each of the plurality of processing blocks; and a memory access unit (the memory access unit 26012) configured to control access to the DRAM 30 in response to the access requests accepted by the arbitration unit 2601, wherein the bank-busy-state signal is output by either or both of the arbitration unit 2601 and the memory access unit 2602.

According to the present first embodiment, an image-processing device (the image-processing device 20) is configured to have the memory access device (the memory access device 200) having a plurality of processing blocks (the imaging input unit 220, the image-processing unit 230, the JPEG-processing unit 240, and the display-processing unit 250) connected to a common data bus (the data bus 210), wherein the plurality of processing blocks are configured to output access requests for requesting access to a memory (the DRAM 30) whose address space is divided into a plurality of banks, a memory controller (the memory controller 260) connected to the data bus 210, wherein the memory controller is configured to arbitrate the access requests output from the plurality of processing blocks and control access to the connected DRAM 30 in response to the accepted access requests while outputting operation information (the bank-busy-state signal) indicating an operation state of the DRAM 30; and an access selection unit (the access selection unit 2202) configured to change a designation sequence of the banks among the plurality of banks according to the operation information and output the access requests of a high-priority processing block designating the banks among the plurality of banks in the changed sequence, wherein at least one processing block (for example, the imaging input unit 220) among the plurality of processing blocks is designated as the high-priority processing block configured to perform a high priority processing.

According to the present first embodiment, an imaging device including the image-processing device (the image-processing device 20) is configured to have the memory access device (the memory access device 200) having a plurality of processing blocks (the imaging input unit 220, the image-processing unit 230, the JPEG-processing unit 240, and the display-processing unit 250) connected to a common data bus (the data bus 210), wherein the plurality of processing blocks are configured to output access requests for requesting access to a memory (the DRAM 30) whose address space is divided into a plurality of banks, a memory controller (the memory controller 260) connected to the data bus 210, wherein the memory controller is configured to arbitrate the access requests output from the plurality of processing blocks and control access to the connected DRAM 30 in response to the accepted access requests while outputting operation information (the bank-busy-state signal) indicating an operation state of the DRAM 30; and an access selection unit (the access selection unit 2202) configured to change a designation sequence of the banks among the plurality of banks according to the operation information and output the access requests of a high-priority processing block designating the banks among the plurality of banks in the changed sequence, wherein at least one processing block (for example, the imaging input unit 220) among the plurality of processing blocks is designated as the high-priority processing block configured to perform a high priority processing.

As described above, in the memory access device 200 according to the first embodiment of the present invention, the memory controller 260 is configured to output the bank-busy-state signal (the operation information of the DRAM 30) indicating whether each bank of the connected DRAM 30 is in the bank-busy state. In the memory access device 200 according to the first embodiment of the present invention, the imaging input unit 220 (the high-priority processing block) is configured to determine the designation sequence of the banks so as to not to designate the banks in the bank-busy state in the access request to each bank (avoid the access to the banks in the bank-busy state) according to the bank-busy-state signals immediately before outputting the initial access request. According to the memory access device 200 according to the first embodiment of the present invention, the access efficiency to the DRAM 30 by the imaging input unit 220 (the high-priority processing block) can be improved, and the bus band width for the imaging input unit 220 (the high-priority processing block) to access the DRAM 30 (to store (write) the input image data into the DRAM 30) can be secured.

As described above, the configuration example of the memory access device 200 according to the first embodiment of the present invention which is configured by the combination of the imaging input unit (high-priority processing block) and the memory controller 260 is described; however, the high-priority processing block varies due to the operation mode of the imaging device 1. Accordingly, the combination of the high-priority processing block and the memory controller 260 configuring the memory access device according to the first embodiment of the present invention is not limited to the combination of the imaging input unit 220 and the memory controller 260. However, even if the memory access device according to the first embodiment of the present invention is configured by the combination of the high-priority processing block different from the imaging input unit 220 and the memory controller 260, the operation thereof can be simply considered by referring to the operation of the combination of the imaging input unit 220 and the memory controller 260 described above. Accordingly, a detailed description regarding the configuration and the operation of the memory access device according to the first embodiment of the present invention which is configured by the high-priority processing block different from the imaging input unit 220 and the memory controller 260 will be omitted.

In the first embodiment of the present invention, it is described that the imaging input unit 220 as the high-priority processing block to configure the memory access device 200 determines the designation sequence of the banks included in the DRAM 30 according to the bank-busy-state signals immediately before outputting the initial access requests. However, the method for the imaging input unit 220 to determine the designation sequence of the banks included in the DRAM 30 may not be the method according to the bank-busy-state signals immediately before outputting the initial access requests. For example, the imaging input unit 220 may determine the designation sequence of the banks according to the bank-busy-state signals immediately before outputting each access request. That is, the imaging input unit 220 may determine the designation bank by each access request.

### Second Embodiment

Next, a memory access device according to a second embodiment of the present invention will be described. In the memory access device according to the second embodiment of the present invention, the high-priority processing block is configured to determine the bank designated in each access request by each access request.

In the description below, for an example, the case in which the memory access device according to the second embodiment of the present invention is equipped in the imaging device such as a camera for capturing still images, a camera for capturing videos or the like will be described. The configuration of the imaging device equipped with the image-processing device having the memory access device according to the second embodiment of the present invention is the same as the schematic configuration of the imaging device 1 equipped with the image-processing device 20 having the memory access device 200 according to the first embodiment shown in FIG. 1. Accordingly, a detailed description regarding the imaging device equipped with the image-processing device having the memory access device according to the second embodiment of the present invention will be omitted, and the configuration elements same as the configuration elements of the imaging device 1 equipped with the image-processing device 20 having the memory access device 200 according to the first embodiment shown in FIG. 1 will be described using the same reference signs. The configuration of the memory access device according to the second embodiment of the present invention is same as the schematic configuration of the memory access device 200 according to the first embodiment shown in FIG. 2. Accordingly, a detailed description of the memory access device according to the second embodiment of the present invention will be omitted, and the configuration elements same as the configuration elements of the memory access device 200 according to the first embodiment shown in FIG. 2 will be described using the same reference signs.

However, the memory access device according to the second embodiment of the present invention (hereinafter, “memory access device 201”) is configured to determine the designation bank by each access request, thus the operation of the access selection unit is different from the operation of the access selection unit 2202 equipped in the memory access device 200 according to the first embodiment. In the description below, the access selection unit equipped in the memory access device 201 is described as an “access selection unit 2212” so as to be distinguish from the access selection unit 2202 equipped in the memory access device 200 according to the first embodiment. In the description below, the imaging input unit configuring the memory access device 201 having the access selection unit 2212 is described as an “imaging input unit 221” so as to be distinguished from the imaging input unit 220 configuring the memory access device 200 having the access selection unit 2202 according to the first embodiment. In the description below, the image-processing device having the memory access device 201 is described as an “image-processing device 21” so as to be distinguished from the image-processing device 20 having the memory access device 200 according to the first embodiment.

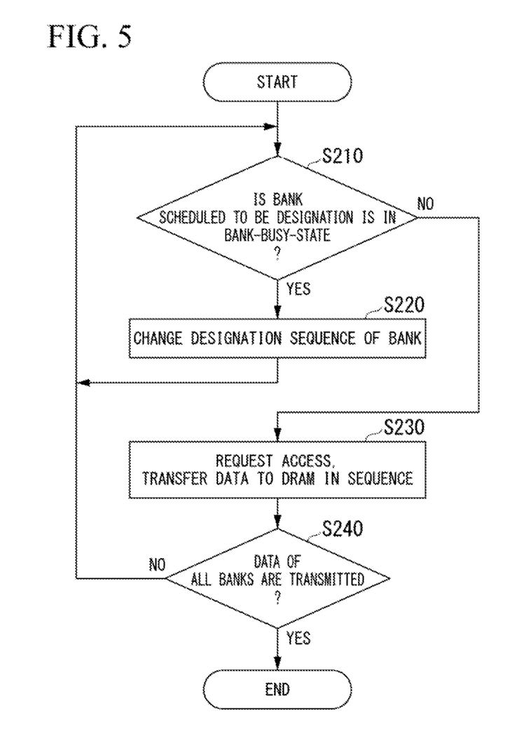

Next, the operation of the memory access device 201 according to the second embodiment of the present invention, that is, the processing of changing the designation sequence of the banks when the access selection unit 2212 transmits the bank data to the DRAM 30 will be described. FIG. 5 is a flow chart showing processing procedures for changing access sequences to banks, that is, the processing procedures for changing designation sequence of the banks in the memory access device 201 according to a second embodiment of the present invention. In the description below, it is described that the bank-busy-state signals corresponding to each bank of the DRAM 30 is consecutively output from the memory controller 260.

When the input image data output from the image sensor 10 to the imaging input unit 221 is buffered in the buffer 2201, the buffer 2201 is configured to output the bank addresses and the bank access request signals for requesting the transmission of the buffered input image data to each bank configured in the DRAM 30 parallelly to the access selection unit 2212. Accordingly, the access selection unit 2212 is configured to determine whether the bank scheduled to be designated is in the bank-busy state according to the bank-busy-state signals output from the memory controller 260 (Step S210). Here, the bank scheduled to be designated refers to the bank-0 as a scheduled initially designation bank in the case in which the predetermined designation sequence of the banks of the DRAM 30 is the sequence from the bank-0 to the bank 1, the bank 2, . . . , the bank 6, and the bank 7 at last.

In Step S210, when it is determined that the scheduled designation bank is in the bank-busy state (“YES” in Step S210), the access selection unit 2212 changes the designation sequence of the banks (Step S220). For example, in Step S210, in the case when it is determined that the bank-0 scheduled to be initially designated is in the bank-busy state, the access selection unit 2212 changes to the bank-1 which is scheduled to be subsequently designated. The access selection unit 2212 may treat the bank-0 whose sequence is changed as the bank scheduled to be initially designated after the access to the bank-1 is finished, and the access selection unit 2212 may treat the bank-0 as the bank scheduled to be initially designated after the access to the predetermined consecutive plurality of banks, that is, after the access to the bank-7 is finished. The access selection unit 212 returns to Step S210 to determine whether the bank (bank-1) scheduled to be designated is in the bank-busy state. In the memory access device 201, the access selection unit 2212 is configured to repeat the processing in Step S210 and Step S220 until the scheduled designation bank is not in the bank-busy state.

On the other hand, in Step S210, in the case when it is determined that the scheduled designation bank is not in the bank-busy state (“NO” in Step S210), the access selection unit 2212 proceeds to Step S230.

Subsequently, the access selection unit 2212 is configured to output the access requests to the banks which are determined not to be in the bank-busy state in Step S210 to the memory controller 260, and the access selection unit 2212 transmits the buffered bank data (the input image data) in the buffer 2201 to the DRAM 30 (Step S230).

Subsequently, the access selection unit 2212 is configured to determine whether the transmission of the bank data (the input image data) corresponding to all of the banks which are set to the access selection unit 2212 in advance to the DRAM 30 is finished (Step S240). In Step S240, when it is determined that the transmission of the bank data (the input image data) corresponding to all of the predetermined banks to the DRAM 30 is finished (“YES” in Step S240), the access selection unit 2212 terminates the processing of changing the designation sequence of the banks. On the other hand, in Step S240, when it is determined that the transmission of the bank data (the input image data) corresponding to all of the predetermined banks to the DRAM 30 is not finished (“NO” in Step S240), the access selection unit 2212 is configured to return to Step S210 and repeat the processing of Step S210 to Step S240. That is, the access selection unit 2212 is configured to repeat the determination regarding whether or not the banks are in the bank-busy state with respect to the banks whose transmission of the bank data (the input image data) is not finished, the change of the sequence, the output of the access requests to the memory controller 260, and the transmission of the bank data (the input image data) until the transmission of the bank data (the input image data) corresponding to all of the predetermined banks to the DRAM 30 is finished.

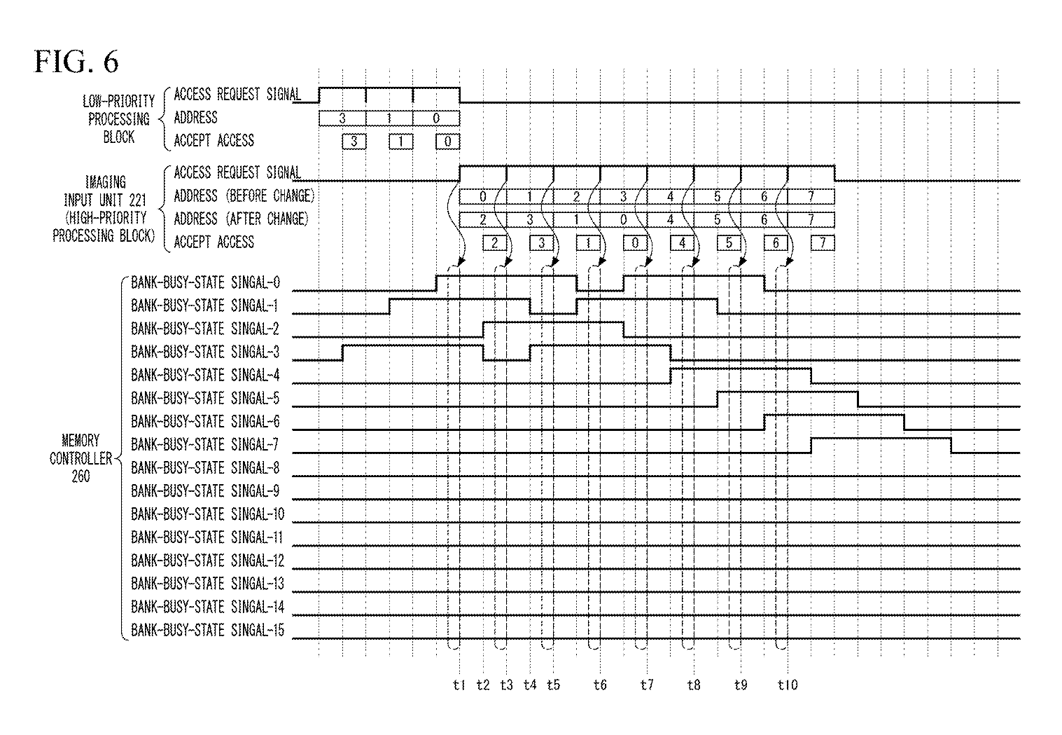

Next, an operation example for transmitting the data to the DRAM 30 in the image-processing device 21 will be described. FIG. 6 is a timing chart showing timings to access the DRAM 30, that is, timings to designate the banks in the memory access device 201 according to the second embodiment of the present invention. In FIG. 6, similar to the example of the timing chart in the memory access device 200 according to the first embodiment shown in FIG. 4, it is shown an example of timings for each of the imaging input unit 221 as the high-priority processing block and the low-priority processing block (for example, the image-processing unit 240 or the JPEG-processing unit 240) to output the access requests for accessing the DRAM 30 by the DMA transmission. More specifically, in FIG. 6, it is shown the examples of the timings of the “access request signals” which are output when each of the imaging input unit 221 and the low-priority processing blocks requests for the access to the DRAM 30 and the “addresses” used for designating the banks. Similar to the example of the timing chart in the memory access device 200 according to the first embodiment shown in FIG. 4, the access request signals at a “High” level indicate the request for accessing the DRAM 30, and the access request signals at a “Low” level indicate that there is no request for accessing the DRAM 30. In FIG. 6, the banks to which the access requests output from each of the imaging input unit 221 and the low-priority processing blocks are accepted are shown as “ACCEPT ACCESS”. In the imaging input unit 221, as described above, the access selection unit 2212 equipped in the imaging input unit 221 changes the designation sequence of the banks according to the bank-busy-state signals output from the memory controller 260. Accordingly, similar to the example of the timing chart in the memory access device 200 according to the first embodiment shown in FIG. 4, the addresses before the access selection unit 2212 changes the sequence are shown as “ADDRESS (BEFORE CHANGE)” and the addresses after the access selection unit 2212 changes the sequence are shown as “ADDRESS (AFTER CHANGE)” in FIG. 6 as the addresses output by the imaging input unit 221. In FIG. 6, “BANK-BUSY-STATE SIGNAL” corresponding to each bank of the DRAM 30 which is output by the memory controller 260 is also shown. Similar to the example of the timing chart in the memory access device 200 according to the first embodiment shown in FIG. 4, the bank-busy-state signals shown in the “High” level indicate the bank busy state, and the bank-busy-state signals shown in the “Low” level indicate that it is not in the bank-busy state.

Similar to the example of the timing chart in the memory access device 200 according to the first embodiment shown in FIG. 4, the timing chart shown in FIG. 6 indicates the example of the timing in the case in which the imaging input unit 221 makes the access requests for consecutively designating the eight banks configured in the DRAM 30 having 16 banks configured therein. In the description below, it is described that the sequence of the access selection unit 2212 for designating the banks of the DRAM 30 is predetermined to be the sequence from the bank-0 to the bank-1, subsequently to the bank-2, . . . , and to the bank-7 as shown as “ADDRESS (BEFORE CHANGE)”. In the description below, similar to the example of the timing chart in the memory access device 200 according to the first embodiment shown in FIG. 4, it is described that the memory controller 260 is configured to consecutively output the bank-busy-state signal corresponding to each bank.

In the example of the timing chart shown in FIG. 6, similar to the example of the timing chart in the memory access device 200 according to the first embodiment shown in FIG. 4, the memory controller 260 is configured to accept the access requests to the banks designated by the low-priority processing block in response to the access request signal output from the low-priority processing block and control the data delivery (the DMA transmission) to the DRAM 30. In the example of the timing chart shown in FIG. 6, similar to the example of the timing chart in the memory access device 200 according to the first embodiment shown in FIG. 4, the bank-busy-state signals corresponding to the bank-3, the bank-1, and the bank-0 respectively which are designated by the low-priority processing block are set to the “High” level consecutively. The memory controller 260 is configured to set each bank-busy-state signal to the “Low” level after the certain period and the bank-busy-state in each bank is canceled.

Subsequently, in the example of the timing chart shown in FIG. 6, similar to the example of the timing chart in the memory access device 200 according to the first embodiment shown in FIG. 4, the imaging input unit 221 makes the access requests to consecutively designate 8 banks from the timing t1. At this time, in the imaging input unit 221, before each timing when outputting the access requests to the DRAM 30, the access selection unit 2212 determines the banks to be designated according to the bank-busy-state signals corresponding to each bank and output from the memory controller 260. In the example of the timing chart shown in FIG. 6, similar to the example of the timing chart in the memory access device 200 according to the first embodiment shown in FIG. 4, the bank-busy-state signals output from the memory controller 260 immediately before the timing t1 indicate that the bank-0, the bank-1, and the bank-3 are in the bank-busy state. Accordingly, the access selection unit 2212 determines that the bank-0 which is predetermined to be initially designated and the bank 1 which is predetermined to be subsequently designated are in the bank-busy state, and the access selection unit 2212 determines to request the access to the bank-2 at the timing t1, wherein the bank-2 is predetermined to be subsequently designated thereafter. That is, the access selection unit 2212 is configured to designate the bank-2 as the designation bank so as to avoid the access to the bank-0 and the bank-1 which are in the bank-busy state.

The imaging input unit 221 (access selection unit 2212) outputs the access request signal for designating the determined bank-2 at the timing t1 to the memory controller 260. Accordingly, the memory controller 260 accepts the access request with respect to the bank-2 which is not in the bank-busy state in response to the access request signal with respect to the bank-2 which is output from the imaging input unit 221 and the memory controller 260 controls the delivery of the data (DMA transmission) to the DRAM 30. At this time, when the memory controller 260 accepts the access request with respect to the bank-2 and output from the imaging input unit 221, at the timing t2, the memory controller 260 sets the bank-busy-state signal-2 corresponding to the bank-2 entering the bank-busy state to the “High level” since the access request is accepted. Since the bank-busy state of the bank-2 is canceled after a certain period, the memory controller 260 sets the bank-busy-state signal corresponding to the bank-2 to the “Low level” when the bank-busy state is canceled.

Then, the access selection unit 2212 determines the designation banks according to the bank-busy-state signals corresponding to each bank which are output from the memory controller 260 before the timing t3 when the access request for the next bank is output. In the Example of the timing chart shown in FIG. 6, the bank-busy-state signals output from the memory controller 260 immediately before the timing t3 indicate that the bank-0, the bank-1, and the bank-2 are in the bank-busy state. Accordingly, the access selection unit 2212 determines that the bank-0 which is predetermined to be initially designated and the bank-1 which is predetermined to be subsequently designated are in the bank-busy state, and the access selection unit 2212 determines to designate the bank-3 as the designation bank for requesting the access at the timing t3, wherein the bank-3 is predetermined to be subsequently designated after the bank-1. That is, the access selection unit 2212 determines to designate the bank-3 so as to avoid the access to the bank-0 and the bank-1 in the bank-busy state. The bank-2 is excluded from the determination objects at the timing t3 since the access to the bank-2 has been requested.

The access selection unit 2212 output the access request signal for designating the determined bank-3 to the memory controller 260 at the timing t3. Accordingly, the memory controller 260 accepts the access request with respect to the bank-3 which is not in the bank-busy state in response to the access request signal with respect to the bank-3 and output from the imaging input unit 221, and the memory controller 260 controls the delivery of the data to the DRAM 30 (DRAM transmission). At this time, the memory controller 260 sets the bank-busy-state signal-3 corresponding to the bank-3 to be the “High level” at the timing t4, wherein the bank-3 enters the bank-busy state since the access request from the imaging input unit 221 is accepted. The memory controller 260 sets the bank-busy-state signal-3 corresponding to the bank-3 to the “Low level” when the bank-busy state is canceled since the bank-busy state of the bank-3 is canceled after the certain period.

Subsequently, the access selection unit 2212 similarly determines the designation banks according to the bank-busy-state signals corresponding to each bank before each timing when the access request for the next bank is output. As described above, the access selection unit 2212 is configured to determine the designation banks by consecutively excluding the banks from the determination objects since the access to these banks are already requested at either timing. More specifically, in the example of the timing chart shown in FIG. 6, the bank-busy-state signals immediately before the timing t5 indicate that the bank-0, the bank-2, and the bank-3 are in the bank-busy state. Thus, the access selection unit 2212 determines that the bank-0 is the bank in the bank-busy state, wherein the bank-0 is predetermined to be initially designated, and the access selection unit 2212 determines the bank-1 to be the bank for requesting the access thereto at the timing t5, wherein the bank-1 is predetermined to be subsequently designated after the bank-0. The bank-busy-state signals immediately before the timing t6 indicate that the bank-1, the bank-2, and the bank-3 are in the bank-busy state. Thus, the access selection unit 2212 determines the bank-0 to be the bank for requesting the access thereto at the timing t6, wherein the bank-0 is predetermined to be initially designated. The bank-busy-state signals immediately before the timing t7 indicate that the bank-0, the bank-1, and the bank-3 are in the bank-busy state. Thus, the access selection unit 2212 determines the bank-4 to be the bank for requesting the access thereto at the timing t7, wherein the bank-4 is predetermined to be initially designated. The bank-busy-state signals immediately before the timing t8 indicate that the bank-0, the bank-1, and the bank-4 are in the bank-busy state. Thus, the access selection unit 2212 determines the bank-5 to be the bank for requesting the access thereto at the timing t8, wherein the bank-5 is predetermined to be initially designated. The bank-busy-state signals immediately before the timing t9 indicate that the bank-0, the bank-4, and the bank-5 are in the bank-busy state. Thus, the access selection unit 2212 determines the bank-6 to be the bank for requesting the access thereto at the timing t9, wherein the bank-6 is predetermined to be initially designated. The bank-busy-state signals immediately before the timing t10 indicate that the bank-4, the bank-5, and the bank-6 are in the bank-busy state. Thus, the access selection unit 2212 determines the bank-7 to be the bank for requesting the access thereto at the timing t10, wherein the bank-7 is predetermined to be initially designated.

In this manner, in the example of the timing chart shown in FIG. 6, each of the banks is determined to be the bank for requesting the access thereto in the sequence from the bank-2 to the bank3, the bank-0, the bank-1, the bank-4, the bank-5, the bank-6, and the bank-7 at last by the access selection unit 2212. In the same manner, the access selection unit 2212 consecutively outputs the access request signals for designating the determined banks to the memory controller 260. Accordingly, the memory controller 260 consecutively accepts the access requests with respect to the banks which are not in the bank-busy state, and the memory controller 260 consecutively controls the delivery of the data to the DRAM 30 (DMA transmission), in response to the access request signals with respect to the banks which are output from the imaging input unit 221.

The access selection unit 2212 can arrange the sequence for designating each bank as the example of the timing chart shown in FIG. 6, for example, without making a major change to the predetermined sequence in the access selection unit 2212 for designating the banks of the DRAM 30, such as from the bank-4 to the bank-7, so as to avoid the access to the banks in the bank-busy state. However, the sequence of the access selection unit 2212 for designating each bank is not limited to the sequence shown as the example of the timing chart shown in FIG. 6. That is, similar to the memory access device 200 according to the first embodiment, the sequence of the access selection unit 2212 in the memory access device 201 for designating each bank only has to be arranged so as to include all of the bank-0 to the bank-7 while being able to avoid the access to the banks in the bank-busy state, and the sequence of the access selection unit 2212 for designating each bank is not particularly limited thereto.

According to such configuration and operation, the memory access device 201 according to the second embodiment of the present invention is configured to determine the banks in the bank-busy state by every access request made to each bank included in the DRAM 30, and then control the delivery of the data (DMA transmission) to avoid the access to the banks in the bank-busy state. Accordingly, similar to the memory access device 200 according to the first embodiment, in the memory access device 201 according to the second embodiment of the present invention, the access efficiency to the DRAM 30 by the imaging input unit 221 can be improved, and the bus band width for making the DRAM 30 to store (write) the input image data by the imaging input unit 221 can be secured. Similar to the memory access device 200 according to the first embodiment, the memory access device 201 according to the second embodiment of the present invention can shorten the period until the data transmission due to the consecutive access requests (the DMA transmission of consecutively designating the 8 banks configured in the DRAM 30) is finished.

According to the second embodiment, the memory access device (the memory access device 201) is configured to include the access selection unit (the access selection unit 2212) to change the sequence for designating the banks according to the operation information (the bank busy signal) every time when the high-priority processing block (for example, the imaging input unit 221) consecutively accesses each bank.

As described above, in the memory access device 201 according to the second embodiment of the present invention, the memory controller 260 is configured to output the bank-busy-state signals (the operation information of the DRAM 30) indicating whether each bank of the connected DRAM 30 is in the bank-busy state. In the memory access device 201 according to the second embodiment of the present invention, the imaging input unit 221 (the high-priority processing block) is configured to determine the sequence for designating the banks according to the bank-busy-state signals immediately before each access request so as to not to designate the banks in the bank-busy state (avoid the access to the banks in the bank-busy state). Accordingly, similar to the memory access device 200 according to the first embodiment, in the memory access device 201 according to the second embodiment of the present invention, the access efficiency to the DRAM 30 by the imaging input unit 221 (the high-priority processing block) can be improved, and the bus band width for the imaging input unit 221 (the high-priority processing block) to access the DRAM 30 (to make the DRAM 30 to store (write) the input image data) can be secured.

In the description above, similar to the memory access device 200 according to the first embodiment, the example of the memory access device 201 according to the second embodiment of the present invention which is configured by the combination of the imaging input unit (high-priority processing block) 221 and the memory controller 260 is described. However, similar to the memory access device according to the first embodiment, in the memory access device according to the second embodiment of the present invention, the high-priority processing block is different due to the operation mode of the imaging device 1. Accordingly, similar to the memory access device according to the first embodiment, in the memory access device according to the second embodiment of the present invention, the combination of the high-priority processing block and the memory controller 260 configuring the memory access device is not limited to the combination of the imaging input unit 221 and the memory controller 260. Similar to the memory access device according to the first embodiment, in the memory access device according to the second embodiment of the present invention, even if the memory access device is configured by the combination of the high-priority processing block different from the imaging input unit 221 and the memory controller 260, the operation of the memory access device can be simply considered by referring to the operation of the combination of the imaging input unit 221 and the memory controller 260 described above. Accordingly, a detailed description regarding the configuration and the operation of the memory access device according to the first embodiment of the present invention which is configured by the high-priority processing block different from the imaging input unit 221 and the memory controller 260 will be omitted.

In the first embodiment and the second embodiment of the present invention, it is described that the imaging input unit (the imaging input unit 220 or the imaging input unit 221) as the high-priority processing block to configure the memory access device 200 changes the designation sequence of the banks included in the DRAM 30 for storing the input image data according to the bank-busy-state signals output from the memory controller 260. However, the configuration for changing the designation sequence of the banks of the DRAM 30, as described in the first embodiment and the second embodiment, is not limited to the high-priority processing block configuring the memory access device. For example, the configuration element configured to change the designation sequence of the banks of the DRAM 30 may be provided outside the high-priority processing block. That is, the configuration configured to change the designation sequence of the banks of the DRAM 30 may not be provided inside the high-priority processing block configuring the memory access device.

### Third Embodiment

Next, a memory access device according to a third embodiment of the present invention will be described. The memory access device according to the third embodiment of the present invention is configured to change the designation sequence of the banks of the DRAM 30 by a configuration element provide outside the high-priority processing block configuring the memory access device. In the description below, the memory access device according to the third embodiment of the present invention will be described by referring to the case in which the memory access device is equipped in the image-processing device of the imaging device such as a camera for capturing still images, a camera for capturing videos and the like.

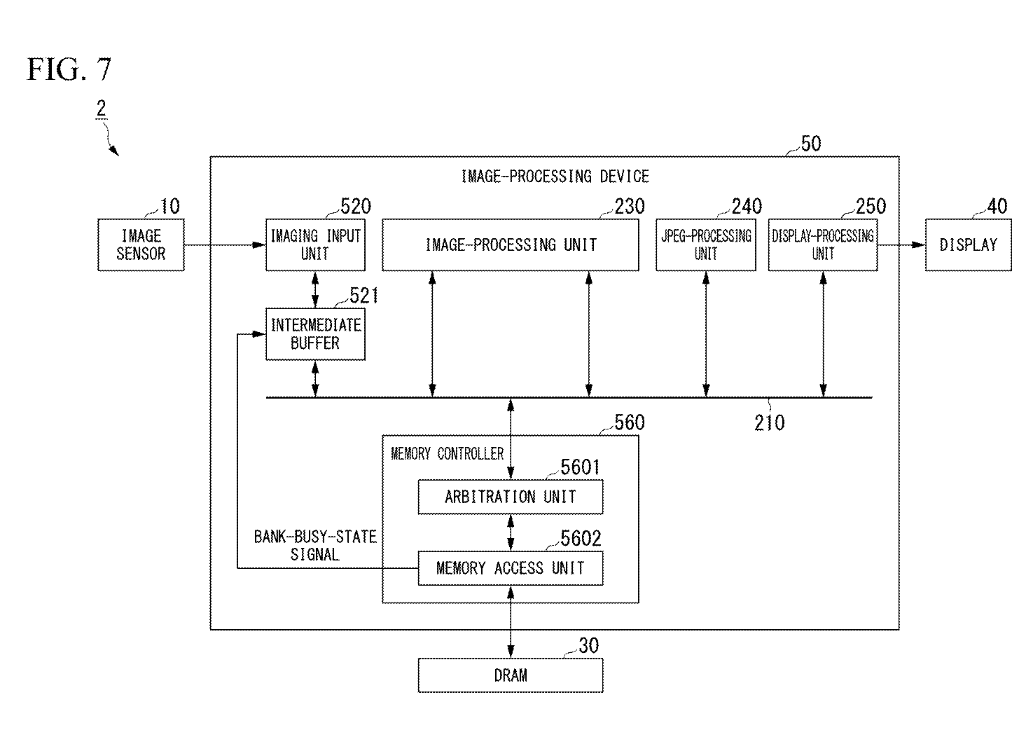

FIG. 7 is a block diagram showing the schematic configuration of the imaging device having the image-processing device with the memory access device according to the third embodiment of the present invention. The configuration of the imaging device having the image-processing device with the memory access device according to the third embodiment of the present invention has the same configuration elements with that of the imaging device 1 having the image-processing device 20 with the memory access device according to the first embodiment shown in FIG. 1 and the second embodiment. Accordingly, configuration elements of the imaging device having the image-processing device with the memory access device according to the third embodiment of the present invention which are same as the configuration elements of the imaging device 1 having the image-processing device 20 with the memory access device according to the first embodiment and the second embodiment will be designated with the same reference signs and a detailed description will be omitted.

As shown in FIG. 7, the imaging device 2 has the image sensor 10, the image-processing device 50, the DRAM 30, and the display 40. The image-processing device 50 has an imaging input unit 520, an intermediate buffer 521, the image-processing unit 230, the JPEG-processing unit 240, the display-processing unit 250, and a memory controller 560. In the image-processing device 50, each of the intermediate buffer 521, the image-processing unit 230, the JPEG-processing unit 240, the display-processing unit 250, and the memory controller 560 is connected to the common data bus 210. The memory controller 560 has an arbitration unit 5601 and a memory access unit 5602.

The imaging device 2, similar to the imaging device 1 having the image-processing device 20 with the memory access device according to the first embodiment and the second embodiment, is configured to capture the still image or the video of the object by the image sensor 10. The imaging device 2, similar to the imaging device 1, is configured to make the display 40 to display the display image according to the captured still image. The imaging device 2, similar to the imaging device 1, is configured to make the display 40 to display the display image according to the captured video. The imaging device 2, similar to the imaging device 1, is configured to make the recording medium (not shown) to store the storage image according to the captured still image and the video.

The image-processing device 50, similar to the image-processing device 20 having the memory access device according to the first embodiment and the second embodiment shown in FIG. 1, is configured to generate the still image and the video according to the pixel signals output from the image sensor 10, generate the display image in response to the still image and the video and make the display 40 to display the display image, and generate the storage image according to the still image and the video and make the recording medium (not shown) to store the storage image.

In the image-processing device 50, each of the imaging input unit 520, the image-processing unit 230, the JPEG-processing unit 240, and the display-processing unit 250 is the processing block configured to realize the image processing functions in the image-processing device 50. In the image-processing device 50, each of the imaging input unit 520, the image-processing unit 230, the JPEG-processing unit 240, and the display-processing unit 250 is configured to access the DRAM 30 by the DMA transmission. In the image-processing device 50, the memory access devices according to the third embodiment of the present invention are configured by the combinations of each processing block, the data transmission blocks corresponding to each processing block, and the memory controller 560. Similar to the image-processing device 20 having the memory access device according to the first embodiment and the second embodiment, in the image-processing device 50, the priority for accessing the DRAM 30 (performing the DMA transmission) is determined when the image processing is executed with respect to each processing block. Accordingly, in the image-processing device 50, similar to the image-processing device 20 having the memory access device according to the first embodiment and the second embodiment, all of the combinations of each processing block, the data transmission block corresponding to each processing block, and the memory controller 560 may not the memory access device according to the third embodiment of the present invention. That is, in the image-processing device 50, similar to the image-processing device 20 having the memory access device according to the first embodiment and the second embodiment, the memory access device is configured by the combination of the high-priority processing block, the data transmission block corresponding to the high-priority processing block, and the memory controller 560.

The data transmission block is configured to deliver the data between the corresponding high-priority processing block and the memory controller 560 by the DMA transmission via the data bus 210. The data transmission block is configured to temporarily store (buffering) the data (hereinafter “transmission data”) delivered with respect to the memory controller 560 via the data bus 210 during the data delivery with respect to the DRAM 30 by the DMA transmission. Also, the data transmission block is configured to change the designation sequence of the banks of the DRAM 30 according to the bank-busy-state signals output from the memory controller 560 during the data delivery with respect to the DRAM 30 by the DMA transmission.

In the description below, in order to make the description easy to understand, similar to the image-processing device 20 having the memory access device according to the first embodiment and the second embodiment, the imaging input unit 520 is described as the high-priority processing block. In the description below, only the combination of the imaging input unit 520 as the high-priority processing block, the data transmission block corresponding to the imaging input unit 520, and the memory controller 560 is described as the memory access device according to the third embodiment of the present invention (hereinafter “memory access device 500”).

Similar to the memory controller 260 configuring the memory access device according to the first embodiment and the second embodiment, the memory controller 560 is configured to arbitrate access requests (DMA requests) to the DRAM 30 by the DMA transmission from the processing blocks in the image-processing device 50 connected to the data bus 210, and the memory controller 560 is configured to accept the access request to the DRAM 30 from either of the processing blocks. The arbitration unit 5601 is an arbitration circuit (DMA arbitration circuit, arbiter) similar to the arbitration unit 2601 included in the memory controller 260 configuring the memory access device according to the first embodiment and the second embodiment. Similar to the memory controller 260 configuring the memory access device according to the first embodiment and the second embodiment, the memory controller 560 is configured to control the data delivery between the processing block whose access request is accepted and the DRAM 30 via the data bus 210. The memory access unit 5602 is a DRAM controller in the same manner as in the memory access unit 2602 included in the memory controller 260 configuring the memory access device according to the first embodiment and the second embodiment.

The memory controller 560 is also provided with a function of noticing information indicating operation states of the connected DRAM 30 according to the control with respect to the DRAM 30 in response to the request from the processing block whose access request is accepted, similar to the memory controller 260 configuring the memory access device according to the first embodiment and the second embodiment. That is, the memory controller 560 is configured to output the bank-busy-state signals, similar to the memory controller 260 configuring the memory access device according to the first embodiment and the second embodiment. However, the memory controller 560 in the image-processing device 50 is configured to output the bank-busy-state signals to the data transmission block configuring the memory access device 500 together with the memory controller 560.

In the memory controller 560, similar to the memory controller 260 configuring the memory access device according to the first embodiment and the second embodiment, either of the arbitration unit 5601, the memory access unit 5602, or other configuration element which is not shown may be configured to output the bank-busy-state signals. As shown in FIG. 7, a configuration of the imaging device 2 having the memory controller 560 with the memory access unit 5602 configured to output the bank-busy-state signals to the data transmission block (intermediate buffer 521) is shown. In the memory controller 560, in the case when the bank-busy-state signals are output by the arbitration unit 5601, the configuration thereof is same as that of the memory controller 260 configuring the memory access device according to the first embodiment and the second embodiment. That is, the image-processing device may have the memory controller 260 instead of the memory controller 560.

In the memory controller 560, similar to the memory controller 260 configuring the memory access device according to the first embodiment and the second embodiment, other operation information indicating the operation state of the DRAM 30 may be included as the operation information of the DRAM 30 being noticed to the intermediate buffer 521.

The intermediate buffer 521 is the data transmission block corresponding to the imaging input unit 520. Accordingly, in the image-processing device 50, the memory access device 500 according to the third embodiment of the present invention is configured by the combination of the imaging input unit 520, the intermediate buffer 521, and the memory controller 560.

The intermediate buffer 521 is configured to temporarily store the input image data as the transmission data output from the imaging input unit 520. Then, when the intermediate buffer 521 outputs the stored input image data to the DRAM 30 and make the DRAM 30 to store (write) the input image data, the intermediate buffer 521 outputs the access request signal (DMA request signal) for requesting the access to the DRAM 30, the address (DMA address) designating the memory region (including the bank) of the DRAM 30 to which the input image data is to be stored, and the access direction signal (DMA write signal) indicating the access direction when writing to the DRAM 30 to the memory controller 560. At this time, the intermediate buffer 521 is configured to change the designation sequence of the banks of the DRAM 30 for storing the input image data according to the bank-busy-state signals output from the memory controller 560.

The method of changing the designation sequence of the banks of the DRAM 30 in the intermediate buffer 521 is same as the method in the imaging input unit 220 configuring the memory access device according to the first embodiment and the second embodiment. That is, the intermediate buffer 521 is configured to change the designation sequence of the banks according to the addresses output together with the access request signals to the memory controller 560 so as to avoid the access to the banks of the DRAM 30 which are in the bank-busy state indicated by the bank-busy-state signals rather than designating the banks of the DRAM 30 in the predetermined sequence. Accordingly, the intermediate buffer 521 is configured to secure the bus band width for making the DRAM 30 to store (write) the input image data which is output from the imaging input unit 520.

The intermediate buffer 521 is provided outside the high-priority processing block and configured to realize the function of changing the designation sequence of the banks of the DRAM 30 in the memory access device according to the first embodiment and the second embodiment. Accordingly, the intermediate buffer 521 is configured by the buffer 2201 and the access selection unit 2202 which are included in the imaging input unit 220 as the configuration elements for realizing the function of changing the designation sequence of the banks of the DRAM 30 in the memory access device according to the first embodiment and the second embodiment. That is, the intermediate buffer 521 has the same configuration as shown in FIG. 2. Therefore, the buffer 2201 and the access selection unit 2202 are deleted from the imaging input unit 520 configuring the memory access device 500, and the imaging input unit 520 is configured to access the DRAM 30 via the intermediate buffer 521 by the DMA transmission. Accordingly, the overall configuration of the memory access device 500 is the same as that of the memory access device according to the first embodiment and the second embodiment. The operation of the intermediate buffer 521 and the operation of the whole memory access device 500 can be considered in the same manner as that of the memory access device according to the first embodiment and the second embodiment described using FIGS. 3-6. Accordingly, a detailed description of the configuration and operation of the intermediate buffer 521 and the whole memory access device 500 will be omitted.

In the present invention, the method of the delivery of the input image data between the imaging input unit 520 and the intermediate buffer 521 configuring the memory access device 500 according to the third embodiment of the present invention is not particularly limited. For example, the imaging input unit 520 may be configured to deliver the input image data to the intermediate buffer 521 by the same method as the procedures of transmitting the input image data to the DRAM 30 and making the DRAM 30 to store (write) the input image data by the DMA transmission. In this case, the imaging input unit 520 can output the input image data to the intermediate buffer 521 in spite of the bank-busy state of each bank included in the DRAM 30.

In this way, in the image-processing device 50, among the processing blocks in the image-processing device 50, the combination of the high-priority processing block with a high priority, the data transmission block corresponding to the high-priority processing block, and the memory controller 560 configures the memory access device 500 according to the third embodiment of the present invention.

As described above, according to the third embodiment, only the combination of the imaging input unit 520 as the high-priority processing block, the intermediate buffer 521 as the data transmission block corresponding to the imaging input unit 520, and the memory controller 560 is described as the memory access device (memory access device 500) according to the third embodiment of the present invention. However, in the imaging device 2, similar to the imaging device 1 having the image-processing device 20 with the memory access device according to the first embodiment and the second embodiment, the processing block operating as the high-priority processing block varies due to the operation mode of the imaging device 2. That is, in the imaging device 2, the processing block and the data transmission block combined with the memory controller 560 to configure the memory access device according to the third embodiment of the present invention vary due to each operation mode. However, as described above, in the memory access device according to the third embodiment of the present invention, different from the memory access device according to the first embodiment and the second embodiment, the data transmission block as the configuration element to realize the function of changing the designation sequence of the banks of the DRAM 30 is provided outside the high-priority processing block. Accordingly, according to the third embodiment, the data transmission block may be shared by a plurality of processing blocks.

More specifically, in the image-processing device 20 included in the memory access device according to the first embodiment and the second embodiment, in the case in which it is possible that all of the processing blocks in the image-processing device 20 become the high-priority processing blocks due to the operation mode of the imaging device 1, even if not at the same time, it is considerable to provide the function of changing the designation sequence of the banks of the DRAM 30 in all of the processing blocks and execute the function when the processing block becomes the high-priority processing block. That is, it is considerable to preliminary provide the function of changing the designation sequence of the banks of the DRAM 30 in the low-priority processing block in a specific operation mode of the imaging device 1 in consideration of the possibility that the processing block may become the high-priority processing block in another operation mode of the imaging device 1.

On the other hand, in the image-processing device 50 included in the memory access device according to the third embodiment of the present invention, in consideration of the operation modes of the imaging device 2, it is possible to preliminary provide a plurality of data transmission blocks with a number equal to the number of the most processing blocks simultaneously become the high-priority processing blocks such that the processing blocks which do not simultaneously become the high-priority processing blocks can share the data transmission block. That is, in the image-processing device 50 having the memory access device according to the third embodiment of the present invention, it is considerable to not to provide the plurality of data transmission blocks exclusively corresponding to each of all the processing blocks. In this case, according to the image-processing device 50 having the memory access device according to the third embodiment of the present invention, it is possible to reduce the image-processing devices 50 to include the data transmission blocks than that of the image-processing device 20 including the memory access device according to the first embodiment and the second embodiment.

According to the third embodiment, the memory access device (memory access device 500) is configured to have the buffer (buffer 2201) and the access selection unit (access selection unit 2202) configured as the intermediate buffer 521 outside the high-priority processing block (for example, the imaging input unit 520).

As described above, the memory access device 500 according to the third embodiment of the present invention is configured by the combination of the imaging input unit 520 (high-priority processing block), the intermediate buffer 521 (data transmission block), and the memory controller 560. The memory access device 500 according to the third embodiment of the present invention is configured to operate in the same manner as that of the memory access device according to the first embodiment and the second embodiment. More specifically, in the memory access device 500 according to the third embodiment of the present invention, the memory controller 560 is configured to output the bank-busy-state signals (operation information of the DRAM 30) indicating whether each bank of the connected DRAM 30 is in the bank-busy state. Then, in the memory access device 500 according to the third embodiment of the present invention, the intermediate buffer 521 is configured to change the designation sequence of each bank according to the bank-busy-state signals output from the memory controller 560 so as to not to designate the bank in the bank-busy state (avoid the access to the bank in the bank-busy state) when the imaging input unit 520 transmits the input image data to the DRAM 30. Accordingly, in the memory access device 500 according to the third embodiment of the present invention, similar to the memory access device according to the first embodiment and the second embodiment, the access efficiency to the DRAM 30 by the imaging input unit 520 (high-priority processing block) can be improved, and the bus band width for the imaging input unit 520 (high-priority processing block) to access the DRAM 30 (to make the DRAM 30 to store (write) the input image data) can be secured.

As described above, the configuration of the memory access device 500 according to the third embodiment of the present invention is described using the example of the combination of the imaging input unit 520 (high-priority processing block), the intermediate buffer 521 (data transmission block), and the memory controller 560; however, as described above, the high-priority processing block varies due to the operation mode of the imaging device 2. Accordingly, the combination of the high-priority processing block, the data transmission block, and the memory controller 560 configuring the memory access device according to the third embodiment of the present invention is not limited to the combination of the imaging input unit 520, the intermediate buffer 521, and the memory controller 560. Even if the memory access device according to the third embodiment of the present invention is configured by the combination of the high-priority processing block different from the imaging input unit 520, the data transmission block, and the memory controller 560, the operation thereof can be easily considered by the same operation of the memory access device according to the first embodiment and the second embodiment.

According to the first embodiment to the third embodiment of the present invention, it is described that the operation information of the DRAM 30 is the bank-busy-state signal indicating whether or not each bank of the DRAM 30 is in the bank-busy state, and the memory access devices according to the first embodiment to the third embodiment are configured to change the designation sequence of the banks of the DRAM 30 according to the bank-busy-state signals. However, as described above, the operation information of the DRAM 30 is not limited to the bank-busy-state signal, and may be other operation information indicating the operation state of the DRAM 30. The other operation information of the DRAM 30, for example, may be the information indicating the time when the bank-busy state of the DRAM 30 is canceled.

### Fourth Embodiment

Next, a memory access device according to a fourth embodiment of the present invention will be described. In the memory access device according to the fourth embodiment of the present invention, a high-priority processing block configuring the memory access device is configured to determine the designation sequence of the banks designated in each access request according to the operation state indicating the time required until the bank-busy state is canceled. In the description below, the memory access device according to the fourth embodiment of the present invention will be described by referring to the case in which the memory access device is equipped in the image-processing device of the imaging device such as a camera for capturing still images, a camera for capturing videos and the like. Also, the scope of the memory access device according to the fourth embodiment of the present invention, that is, the scope of determining the designation sequence of the banks designated in each access request according to the operation state indicating the time required until the bank busy state is canceled, can be applied to the memory access device according to either of the first embodiment to the third embodiment. In the description below, the scope of the memory access device according to the fourth embodiment of the present invention will be described in the case of applying the scope to the memory access device 200 according to the first embodiment.

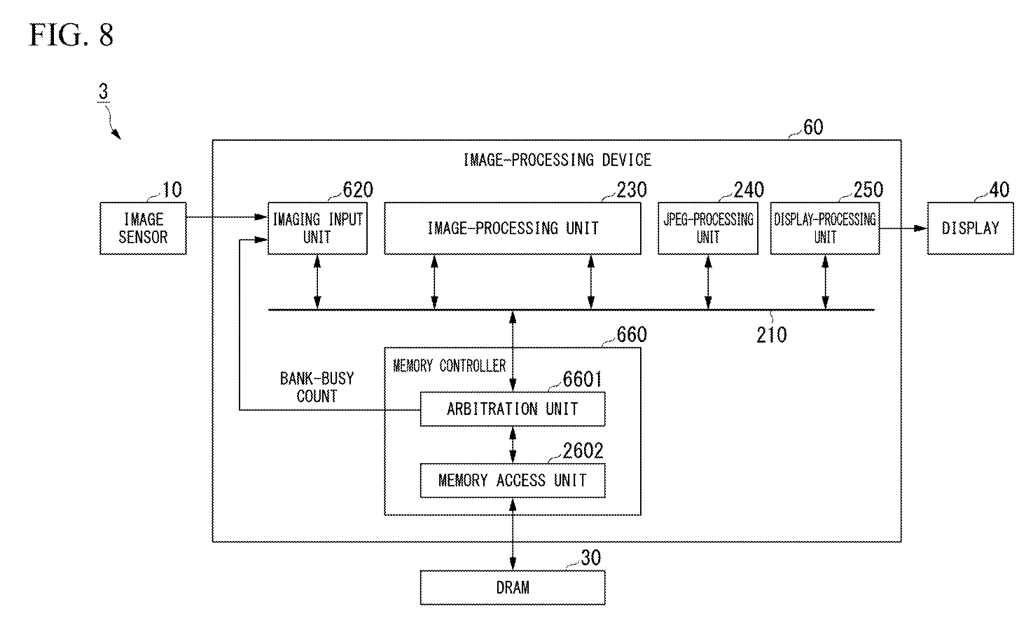

FIG. 8 is a schematic block diagram showing a configuration of an imaging device having an image-processing device with the memory access device according to the fourth embodiment of the present invention. The configuration of the imaging device having the image-processing device with the memory access device according to the fourth embodiment of the present invention has the same configuration elements with that of the imaging device 1 having the image-processing device 20 with the memory access device 200 according to the first embodiment shown in FIG. 1. Accordingly, configuration elements of the imaging device having the image-processing device with the memory access device according to the fourth embodiment of the present invention which are same as the configuration elements of the imaging device 1 having the image-processing device 20 with the memory access device 200 according to the first embodiment will be designated with the same reference signs and a detailed description will be omitted.

The imaging device 3 as shown in FIG. 8 has the image sensor 10, the image-processing device 60, the DRAM 30, and the display 40. The image-processing device 60 has the imaging input unit 620, the image-processing unit 230, the JPEG-processing unit 240, the display-processing unit 250, and the memory controller 660. In the image-processing device 60, each of the imaging input unit 620, the image-processing unit 230, the JPEG-processing unit 240, the display-processing unit 250, and the memory controller 660 is connected to the common data bus 210. The memory controller 660 has an arbitration unit 6601 and a memory access unit 6602.

Similar to the imaging device 1 having the image-processing device 20 with the memory access device 200 according to the first embodiment, the imaging device 3 is configured to capture the still image or the video of the object by the image sensor 10. The imaging device 3, similar to the imaging device 1, is configured to make the display 40 to display the display image according to the captured still image and the video. The imaging device 3, similar to the imaging device 1, is configured to make the recording medium (not shown) to store the storage image according to the captured still image and the video.

The image-processing device 60, similar to the image-processing device 20 having the memory access device according to the first embodiment and the second embodiment shown in FIG. 1, is configured to generate the still image and the video according to the pixel signals output from the image sensor 10, generate the display image in response to the still image and the video and make the display 40 to display the display image, and generate the storage image according to the still image and the video and make the recording medium (not shown) to store the storage image.

In the image-processing device 60, each of the imaging input unit 620, the image-processing unit 230, the JPEG-processing unit 240, and the display-processing unit 250 is the processing block configured to realize the image processing functions in the image-processing device 60. In the image-processing device 60, each of the imaging input unit 620, the image-processing unit 230, the JPEG-processing unit 240, and the display-processing unit 250 is configured to access the DRAM 30 by the DMA transmission via the data bus 210. In the image-processing device 60, the memory access devices are configured by the combinations of each processing block and the memory controller 660. Similar to the image-processing device 20 having the memory access device 200 according to the first embodiment, in the image-processing device 60, the priority for accessing the DRAM 30 (performing the DMA transmission) is determined when the image processing is executed with respect to each processing block. Accordingly, in the image-processing device 60, similar to the image-processing device 20 having the memory access device according to the first embodiment, all of the combinations of each processing block and the memory controller 660 may not the memory access device according to the fourth embodiment of the present invention. That is, in the image-processing device 60, similar to the image-processing device 20 having the memory access device according to the first embodiment, the memory access device is configured by the combination of the high-priority processing block and the memory controller 660.

In the description below, in order to make the description easy to understand, similar to the image-processing device 20 having the memory access device according to the first embodiment, the imaging input unit 620 is described as the high-priority processing block, and only the combination of the imaging input unit 620 as the high-priority processing block and the memory controller 660 is described as the memory access device according to the fourth embodiment of the present invention (hereinafter “memory access device 600”).

Similar to the memory controller 260 configuring the memory access device according to the first embodiment, the memory controller 660 is configured to arbitrate access requests (DMA requests) to the DRAM 30 by the DMA transmission from the processing blocks in the image-processing device 60 connected to the data bus 210, and the memory controller 660 is configured to accept the access request to the DRAM 30 from either of the processing blocks. Similar to the memory controller 260 configuring the memory access device according to the first embodiment, the memory controller 660 is configured to control the data delivery between the processing block whose access request is accepted and the DRAM 30 via the data bus 210. The memory controller 660 is also provided with a function of noticing the information indicating operation states of the connected DRAM 30 according to the control with respect to the DRAM 30 in response to the request from the processing block whose access request is accepted, similar to the memory controller 260 configuring the memory access device according to the first embodiment.

However, the memory controller 660 is different from the memory controller 260 configuring the memory access device 200 according to the first embodiment in that the memory controller 660 is configured to notice the information indicating time required until a predetermined period (a certain period) during which it is impossible to access the memory region (bank) of the DRAM 30 is elapsed, that is, the time required until the bank-busy state is canceled as the operation information of the connected DRAM 30. Accordingly, the memory controller 660 is configured to output the operation state indicating the time required until the bank-busy state is canceled by each bank included in the DRAM 30 to the imaging input unit 620 configuring the memory access device 600 together with the memory controller 660. The operation state indicating the time required until the bank-busy state is canceled which is noticed by the memory controller 660 is, for example, the information of a count value indicating the number of clocks required until the bank-busy state is canceled. In the description below, the memory controller 660 is described as the configuration to output the information of the count value (hereinafter “bank-busy count”) indicating the number of clocks required until the bank-busy state is canceled as the operation information of the DRAM 30 to the imaging input unit 620.

The arbitration unit 6601 is an arbitration circuit (DMA arbitration circuit, arbiter) similar to the arbitration unit 2601 included in the memory controller 260 configuring the memory access device 200 according to the first embodiment. However, the arbitration unit 6601 is configured to output the bank-busy count to the imaging input unit 620 instead of the bank-busy-state signal output by the arbitration unit 2601 equipped in the memory controller 260 configuring the memory access device 200 according to the first embodiment.

In the memory controller 660, similar to the memory controller 260 configuring the memory access device 200 according to the first embodiment, either of the arbitration unit 6601, the memory access unit 6602, or other configuration element (not shown) which are included in the memory controller 660 may be configured to output the bank-busy count if they are able to detect the operation state of the connected DRAM 30. Similar to the memory controller 260 configuring the memory access device 200 according to the first embodiment, in the memory controller 660, other operation information indicating the operation state of the DRAM 30 may be included as the operation information of the DRAM 30 being noticed to the imaging input unit 620.

Similar to the imaging input unit 220 configuring the memory access device 200 according to the first embodiment, the imaging input unit 620 is the processing block configured to make the DRAM 30 to store (write) the input image data output from the image sensor. The imaging input unit 620 is also the processing block (high-priority processing block) configuring the memory access device 600 according to the fourth embodiment of the present invention. However, when the imaging input unit 620 makes the DRAM 30 to store (write) the input image data by the DMA transmission, the imaging input unit 620 is configured to determine whether to change the designation sequence of the banks of the DRAM 30 for storing the input image data according to the bank-busy counts output from the memory controller 660. The imaging input unit 620 is configured to change the designation sequence of the banks only when it is determined to change the designation sequence of the banks of the DRAM 30. According to such an operation, the imaging input unit 620 can secure the bus band width for making the DRAM 30 to store (write) the input image data.

More specifically, the imaging input unit 620 is configured to determine to avoid the access to the bank of the DRAM 30 which is in the bank-busy state when the count value of the bank-busy count (time required until the bank-busy state is canceled) output from the memory controller 660 is equal to or larger than a predetermined threshold. In this case, the imaging input unit 620 is configured to change the designation sequence of the banks, similar to the imaging unit 220 configuring the memory access device 200 according to the first embodiment. On the other hand, when the count value of the bank-busy count output from the memory controller 660 is smaller than the predetermined threshold, the imaging input unit 620 is configured to not to avoid the access to the bank of the DRAM 30 in the bank-busy state, that is, the imaging input unit 620 determines to access the bank of the DRAM 30 in the bank-busy state. In this case, the imaging input unit 620 is configured to designate the banks in the predetermined sequence. Here, the predetermined threshold for the imaging input unit 620 to determine whether to change the designation sequence of the banks of the DRAM 30 is the count value determined according to the acceptable time when the access to the DRAM 30 is kept waiting. The imaging input 620 is configured to designate the predetermined banks without changing the designation banks when the imaging input 620 determines that the bank-busy state will be canceled during the acceptable waiting time in the transmission of the input image data to the DRAM 30 even if the banks of the DRAM 30 to be accessed are in the bank-busy state. For example, the predetermined threshold is the count value indicating the time required for the procedures of accessing the DRAM 30. In this case, if the imaging input unit 620 can determine that the bank-busy state of the banks to be accessed will be canceled until the input image data is actually transmitted to the DRAM 30, the imaging input unit 620 is configured to designate the banks scheduled to access without changing the designation banks.

The imaging input unit 620 has the same configuration as that of the imaging input unit 220 configuring the memory access device 200 according to the first embodiment shown in FIG. 2. However, the memory access device 600 according to the fourth embodiment of the present invention is configured to determine the designation sequence of the banks according to the bank-busy count therefore the operation of the access selection unit is different from that of the access selection unit 2202 equipped in the memory access device 200 according to the first embodiment. In the description below, the access selection unit equipped in the memory access device 600 is described as “access selection unit 6202” in order to be distinguished from the access selection unit 2202 of the memory access device 200 according to the first embodiment.

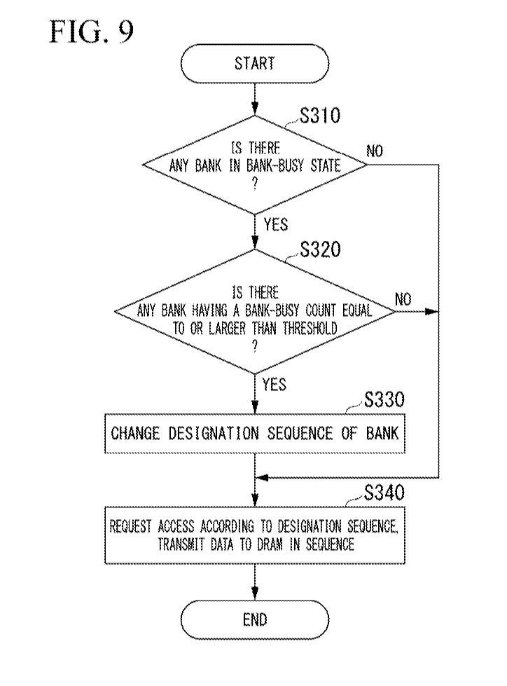

Next, the operation of the memory access device 600 according to the fourth embodiment of the present invention, that is, the process of changing the designation sequence of the banks when the access selection unit 6202 transmits the bank data to the DRAM 30 will be described. FIG. 9 is a flow chart showing processing procedures of the memory access device 600 according to the fourth embodiment of the present invention to change the banks to access; that is, the processing procedures to determine whether to change the designation sequence of the banks. In the description below, it is described that the bank-busy count corresponding to each bank of the DRAM 30 is sequentially output from the memory controller 660.

When the input image data output from the image sensor 10 to the imaging input unit 620 is buffered in the buffer 2201, the buffer 2201 is configured to parallelly output the bank addresses and the bank access request signals for requesting the transmission of the buffered input image data to each bank of the DRAM 30 to the access selection unit 6202. Accordingly, the access selection unit 6202 is configured to determine whether there is any bank in the bank-busy state according to the bank-busy counts output from the memory controller 660 (Step S310).

In Step S310, if it is determined that there is no bank in the bank-busy state, that is, all of the banks configured in the DRAM 30 are not in the bank-busy state (“NO” in Step S310), the access selection unit 6202 proceeds to Step S340.

On the other hand, if it is determined that the bank in the bank-busy state exists (“YES” in Step S310), the access selection unit 6202 determines whether the bank-busy counts output from the memory controller 660 are equal to or larger than the predetermined threshold (Step S320). That is, in Step S320, the access selection unit 6202 is configured to confirm whether there is any bank whose time required for the bank-busy state to be canceled is longer than the predetermined threshold.

In Step S320, if it is determined that there is no bank whose bank-busy count is equal to or larger than the predetermined threshold (“NO” in Step S320), the access selection unit 6202 proceeds to Step S340. That is, in Step S320, in the case in which the access selection unit 6202 determines that there are banks in the bank-busy state among the banks configuring the DRAM 30, however, the bank-busy state of all of the banks in the bank-busy state will be canceled during a period shorter than the time according to the predetermined threshold, the access selection unit 6202 determines to not to avoid the access to the banks in the bank-busy state to continue the access processing, and proceeds to Step s340.

On the other hand, in Step S320, if it is determined that there is a bank whose bank-busy count is equal to or larger than the predetermined threshold (“YES” in Step S320), the access selection unit 6202 is configured to change the designation sequence of the banks (Step S330). More specifically, the access selection unit 6202 is configured to change the designation sequence of the banks among the banks to be designated in the predetermined sequence so as to postpone the sequence of the banks whose bank-busy state cannot be canceled until the timing when the banks are actually accessed and firstly designate the banks not in the bank-busy state and the banks whose bank-busy state will be canceled until the timing when the banks are actually accessed.

Subsequently, the access selection unit 6202 outputs the access requests to the memory controller 660 in the designation sequence of the banks in the DRAM 30, and the access selection unit 6202 sequentially transmits the input image data buffered in the buffer 2201 to the DRAM 30 (Step S340). More specifically, when it is determined that there is no bank in the bank-busy state in Step S310, or there are only the banks whose bank-busy state will be canceled until the timing when the banks are actually accessed in Step S320, the access selection unit 6202 outputs the access requests to the memory controller 660 in the predetermined designation sequence of the banks in the DRAM 30, and sequentially transmits the bank data (input image data) corresponding to each bank to the DRAM 30. On the other hand, when it is determined that the bank in the bank-busy state exists in Step S310, and there are the banks whose bank-busy state cannot be canceled until the timing when the banks are actually accessed in Step S320, the access selection unit 6202 outputs the access requests to the memory controller 660 in the changed sequence changed in Step S330, and sequentially transmits the bank data (input image data) corresponding to each bank to the DRAM 30.

According to such configuration and operation, the memory access device 600 according to the fourth embodiment of the present invention is configured to determine whether the banks included in the DRAM 30 are the banks whose bank-busy state are canceled until the timing when the banks are actually accessed, and the memory access device 600 is configured to control the data delivery (DMA transmission) while avoiding the access to the banks whose bank-busy state will not be canceled. Accordingly, according to the memory access device 600 according to the fourth embodiment of the present invention, similar to the memory access device 200 according to the first embodiment, the efficiency of the access to the DRAM 30 by the imaging input unit 620 can be improved, and the bus band width for the imaging input unit 620 to store (write) the input image data into the DRAM 30 can be secured. Also, similar to the memory access device according to the first embodiment, the memory access device 600 according to the fourth embodiment of the present invention can shorten the period until the data transmission due to the consecutive access requests (for example, the DMA transmission of consecutively designating the 8 banks configured in the DRAM 30) is finished.

In the description above, it is described to apply the scope of the memory access device 600 according to the fourth embodiment of the present invention to the configuration of the memory access device 200 according to the first embodiment. That is, the memory access device 600 according to the fourth embodiment of the present invention is configured to determine the designation sequence of each bank according to the bank-busy count immediately before the output of the initial access request so as to not to designate the banks whose bank-busy state is not canceled until the timing when the banks are actually accessed (avoid the access to the banks in the bank-busy state) with respect to each access request. However, as described above, the scope of the memory access device 600 according to the fourth embodiment of the present invention can be applied to the memory access device according to either of the first embodiment to the third embodiment. For example, in the case of applying the scope of the memory access device 600 according to the fourth embodiment of the present invention to the memory access device 201 according to the second embodiment, it is possible to determine whether the bank-busy state is canceled until the actual access timing with respect to each access request, and perform the data delivery (DMA transmission) while avoiding the access to the banks in the bank-busy state at the actual access timing. Furthermore, for example, in the case of applying the scope of the memory access device 600 according to the fourth embodiment of the present invention to the memory access device 500 according to the third embodiment, in the memory access device configured to include the data transmission block, it is possible to perform the data delivery (DMA transmission) while avoiding the access to the banks in the bank-busy state at the actual access timing with respect to the DRAM 30.

According to the present fourth embodiment, the operation information is described as the information indicating the time required until the predetermined period during which it is impossible to access the given bank is elapsed (the bank-busy count as the count value information of the number of clocks required until the bank-busy state is canceled) by each bank. Also, according to the present fourth embodiment, the access selection unit (access selection unit 6202) of the memory access device (memory access device 600) is configured to not to avoid the access to the given bank (bank in the bank-busy state) when the time required (bank-busy count) until the predetermined period (bank-busy state) during which it is impossible to access the given bank is elapsed is smaller than the predetermined threshold according to the bank-busy count, and the access selection unit (access selection unit 6202) is configured to change the designation sequence of the banks so as to avoid the access to the given bank (bank in the bank-busy state) when the time required (bank-busy count) until the predetermined period (bank-busy state) during which it is impossible to access the given bank is elapsed is equal to or longer than the predetermined threshold.

As described above, in the memory access device 600 according to the fourth embodiment of the present invention, the memory controller 660 is configured to output the bank-busy count (operation information of the DRAM 30) indicating the time required until the bank-busy state of each bank of the connected DRAM 30 is canceled. In the memory access device 600 according to the fourth embodiment of the present invention, the imaging input unit 620 (high-processing unit) is configured to determine whether the bank is the one whose bank-busy state is canceled until the actual access timing with respect to the DRAM 30 according to the bank-busy count. Then, in the memory access device 600 according to the fourth embodiment of the present invention, the imaging input unit 620 (high-priority processing block) is configured to determine the designation sequence of the banks so as to not to designate the banks whose bank-busy state is not canceled until the actual access timing (avoid the access to the banks in the bank-busy state). Accordingly, similar to the memory access device according to the first embodiment to the third embodiment, according to the memory access device 600 according to the fourth embodiment of the present invention, the efficiency of the access to the DRAM 30 by the imaging input unit 620 (high-priority processing block) can be improved, and the bus band width for the imaging input unit 620 (high-priority processing block) to access the DRAM 30 (store (write) the input image data into the DRAM 30) can be secured.

In the description above, similar to the memory access device according to the first embodiment to the third embodiment, the memory access device 600 according to the fourth embodiment of the present invention is described by the example of the combination of the imaging input unit 620 (high-priority processing block) and the memory controller 660. However, in the memory access device 600 according to the fourth embodiment of the present invention, similar to the memory access device according to the first embodiment to the third embodiment, the high-processing block varies due to the operation mode of the imaging device 3. Accordingly, in the memory access device according to the fourth embodiment of the present invention, similar to the memory access device according to the first embodiment to the third embodiment, the combination of the high-priority processing block and the memory controller 660 configuring the memory access device is not limited to the combination of the imaging input unit 620 and the memory controller 660. Even if the memory access device according to the fourth embodiment of the present invention is configured by the s15 combination of the high-priority processing block different from the imaging input unit 620 and the memory controller 660, the operation thereof can be easily considered to be same as the operation of the memory access device 600 according to the fourth embodiment described above.

According to the first embodiment to the fourth embodiment of the present invention, the operation information of the DRAM 30 which is output by the memory controller is described to be a single type. However, the operation information of the DRAM 30 output by the memory controller is not limited to the single type and may be multiple types. For example, the memory controller may be configured to output both of the bank-busy-state signal and the bank-busy count as the operation information of the DRAM 30.

### Fifth Embodiment

Next, a memory access device according to a fifth embodiment of the present invention will be described. In the memory access device according to the fifth embodiment of the present invention, a memory controller configuring the memory access device is configured to output multiple types of the operation information of the DRAM 30 and a high-processing block configuring the memory access device is configured to determine the designation sequence of the banks in each access request according to the multiple types of the operation information. In the description below, the memory access device according to the fifth embodiment of the present invention will be described by referring to the case in which the memory access device is equipped in the image-processing device of the imaging device such as a camera for capturing still images, a camera for capturing videos and the like. Also, the scope of the memory access device according to the fifth embodiment of the present invention, that is, the scope of determining the designation sequence of the banks designated in each access request according to the multiple types of the operation information of the DRAM 30, can be applied to the memory access device according to either of the first embodiment to the fourth embodiment. In the description below, the scope of the memory access device according to the fifth embodiment of the present invention will be described in the case of applying the scope to the memory access device 200 according to the first embodiment.

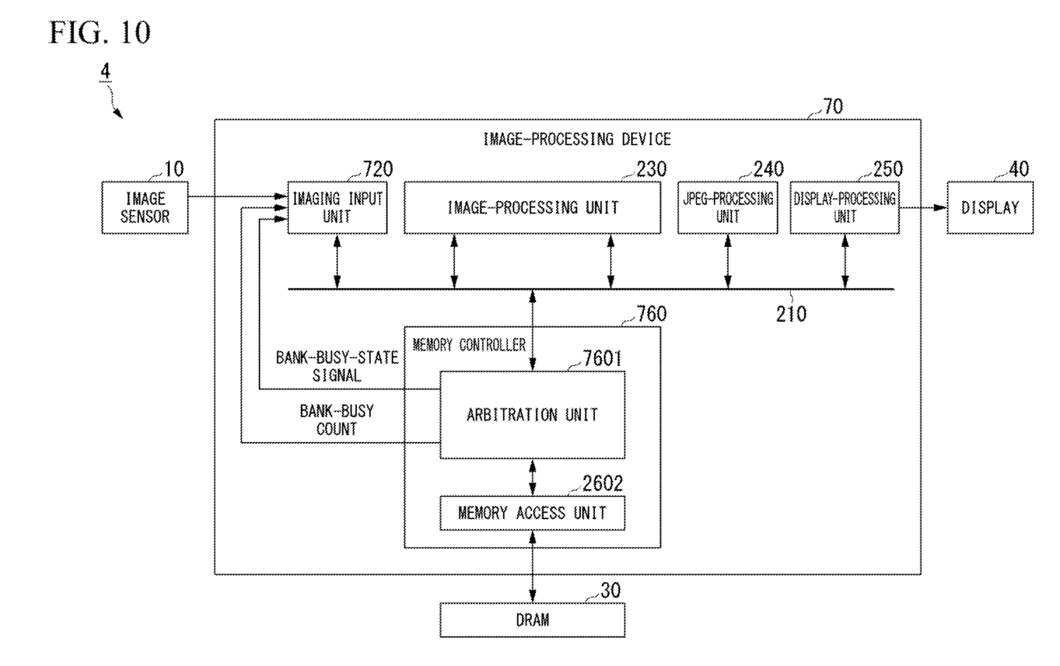

FIG. 10 is a schematic block diagram showing a configuration of an imaging device having an image-processing device with the memory access device according to the fifth embodiment of the present invention. The configuration of the imaging device having the image-processing device with the memory access device according to the fifth embodiment of the present invention has the same configuration elements with that of the imaging device 1 having the image-processing device 20 with the memory access device 200 according to the first embodiment shown in FIG. 1. Accordingly, configuration elements of the imaging device having the image-processing device with the memory access device according to the fifth embodiment of the present invention which are same as the configuration elements of the imaging device 1 having the image-processing device 20 with the memory access device 200 according to the first embodiment will be designated with the same reference signs and a detailed description will be omitted.

The imaging device 4 as shown in FIG. 10 has the image sensor 10, the image-processing device 70, the DRAM 30, and the display 40. The image-processing device 70 has the imaging input unit 720, the image-processing unit 230, the JPEG-processing unit 240, the display-processing unit 250, and the memory controller 760. In the image-processing device 70, each of the imaging input unit 720, the image-processing unit 230, the JPEG-processing unit 240, the display-processing unit 250, and the memory controller 760 is connected to the common data bus 210. The memory controller 760 has an arbitration unit 7601 and a memory access unit 7602.

Similar to the imaging device 1 having the image-processing device 20 with the memory access device 200 according to the first embodiment, the imaging device 4 is configured to capture the still image or the video of the object by the image sensor 10. The imaging device 4, similar to the imaging device 1, is configured to make the display 40 to display the display image according to the captured still image and the video. The imaging device 4, similar to the imaging device 1, is configured to make the recording medium (not shown) to store the storage image according to the captured still image and the video.

The image-processing device 70, similar to the image-processing device 20 having the memory access device according to the first embodiment and the second embodiment shown in FIG. 1, is configured to generate the still image and the video according to the pixel signals output from the image sensor 10, generate the display image in response to the still image and the video and make the display 40 to display the display image, and generate the storage image according to the still image and the video and make the recording medium (not shown) to store the storage image.

In the image-processing device 70, each of the imaging input unit 720, the image-processing unit 230, the JPEG-processing unit 240, and the display-processing unit 250 is the processing block configured to realize the image processing functions in the image-processing device 70. In the image-processing device 70, each of the imaging input unit 720, the image-processing unit 230, the JPEG-processing unit 240, and the display-processing unit 250 is configured to access the DRAM 30 by the DMA transmission via the data bus 210. In the image-processing device 70, the memory access devices are configured by the combinations of each processing block and the memory controller 760. Similar to the image-processing device 20 having the memory access device 200 according to the first embodiment, in the image-processing device 70, the priority for accessing the DRAM 30 (performing the DMA transmission) is determined when the image processing is executed with respect to each processing block. Accordingly, in the image-processing device 70, similar to the image-processing device 20 having the memory access device according to the first embodiment, all of the combinations of each processing block and the memory controller 760 may not the memory access device according to the fifth embodiment of the present invention. That is, in the image-processing device 70, similar to the image-processing device 20 having the memory access device according to the first embodiment, the memory access device is configured by the combination of the high-priority processing block and the memory controller 760.

In the description below, in order to make the description easy to understand, similar to the image-processing device 20 having the memory access device according to the first embodiment, the imaging input unit 720 is described as the high-priority processing block, and only the combination of the imaging input unit 720 as the high-priority processing block and the memory controller 760 is described as the memory access device according to the fifth embodiment of the present invention (hereinafter “memory access device 700”).

Similar to the memory controller 260 configuring the memory access device according to the first embodiment, the memory controller 760 is configured to arbitrate access requests (DMA requests) to the DRAM 30 by the DMA transmission from the processing blocks in the image-processing device 70 connected to the data bus 210, and the memory controller 760 is configured to accept the access request to the DRAM 30 from either of the processing blocks. Similar to the memory controller 260 configuring the memory access device according to the first embodiment, the memory controller 760 is configured to control the data delivery between the processing block whose access request is accepted and the DRAM 30 via the data bus 210. The memory controller 760 is also provided with a function of noticing the information indicating operation states of the connected DRAM 30 according to the control with respect to the DRAM 30 in response to the request from the processing block whose access request is accepted, similar to the memory controller 260 configuring the memory access device according to the first embodiment.

However, the memory controller 760 is different from the memory controller 260 configuring the memory access device 200 according to the first embodiment in that the memory controller 660 is configured to notice both of the operation information (bank-busy-state signal) indicating whether each of the banks of the DRAM 30 is in the bank-busy state and the operation information (bank-busy count) indicating the time required for the bank-busy state to be canceled as the operation information of the connected DRAM 30. Accordingly, the memory controller 760 is configured to output both the bank-busy-state signal and the bank-busy count of each bank included in the DRAM 30 to the imaging input unit 720 configuring the memory access device 700 together with the memory controller 760.

The arbitration unit 7601 is an arbitration circuit (DMA arbitration circuit, arbiter) similar to the arbitration unit 2601 included in the memory controller 260 configuring the memory access device 200 according to the first embodiment. However, the arbitration unit 7601 is configured to output both of the bank-busy-state signal output by the arbitration unit 2601 equipped in the memory controller 260 configuring the memory access device 200 according to the first embodiment and the bank-busy count output by the arbitration unit 6601 equipped in the memory controller 660 configuring the memory access device 600 according to the fourth embodiment, to the imaging input unit 720.

In the memory controller 760, similar to the memory controller 260 configuring the memory access device 200 according to the first embodiment, either of the arbitration unit 7601, the memory access unit 7602, or other configuration element (not shown) which are included in the memory controller 660 may be configured to output the bank-busy-state signal and the bank-busy count if they are able to detect the operation state of the connected DRAM 30. In the memory controller 760, different configuration element may output the bank-busy-state signal and the bank-busy count. For example, in the memory controller 760, similar to the memory controller 560 configuring the memory access device 500 according to the third embodiment, the memory access unit 5602 may output the bank-busy-state signal and similar to the memory controller 660 configuring the memory access device 600 according to the fourth embodiment, the arbitration unit 6601 may output the bank-busy count. Similar to the memory controller 260 configuring the memory access device 200 according to the first embodiment, in the memory controller 760, other operation information indicating the operation state of the DRAM 30 may be included as the operation information of the DRAM 30 being noticed to the imaging input unit 720.

More specifically, similar to the imaging input unit 220 configuring the memory access device 200 according to the first embodiment, the imaging input unit 720 is the processing block configured to make the DRAM 30 to store (write) the input image data output from the image sensor 10. The imaging input unit 720 is also the processing block (high-priority processing block) configuring the memory access device 700 according to the fifth embodiment of the present invention. However, when the imaging input unit 720 transmits the input image data by the DMA transmission and make the DRAM 30 to store (write) the input image data, the imaging input unit 720 is configured to change the designation sequence of the banks of the DRAM 30 for storing the input image data according to the bank-busy-state signal and the bank-busy count output from the memory controller 760.

More specifically, the imaging input unit 720 is configured to determine whether there is any bank in the bank-busy state according to the bank-busy-state signal output from the memory controller 760, and the imaging input unit 720 is configured to determine whether to change the designation sequence of the banks according to the bank-busy count output from the memory controller 760. The imaging input unit 720 changes the designation sequence of the banks only when it is determined to change the designation sequence of the banks of the DRAM 30. According to such an operation, the imaging input unit 720 can secure the bus band width for making the DRAM 30 to store (write) the input image data.

The imaging input unit 720 has the same configuration as that of the imaging input unit 220 configuring the memory access device 200 according to the first embodiment shown in FIG. 2. However, the memory access device 700 according to the fifth embodiment of the present invention is configured to determine the designation sequence of the banks according to the bank-busy-state signal and the bank-busy count, therefore the operation of the access selection unit is different from that of the access selection unit 2202 equipped in the memory access device 200 according to the first embodiment. In the description below, the access selection unit equipped in the memory access device 700 is described as “access selection unit 7202” in order to be distinguished from the access selection unit 2202 of the memory access device 200 according to the first embodiment.

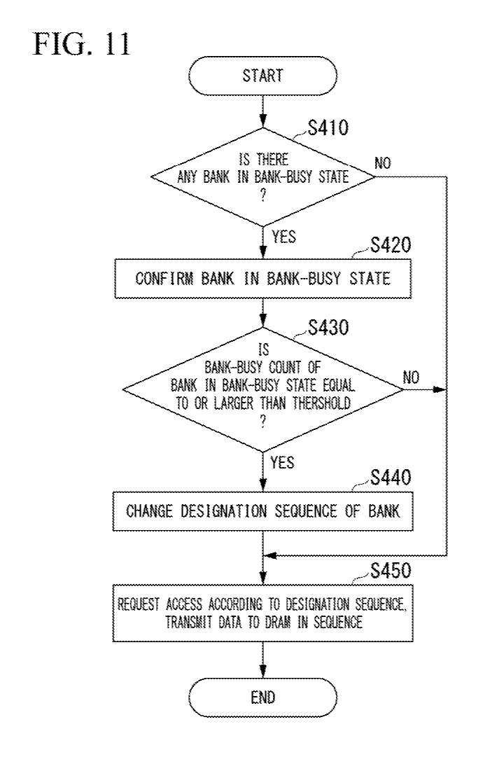

Next, the operation of the memory access device 700 according to the fifth embodiment of the present invention, that is, the process of changing the designation sequence of the banks when the access selection unit 7202 transmits the bank data to the DRAM 30 will be described. FIG. 11 is a flow chart showing processing procedures of the memory access device 700 according to the fifth embodiment of the present invention to change the banks to access; that is, the processing procedures to determine the designation sequence of the banks according to the bank-busy-state signal and the bank-busy count. In the description below, it is described that the bank-busy-state signal and the bank-busy count corresponding to each bank of the DRAM 30 is sequentially output from the memory controller 760.

When the input image data output from the image sensor 10 to the imaging input unit 720 is buffered in the buffer 2201, the buffer 2201 is configured to parallelly output the bank addresses and the bank access request signals for requesting the transmission of the buffered input image data to each bank of the DRAM 30 to the access selection unit 7202. Accordingly, the access selection unit 7202 is configured to determine whether there is any bank in the bank-busy state according to the bank-busy-state signal output from the memory controller 760 (Step S410).

In Step S410, if it is determined that there is no bank in the bank-busy state, that is, all of the banks configured in the DRAM 30 are not in the bank-busy state (“NO” in Step S410), the access selection unit 7202 proceeds to Step S450.

On the other hand, in Step S410, if it is determined that the bank in the bank-busy state exists (“YES” in Step S410), the access selection unit 7202 confirms the bank in the bank-busy state according to the bank-busy-state signal output from the memory controller 760 (Step S420).

Subsequently, the access selection unit 7202 determines whether the bank-busy count among the bank-busy counts output from the memory controller 760 and corresponding to the bank in the bank-busy state confirmed in Step S420 is equal to or larger than the predetermined threshold (Step S430). That is, in Step S430, the access selection unit 7202 determines whether the time required for canceling the bank-busy state of the bank in the bank-busy state is longer than the predetermined threshold.

In Step S420, if it is determined that there is no bank whose bank-busy count is equal to or larger than the predetermined threshold (“NO” in Step S430), the access selection unit 7202 proceeds to Step S450. That is, in Step S430, in the case in which the access selection unit 7202 determines that there is no bank in which the time required for canceling the bank-busy state is longer than the predetermined threshold among the banks in the bank-busy state, the access selection unit 7202 determines to not to avoid the access to the banks of the DRAM 30 in the bank-busy state to continue the access processing, and proceeds to Step S450.

On the other hand, in Step S420, if it is determined that there is a bank whose bank-busy count is equal to or larger than the predetermined threshold (“YES” in Step S430), the access selection unit 7202 is configured to change the designation sequence of the banks (Step S440). More specifically, the access selection unit 7202 is configured to change the designation sequence of the banks among the banks to be designated in the predetermined sequence so as to postpone the designation sequence of the banks whose bank-busy state is canceled in the time longer than the predetermined threshold and firstly designate the banks not in the bank-busy state and the banks whose bank-busy state will be canceled in the time shorter than the predetermined threshold.

Subsequently, the access selection unit 7202 outputs the access requests to the memory controller 760 in the designation sequence of the banks in the DRAM 30, and the access selection unit 7202 sequentially transmits the input image data buffered in the buffer 2201 to the DRAM 30 (Step S450). More specifically, when it is determined that there is no bank in the bank-busy state in Step S410, or there are only the banks whose bank-busy state is canceled in the time shorter than the predetermined threshold, the access selection unit 7202 outputs the access requests to the memory controller 760 in the predetermined designation sequence of the banks in the DRAM 30, and sequentially transmits the bank data (input image data) corresponding to each bank to the DRAM 30. On the other hand, when it is determined that the bank in the bank-busy state exists in Step S310, and there are the banks whose bank-busy state is canceled in the time longer than the predetermined threshold in Step S430, the access selection unit 7202 outputs the access requests to the memory controller 760 in the changed sequence changed in Step S440, and sequentially transmits the bank data (input image data) corresponding to each bank to the DRAM 30.

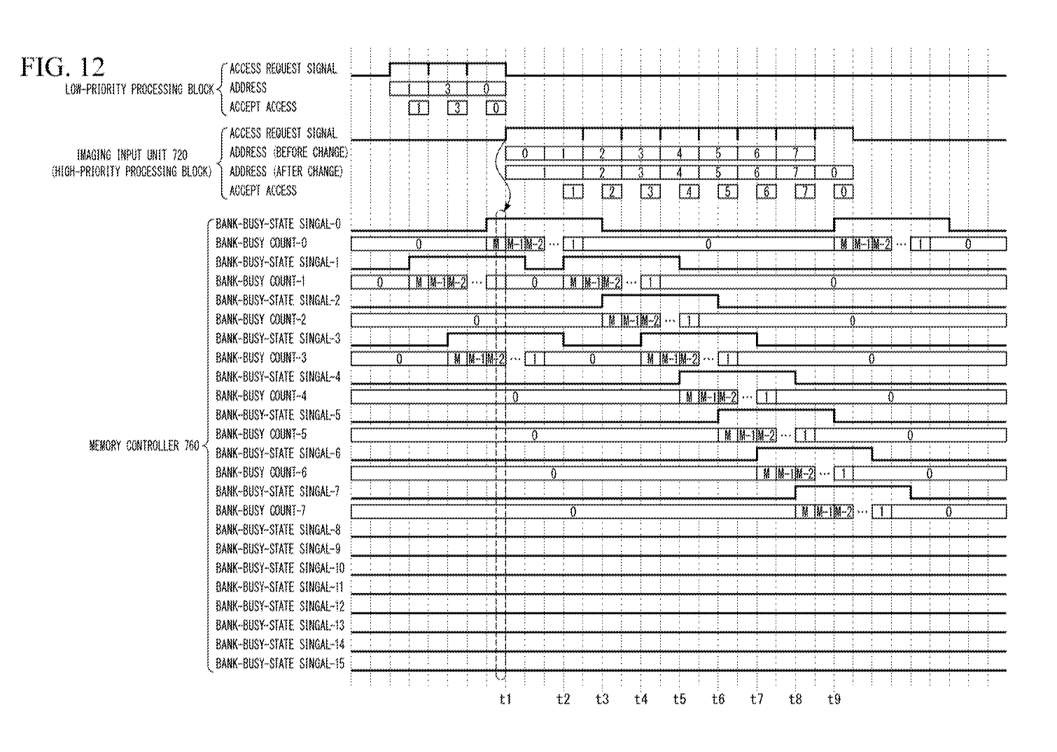

Next, an example of the operation for transmitting the data to the DRAM 30 in the image-processing device 70 will be described. FIG. 12 is a timing chart showing the example of accessing the DRAM 30, that is, the example of designating the banks by the memory access device 700 according to the fifth embodiment of the present invention. Similar to the example of the timing chart in the memory access device 200 according to the first embodiment shown in FIG. 4, FIG. 12 shows the example of the timing when each of the imaging input unit 720 as the high-priority processing block and the low-priority processing block (for example, the image-processing unit 230 and the JPEG-processing unit 240) outputs the access requests to the DRAM 30 by the DMA transmission. More specifically, in FIG. 12, the example of the timing when each of the imaging input unit 720 and the low-priority processing blocks outputs the “access request signals” for requesting the access to the DRAM 30 and the “bank addresses” for designating the banks is shown. Similar to the example of the timing chart in the memory access device 200 according to the first embodiment shown in FIG. 4, the access request signals at a “High” level indicate the request for accessing the DRAM 30, and the access request signals at a “Low” level indicate that there is no request for accessing the DRAM 30. In FIG. 12, the banks to which the access request output from each of the imaging input unit 720 and the low-priority processing blocks are accepted are shown as “ACCEPT ACCESS”. As described above, in the imaging input unit 720, the access selection unit 7202 equipped in the imaging input unit 720 is configured to change the designation sequence of the banks according to the bank-busy-state signal and the bank-busy count output from the memory controller 760. Thus, in FIG. 12, similar to the example of the timing chart in the memory access device 200 according to the first embodiment shown in FIG. 4, as the addresses output by the imaging input unit 720, the addresses before the access selection unit 7202 changes the sequence are shown as the “ADDRESSES (BEFORE CHANGE)”, and the addresses after the access selection unit 7202 changes the sequence are shown as the “ADDRESSES (AFTER CHANGE)”. In FIG. 12, both of the “BANK-BUSY-STATE SIGNALS” and the “BANK-BUSY COUNT” corresponding to each bank of the DRAM 30 and output by the memory controller 760 are shown. Similar to the example of the timing chart in the memory access device 200 according to the first embodiment shown in FIG. 4, the “bank-busy-state signals” at a “High” level indicate the bank-busy state, and the “bank-busy-state signals” at a “Low” level indicate a state rather than the bank-busy state. The “bank-busy count” is a count value indicating the time required until the bank-busy state is canceled which is represented by the number of the clocks, and the “bank-busy count” is used to represent the time required for accessing the given bank in the form of “M clock (s)” (M is a natural number, a positive integer), and the count value of the bank-busy count is subtracted with the progress of the time.

Similar to the timing chart in the memory access device 200 according to the first embodiment shown in FIG. 4, the timing chart shown in FIG. 12 is also the example of the timing in the case in which the imaging input unit 720 makes the access requests for consecutively designating the eight banks configured in the DRAM 30 having 16 banks configured therein. In the description below, it is described that the sequence for the access selection unit 7202 to designate the banks of the DRAM 30 is predetermined to be the sequence from the bank-0 to the bank-1, subsequently to the bank-2, . . . , and to the bank-7 as shown as “ADDRESS (BEFORE CHANGE)”. In the description below, it is described that the threshold for the access selection unit 7202 to determine whether to change the predetermined designation sequence of the banks of the DRAM 30 is equal to 2. In the description below, it is described that the memory controller 760 is configured to consecutively output the bank-busy-state signal corresponding to each bank. In the timing chart shown in FIG. 12, in order to identify the corresponding bank (the bank-0 to the bank-15) of the DRAM 30, a “number” showing the corresponding bank is affixed to the hyphen “-” after the name of each bank-busy-state signals and the bank-busy counts. In the timing chart shown in FIG. 12, the bank-busy counts according to the bank-8 to the bank-15 are omitted.

Similar to the timing chart in the memory access device 200 according to the first embodiment shown in FIG. 4, in the example of the timing chart shown in FIG. 12, the memory controller 760 is configured to accept the access requests to the banks designated by the low-priority processing block in response to the access request signal output from the low-priority processing block and control the data delivery (DMA transmission) to the DRAM 30. In the example of the timing chart shown in FIG. 12, the bank-busy-state signal-1, the bank-busy-state signal-3, and the bank-busy-state signal-0 corresponding to the bank-1, the bank-3, and the bank-0 respectively which are designated by the low-priority processing block are set to the “High” level consecutively. Then, the memory controller 760 is configured to set each bank-busy-state signal to the “Low” level after the certain period when the bank-busy-state in each bank is canceled. The memory controller 760 sets the count value to be equal to M at the timing when the bank-busy-state signals are set to the “High” level, and the memory controller 760 outputs the bank-busy count by subtracting the count value until the bank-busy-state signals are set to the “Low” level.

Subsequently, in the example of the timing chart shown in FIG. 12, similar to the example of the timing chart in the memory access device 200 according to the first embodiment shown in FIG. 4, the imaging input unit 720 makes the access requests to consecutively designate 8 banks from the timing t1. At this time, in the imaging input unit 720, before the initial access request to the DRAM 30 is output at the timing t1, the access selection unit 7202 determines the sequence for designating the banks according to the bank-busy-state signals and the bank-busy counts corresponding to each bank and output from the memory controller 760. In the example of the timing chart shown in FIG. 12, the bank-busy-state signals output from the memory controller 760 immediately before the timing t1 indicate that the bank-0, the bank-1, and the bank-3 are in the bank-busy state. Accordingly, the access selection unit 7202 is configured to determine whether the bank-busy counts with respect to the banks in the bank-busy-state are equal to or larger than the predetermined threshold. In the example of the timing chart shown in FIG. 12, the bank-busy count corresponding to the bank-0, the bank-busy count corresponding to the bank-1, and the bank-busy count corresponding to the bank-3 which are output from the memory controller 760 immediately before the timing t1 have the count values of M, 1, and M−2, respectively. Accordingly, the access selection unit 7202 is configured to determine the designation sequence of the banks so as to postpone the access to the bank-0 having the count value larger than the predetermined threshold (M=2), and firstly designate the bank not in the bank-busy state and the bank having the count value smaller than the predetermined threshold (M=2). In the example of the timing chart shown in FIG. 12, the access selection unit 7202 is configured to determine to designate the banks in the sequence from bank-1 to bank-2, bank-3, bank-4, bank-5, bank-6, bank-7, and bank-0 at last.

In the example of the timing chart shown in FIG. 12, the bank-busy count-3 corresponding to the bank-3 and output from the memory controller 760 immediately before the timing t1 has the count value of M−2, such that the bank-3 is considered to be the bank to which the access is postponed. However, as described above, the access selection unit 7202 does not postpone the access to the bank-3. The reason is that in the case in which the memory controller 760 accesses each bank in the determined sequence, even if the count value indicating the bank-busy count corresponding to the bank-3 has the value M−2, the memory controller 760 determines that the bank-busy-state thereof is canceled until the timing when the memory controller 760 actually accesses the bank-3. The memory controller 760 determines the designation sequence for accessing each bank by determining according to not only the predetermined threshold, but also whether the bank-busy state is canceled at the timing when the bank is actually accessed.

The imaging input unit 720 (the access selection unit 7202) is configured to sequentially output the access request signals for consecutively designating the 8 banks in the determined sequence to the memory controller 760. Accordingly, the memory controller 760 is configured to accept the access requests to the banks designated by the imaging input unit 720 in response to each access request signal output from the imaging input unit 720, and to control the data delivery (DMA transmission) to the DRAM 30. In the example of the timing chart shown in FIG. 12, it is shown the timing when the memory controller 760 accepts the access requests to each bank designated by the imaging input unit 720 and performs the DMA transmission at each of the timing t2 to the timing t9. At the timing t2, the memory controller 760 accepts the access request to the bank-1 which is output by the imaging input unit 720 at the timing t1 after the bank-busy state of the bank-1 is canceled. At this time, when the memory controller 760 accepts the access requests to each bank designated by the imaging input unit 720, the memory controller 760 sets the bank-busy-state signals corresponding to each bank entering the bank-busy state due to accept the access request to the “High” level. Since the bank-busy state of each bank is canceled after the certain period, the memory controller 760 is configured to set the bank-busy-state signals corresponding to each bank to the “Low” level when the bank-busy state is canceled.

The sequence for designating each bank by the access selection unit 7202 is not limited to the sequence shown in the example of the timing chart in FIG. 12. That is, in the memory access device 700, the sequence of designating each bank by the access selection unit 7202 is not particularly limited. In the memory access device 700, the sequence of designating each bank may be suitably determined to allow the access to the DRAM 30 to be waited for the period of the predetermined threshold, and to avoid the access to the banks in the bank-busy state while including all of the bank-0 to the bank-7.

According to such configuration and operation, the memory access device 700 according to the fifth embodiment of the present invention is configured to perform the data delivery (DMA transmission) by avoiding the access to the banks whose bank-busy state is not canceled after determining the banks in which a long period is required for the bank-busy state to be canceled and then allowing the access request with respect to the banks in the bank-busy state to be waited for the period of the predetermined threshold. Accordingly, similar to the memory access device 200 according to the first embodiment, according to the memory access device 700 according to the fifth embodiment of the present invention, the access efficiency to the DRAM 30 by the imaging input unit 720 can be improved, and the bus band width for the imaging input unit 720 to store (write) the input image data into the DRAM 30 can be secured. Similar to the memory access device 200 according to the first embodiment, the memory access device 700 according to the fifth embodiment of the present invention can shorten the period until the data transmission due to the consecutive access requests (the DMA transmission of consecutively designating the 8 banks configured in the DRAM 30) is finished.

In the description above, it is described to apply the scope of the memory access device 700 according to the fifth embodiment of the present invention to the configuration of the memory access device 200 according to the first embodiment. That is, the memory access device 700 according to the fifth embodiment of the present invention is configured to determine the designation sequence of each bank according to the bank-busy-state signal and the bank-busy count immediately before the output of the initial access request so as to not to designate the banks (avoid the access thereto) in which a long period is required for the bank-busy state to be canceled while allowing each access request to be waited for the period of the predetermined threshold. However, as described above, the scope of the memory access device 700 according to the fifth embodiment of the present invention can be applied to the memory access device according to either of the first embodiment to the fourth embodiment. For example, in the case of applying the scope of the memory access device 700 according to the fifth embodiment of the present invention to the memory access device 201 according to the second embodiment, it is possible to determine the banks in which a period required for the bank-busy state to be canceled is longer than the predetermined threshold by each access request, and perform the data delivery (DMA transmission) by avoiding the access to the banks in which the period required for the bank-busy state to be canceled is longer than the predetermined threshold. For example, in the case of applying the scope of the memory access device 700 according to the fifth embodiment of the present invention to the memory access device 500 according to the third embodiment, in the memory access device including the data transmission block, it is possible to perform the data delivery (DMA transmission) by avoiding the access to the banks in which the period required for the bank-busy state to be canceled is longer than the predetermined threshold.

According to the fifth embodiment, in the memory access device (memory access device 700), the memory controller (memory controller 760) is configured to output multiple operation information (for example, the bank-busy-state signal and the bank-busy count) indicating the operation state of the memory (DRAM 30), and the access selection unit (access selection unit 7202) is configured to change the designation sequence of the banks according to the multiple operation information.

As described above, in the memory access device 700 according to the fifth embodiment of the present invention, the memory controller 760 is configured to output both of the bank-busy-state signal indicating whether each bank of the connected DRAM 30 is in the bank-busy state and the bank-busy count indicating the time until the bank-busy state is canceled as the operation information of the DRAM 30. In the memory access device 700 according to the fifth embodiment of the present invention, the imaging input unit 720 (high-priority processing block) is configured to determine the banks in which the period required for the bank-busy state to be canceled is longer than the predetermined threshold according to the bank-busy-state signal and the bank-busy count. In the memory access device 700 according to the fifth embodiment of the present invention, the imaging input unit 720 (high-priority processing block) is configured to allow the access request to be waited for the period of the predetermined threshold and determine the designation sequence of the banks so as to not to designate (avoid the access thereto) the banks in which the period required for the bank-busy state to be canceled is longer than the predetermined threshold. Accordingly, in the memory access device 700 according to the fifth embodiment of the present invention, similar to the memory access device according to the first embodiment to the fourth embodiment, the access efficiency to the DRAM 30 by the imaging input unit 720 (high-priority processing block) can be improved, and the bus bandwidth for the imaging input unit 720 (high-priority processing block) to access the DRAM 30 (to store (write) the input image data into the DRAM 30) can be secured.

In the description above, similar to the memory access device according to the first embodiment to the fourth embodiment, the memory access device 700 according to the fifth embodiment of the present invention is described by the example of the combination of the imaging input unit 720 (high-priority processing block) and the memory controller 760. However, in the memory access device 700 according to the fifth embodiment of the present invention, similar to the memory access device according to the first embodiment to the fourth embodiment, the high-processing block varies due to the operation mode of the imaging device 4. Accordingly, in the memory access device according to the fifth embodiment of the present invention, similar to the memory access device according to the first embodiment to the fourth embodiment, the combination of the high-priority processing block and the memory controller 760 configuring the memory access device is not limited to the combination of the imaging input unit 720 and the memory controller 760. Even if the memory access device according to the fifth embodiment of the present invention is configured by the combination of the high-priority processing block different from the imaging input unit 720 and the memory controller 760, the operation thereof can be easily considered to be same as the operation of the memory access device 700 according to the fifth embodiment described above.

According to the first embodiment to the fifth embodiment of the present invention, the configuration having a single processing block (imaging input unit) as the high-priority processing block is described. However, the processing block as the high-priority processing block is not limited to the single processing block, for example, a plurality of processing blocks may be configured as the high-priority processing blocks due to the operation mode of the imaging device. However, in this case, it is possible that the plurality of high-priority processing blocks make the access requests to the given bank simultaneously, that is, the plurality of high-priority processing blocks may designate the given bank. Accordingly, the memory access device may be configured to further change the designation sequence of the banks when it is impossible to accept the access requests to the given bank.

### Sixth Embodiment

Next, a memory access device according to a sixth embodiment of the present invention will be described. The memory access device according to the sixth embodiment of the present invention is configured to have two processing blocks as the high-priority processing blocks. In the description below, the memory access device according to the sixth embodiment of the present invention will be described by referring to the case in which the memory access device is equipped in the image-processing device of the imaging device such as a camera for capturing still images, a camera for capturing videos and the like.

The configuration of the imaging device having the image-processing device with the memory access device according to the sixth embodiment of the present invention is same as the schematic configuration of the imaging device 1 having the image-processing device 20 with the memory access device 200 according to the first embodiment shown in FIG. 1. Accordingly, a detailed description regarding the configuration of the imaging device having the image-processing device with the memory access device according to the sixth embodiment will be omitted, and configuration elements which are same as the configuration elements of the imaging device 1 having the image-processing device 20 with the memory access device 200 according to the first embodiment shown in FIG. 1 will be designated with the same reference signs. The configuration of the memory access device according to the sixth embodiment of the present invention is same as the schematic configuration of the memory access device 200 according to the first embodiment shown in FIG. 2.

Accordingly, a detailed description regarding the configuration of the memory access device according to the sixth embodiment will be omitted, and configuration elements of the memory access device which are same as the configuration elements of the memory access device 200 according to the first embodiment shown in FIG. 2 will be designated with the same reference signs.

However, in the memory access device according to the sixth embodiment of the present invention, two processing blocks are configured as the high-priority processing blocks. Accordingly, in the imaging device 1 having the image-processing device 20 with the memory access device 200 according to the first embodiment shown in FIG. 1, in the image-processing device 20, a memory access device according to the sixth embodiment of the present invention which is configured by a combination of a first high-priority processing block and the memory controller 260, and a memory access device according to the sixth embodiment of the present invention which is configured by a combination of a second high-priority processing block and the memory controller 260 are configured therein. Each of the memory access devices according to the sixth embodiment of the present invention has the same configuration in each high-processing block as shown in FIG. 2. That is, the high-processing block of each memory access devices according to the sixth embodiment of the present invention has the buffer and the access selection unit.

In the description below, the case in which the imaging input unit is configured as the first high-priority processing block and the display-processing block is configured as the second high-processing block will be described. In the description below, the memory access device according to the sixth embodiment of the present invention configured by the combination of the imaging input unit and the memory controller 260 will be described as “memory access device 202”, and the memory access device according to the sixth embodiment of the present invention configured by the combination of the display-processing unit and the memory controller 260 will be described as “memory access device 205”. The memory access device 202 and the memory access device 205 are configured to change the designation sequence of the banks of the DRAM 30 in the same manner.

Next, the operation of the memory access device according to the sixth embodiment of the present invention, that is, the processing of changing the designation sequence of the banks when the access selection unit equipped in the memory access device 202 and the memory access device 205 transmits the bank data to the DRAM 30 will be described. In the description below, operation of the buffer included in each of the memory access device 202 and the memory access device 205 is same as the operation of the buffer 2201 included in the memory access device 200 according to the first embodiment; however, the operation of the access selection unit is different from the operation of the access selection unit 2202 included in the memory access device 200 according to the first embodiment. In the description below, the buffer 2201 included in the memory access device 202 is described as “buffer 2221” and the access selection unit is described as “access selection unit 2222” so as to distinguish from the buffer 2201 and the access selection unit 2202 included in the memory access device 200 according to the first embodiment. In the description below, the imaging input unit configuring the memory access device 202 having the buffer 2221 and the access selection unit 2222 is described as “imaging input unit 222” so as to distinguish from the imaging input unit 220 configuring the memory access device 202 having the buffer 2201 and the access selection unit 2202 according to the first embodiment. In the description below, the buffer 2201 included in the memory access device 205 is described as “buffer 2251” and the access selection unit is described as “access selection unit 2252” so as to distinguish from the buffer 2201 and the access selection unit 2202 included in the memory access device 200 according to the first embodiment. In the description below, the imaging input unit configuring the memory access device 205 having the buffer 2251 and the access selection unit 2252 is described as “imaging input unit 252” so as to distinguish from the imaging input unit 220 configuring the memory access device 202 having the buffer 2201 and the access selection unit 2202 according to the first embodiment. In the description below, the image-processing device having the memory access device 202 and the memory access device 205 is described as “image-processing device 22” so as to distinguish from the image-processing device having the memory access device 200 according to the first embodiment.

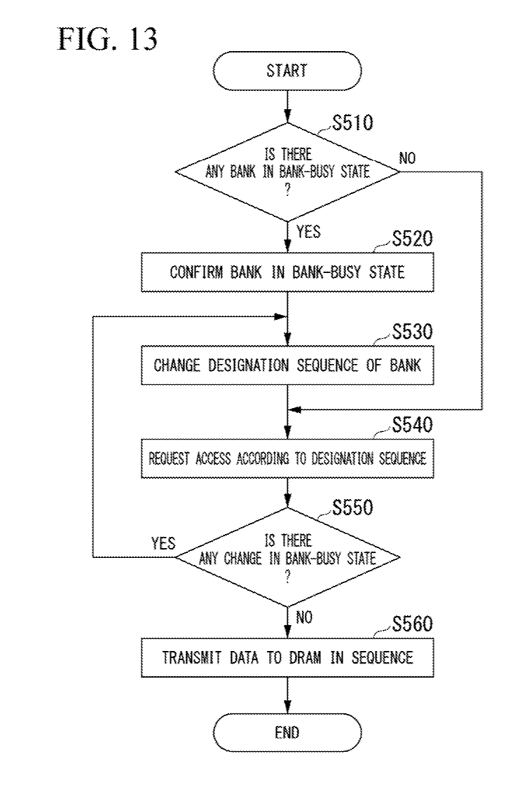

FIG. 13 is a flow chart showing processing procedures for changing the banks to be accessed by the memory access device (memory access device 202 and the memory access device 205) according to the sixth embodiment of the present invention, that is, the processing procedures of changing the designation sequence of the banks. In the description below, the processing procedures of the memory access device 202 will be described as a representation of the memory access device according to the sixth embodiment of the present invention. The memory access device 205 as the memory access device according to the sixth embodiment of the present invention is different only in the configuration of replacing the access selection unit 222 with the access selection unit 2252, and the processing procedure thereof are the same. In the description below, it is described that the bank-busy-state signals corresponding to each bank of the DRAM 30 is sequentially output from the memory controller 260.

When the input image data output to the imaging input unit 222 from the image sensor 10 is buffered in the buffer 2221, similar to the buffer 2201 included in the memory access device 200 according to the first embodiment, the buffer 2221 is configured to parallelly output the bank access signals for requesting the transmission of the buffered input image data to each bank configured in the DRAM 30 together with the bank address to the access selection unit 2222. Accordingly, similar to the access selection unit 2202 included in the memory access device 200 according to the first embodiment, the access selection unit 2222 determines whether there is any bank in the bank-busy state according to the bank-busy-state signal output from the memory controller 260 (Step S510).

In the Step S510, if it is determined that there is no bank in the bank-busy state, that is, all of the banks configured in the DRAM 30 are not in the bank-busy state (“NO” in Step S510), the access selection unit 2222 proceeds to Step S540.

On the other hand, if it is determined that the bank in the bank-busy state exists (“YES” in Step S510), similar to the access selection unit 2202 included in the memory access device 200 according to the first embodiment, the access selection unit 2222 confirms the bank in the bank-busy state (Step S520).

Subsequently, the access selection unit 2222 changes the designation sequence of the banks according to the confirmation results in Step S120 according to the determination result in Step S520, similar to the access selection unit 2202 included in the memory access device 200 according to the first embodiment (Step S530).

Subsequently, similar to the access selection unit 2202 included in the memory access device 200 according to the first embodiment, the access selection unit 2222 outputs the access requests to the memory controller 260 in the designation sequence of the banks in the DRAM 30 (Step S540). The processing of the buffer 2221 and the access selection unit 2222 so far is the same as that of the buffer 2201 and the access selection unit 2202 included in the memory access device 200 according to the first embodiment.

Subsequently, the access selection unit 2222 output the access requests to the memory controller 260, and the access selection unit 2222 monitors the change of the bank-busy state and determines whether there is any change in the bank-busy state according to the bank-busy-state signal output from the memory controller 260 during the period when the access requests are not accepted by the memory controller 260 (Step S550). The monitoring of the bank-busy state by the access selection unit 2222 during the period when the access requests are not accepted by the memory controller 260 may be successively performed, or be periodically performed at a predetermined timing. The monitoring of the bank-busy state by the access selection unit 2222 may be performed with respect to all of the designation banks according to the output access requests, and may be performed with respect to the initial designation bank.

In Step S550, when it is determined that there is change in the bank-busy state (“YES” in Step S550), the access selection unit 2222 returns to Step S530 to further change the designation sequence of the banks. Then, in Step S540, the access selection unit 222 further outputs the changed access request for designating the banks of the DRAM 30 to the memory controller 260. That is, the access selection unit 2222 exchanges the designation banks. The access selection unit 2222 repeatedly performs the processing from Step S530 to Step S550 until the output access requests are accepted by the memory controller 260.

On the other hand, in Step S550, when it is determined that there is no change in the bank-busy state (“NO” in Step S550), the access selection unit 2222 proceeds to Step S560. That is, in the state in which there is no change in the bank-busy state of all of the banks configured in the DRAM 30, when the output access requests are accepted by the memory controller 260, the access selection unit 2222 finishes the monitoring of the change of the bank-busy state.

Subsequently, the access selection unit 2222 sequentially transmits the input image data buffered in the buffer 2221 and corresponding to the access requests accepted by the memory controller 260 to the DRAM 30 (Step S560). The method of transmitting the input image data to the DRAM 30 in Step S560 is same as that of the access selection unit 2202 equipped in the memory access device 200 according to the first embodiment.

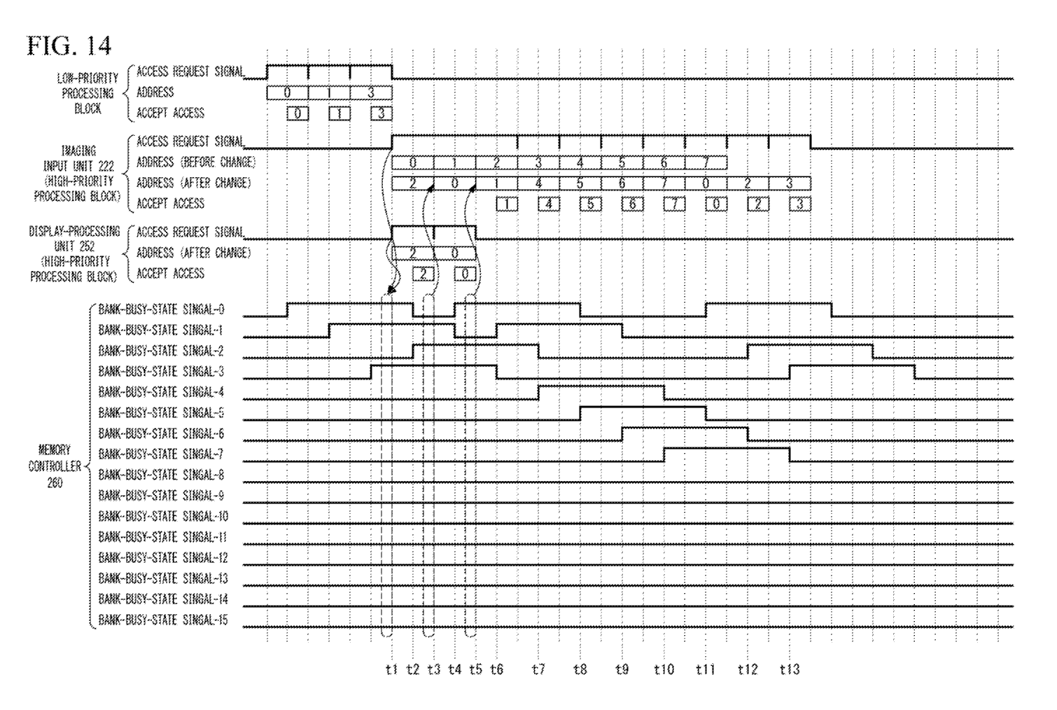

Next, an example of the operation for transmitting the data to the DRAM 30 in the image-processing device 22 will be described. FIG. 14 is a timing chart showing the example of the timing for accessing the DRAM 30 according to the sixth embodiment of the present invention, that is, the timing for further changing the designation sequence of the banks during the period when the output access requests are not accepted by the memory controller 260. In FIG. 14, the example of the timing when each of the high-priority processing block such as the imaging input unit 222 and the display-processing unit 252 and the low-priority processing block (for example, the image-processing unit 230 and the JPEG-processing unit 240) outputs the access requests to the DRAM 30 by the DMA transmission. More specifically, in FIG. 14, the example of the timing when each of the imaging input unit 222, the display-processing unit 252, and the low-priority processing blocks outputs the “access request signals” for requesting the access to the DRAM 30 and the “bank addresses” for designating the banks is shown. Similar to the example of the timing chart in the memory access device 200 according to the first embodiment shown in FIG. 4, the access request signals at a “High” level indicate the request for accessing the DRAM 30, and the access request signals at a “Low” level indicate that there is no request for accessing the DRAM 30. In FIG. 14, the banks to which the access requests output from each of the imaging input unit 222, the display-processing unit 252, and the low-priority processing blocks are accepted are shown as “ACCEPT ACCESS”. As described above, in the imaging input unit 222 and the display-processing unit 252, the access selection unit 2222 equipped in the imaging input unit 222 and the access selection unit 2252 equipped in the display-processing unit 252 are configured to change the designation sequence of the banks according to the bank-busy-state signal output from the memory controller 260. However, in the example of the timing shown in FIG. 14, in order to make the description easy to understand, it is described that in the case in which each of the imaging input unit 222 and the display-processing unit 252 outputs the access requests during the same period, the access requests output by the display-processing unit 252 with respect to the banks in a changed sequence are accepted by the memory controller 260 earlier than the access requests output by the imaging input unit 222 such that the imaging input unit 222 further changes the designation sequence of the banks. Accordingly, in FIG. 14, similar to the example of the timing chart in the memory access device 200 according to the first embodiment shown in FIG. 4, as the addresses output by the imaging input unit 222, the addresses before the access selection unit 2222 changes the sequence are shown as the “ADDRESSES (BEFORE CHANGE)”, and the addresses after the access selection unit 2222 changes the sequence are shown as the “ADDRESSES (AFTER CHANGE)”. In FIG. 14, the “BANK-BUSY-STATE SIGNALS” corresponding to each bank of the DRAM 30 and output by the memory controller 260 are shown. Similar to the example of the timing chart in the memory access device 200 according to the first embodiment shown in FIG. 4, the bank-busy-state signals at a “High” level indicate the bank-busy state, and the “bank-busy-state signals” at a “Low” level indicate a state other than the bank-busy state.

Similar to the example of the timing chart in the memory access device 200 according to the first embodiment shown in FIG. 4, the timing chart shown in FIG. 14 is the example of the timing in the case in which 16 banks are configured in the DRAM 30. In the timing chart shown in FIG. 14, the case in which the imaging input unit 222 makes the access requests to consecutively designate 8 banks configured in the DRAM 30 and the display-processing unit 252 makes the access requests to consecutively designate 2 banks configured in the DRAM 30. In the description below, similar to the example of the timing chart in the memory access device 200 according to the first embodiment shown in FIG. 4, the designation sequence of the banks of the DRAM 30 which is predetermined by the access selection unit 2222 is from the bank-0 to the bank-1, the bank-2, . . . , the bank-6, and the bank-7 at last, shown as “ADDRESS (BEFORE CHANGE)”. In the description below, similar to the example of the timing chart in the memory access device 200 according to the first embodiment shown in FIG. 4, it is described that the memory controller 260 sequentially outputs the bank-busy-state signals corresponding to each bank.

Similar to the example of the timing chart in the memory access device 200 according to the first embodiment shown in FIG. 4, in the example of the timing chart shown in FIG. 14, the memory controller 260 is configured to accept the access requests to the banks designated by the low-priority processing block in response to the access request signal output from the low-priority processing block and control the data delivery (DMA transmission) to the DRAM 30. In the example of the timing chart shown in FIG. 14, the bank-busy-state signal-0, the bank-busy-state signal-1, and the bank-busy-state signal-3 corresponding to the bank-0, the bank-1, and the bank-3 respectively which are designated by the low-priority processing block are set to the “High” level consecutively. The memory controller 260 is configured to set each bank-busy-state signal to the “Low” level after the certain period when the bank-busy-state in each bank is canceled.

Subsequently, in the example of the timing chart shown in FIG. 14, the imaging input unit 220 makes the access requests to consecutively designate 8 banks and the display-processing unit 252 makes the access requests to consecutively designate 2 banks from the timing t1. At this time, in the imaging input unit 220, before the initial access request to the DRAM 30 is output at the timing t1, the access selection unit 2222 determines the designation banks according to the bank-busy-state signals corresponding to each bank and output from the memory controller 260. Also, before the initial access request to the DRAM 30 is output at the timing t1, the access selection unit 2252 determines the designation banks according to the bank-busy-state signals corresponding to each bank and output from the memory controller 260. In the example of the timing chart shown in FIG. 4, the bank-busy-state signals output from the memory controller 260 immediately before the timing t1 indicate that the bank-0, the bank-1, and the bank-3 are in the bank-busy state. Accordingly, the access selection unit 2222 and the display-processing unit 2252 are configured to determine the sequence for designating the banks so as to postpone the access to the banks in the bank-busy-state and firstly accesses the banks which are not in the bank-busy-state. The determination of the designation sequence of the banks by the access selection unit 2222 and the access selection unit 2252 are performed simultaneously. Accordingly, it is possible that both of the access selection unit 2222 and the access selection unit 2252 determines the given bank-2 as the initial bank for making the access request at the timing t1.

In this case, the imaging input unit 222 (access selection unit 2222) and the display-processing unit 252 (access selection unit 2252) output the determined access request signals for designating the given bank-2 to the memory controller 260 at the timing t1. Here, in the example of the timing chart shown in FIG. 14, the access requests output by the display-processing unit 252 are accepted by the memory controller 260 earlier than the access requests output by the imaging input unit 222. Accordingly, the memory controller 260 accepts the access request to the bank-2 which is not in the bank-busy state in response to the access request signal output by the display-processing unit 252 with respect to the bank-2 to control the data delivery to the DRAM 30 (DMA transmission). That is, the access request output by the imaging input unit 222 with respect to the bank-2 is kept waiting. When the memory controller 260 accepts the access request output by the display-processing unit 252 with respect to the bank-2, at the timing t2, the memory controller 260 sets the bank-busy-state signal-2 corresponding to the bank-2 entering the bank-busy state, to the “High” level due to accept the access request. In the bank-2, since the bank-busy state is canceled after the certain period is elapsed, the memory controller 260 sets the bank-busy-state signal-2 corresponding to the bank-2 to the “Low” level when the bank-busy state is canceled.

The access selection unit 2222 monitors the change of the bank-busy state and determines whether there is any change in the bank-busy state according to the bank-busy-state signal output from the memory controller 260 during the period when the access requests are not accepted by the memory controller 260. In the example of the timing chart shown in FIG. 14, for example, at the timing t3, the access selection unit 2222 confirms that the bank-busy-state signal-2 corresponding to the bank-2 is changed to the “High” level, that is, the access selection unit 222 confirms that the bank-2 is changed into the bank-busy state.

The access selection unit 2222 further changes the designation sequence of the banks according to the bank-busy-state signals corresponding to each bank which are output from the memory controller 260. In the example of the timing chart shown in FIG. 14, the bank-busy-state signals output from the memory controller 260 confirmed at the timing t3 indicate that the bank-1, the bank-2, and the bank-3 are in the bank-busy state. Accordingly, the access selection unit 2222 changes the initial bank to access from the bank-2 to the bank-0 at the timing t3.

However, in the access request of the display-processing unit 252 which is accepted by the memory controller 260 earlier, the bank-0 is the second bank to be designated. In this case, the memory controller 260 accepts the access request with respect to the bank-0 which is not in the bank-busy state in response to the access request signal consecutively output from the display-processing unit 252 with respect to the bank-0 to control the data delivery (DMA transmission) to the DRAM 30. When the memory controller 260 accepts the access request output from the display-processing unit 252 with respect to the bank-0, the memory controller 260 sets the bank-busy-state signal-0 corresponding to the bank-0 entering the bank-busy state due to accept the access request at the timing t4 to the “High” level. In the bank-0, since the bank-busy state is canceled after the certain period is elapsed, the memory controller 260 sets the bank-busy-state signal-0 corresponding to the bank-0 to the “Low” level when the bank-busy state is canceled.

In this case, the access request output by the imaging input unit 222 with respect to the bank-0 is kept waiting. The access selection unit 2222, as the example of the timing chart shown in FIG. 14, for example, confirms that the bank-0 is also in the bank-busy state by confirming that the bank-busy-state signal-0 corresponding to the bank-0 is changed to the “High” level at the timing t5.

Accordingly, the access selection unit 2222 further changes the designation sequence of the banks according to the bank-busy-state signals corresponding to each bank and output from the memory controller 260. In the example of the timing chart shown in FIG. 14, the bank-busy-state signals output from the memory controller 260 confirmed at the timing t5 indicate that the bank-0, the bank-2, and the bank-3 are in the bank-busy state. Accordingly, the access selection unit 2222 further changes the initial bank to access from the bank-0 to the bank-1 at the timing t5. The access selection unit 2222 reviews and changes the sequence of the consecutive eight banks according to the change of the initial bank requested to access. In the timing chart shown in FIG. 14, the example of changing the designation sequence of the banks into the sequence from the bank-1 to the bank-4, the bank-5, the bank-6, the bank-7, the bank-0, the bank-2, and the bank-3 lastly by the access selection unit 2222 is shown.

The sequence for the access selection unit 2222 to designate each bank is not limited to the sequence shown in the example of the timing chart shown in FIG. 14. That is, in the memory access device according to the sixth embodiment of the present invention, similar to the memory access device 200 according to the first embodiment, the sequence for the access selection unit 2222 to designate each bank only has to include the consecutive banks (the bank-0 to the bank-7 shown in FIG. 14) while avoiding the access to the banks in the bank-busy state.

Subsequently, in the example of the timing chart shown in FIG. 14, the access request signals output by the imaging input unit 222 (access selection unit 2222) are accepted by the memory controller 260 from the timing t6. Accordingly, the access selection unit 2222 makes the access requests to consecutively designate the eight banks and the memory controller 260 controls the data delivery (DMA transmission) to the DRAM 30 in the sequence of the banks designated by the imaging input unit 222 in response to each access request signal output from the imaging input unit 222. In the example of the timing chart shown in FIG. 14, it is shown the timing when the memory controller 260 accepts the access requests with respect to each bank designated by the imaging input unit 222 at each timing of the timing t6 to the timing t13 and performs the DMA transmission. At this time, the memory controller 260 sets the bank-busy-state signals corresponding to the banks to which the access requests are accepted to the “High” level, and when the bank-busy state is canceled after the certain period is elapsed, the memory controller 260 sets each bank-busy-state signal to the “Low” level.

According to such configuration and operation, the memory access device according to the sixth embodiment of the present invention is configured to have both of the imaging input unit 222 and the display-processing unit 252 as the high-priority processing blocks, and in the case in which both of the high-priority processing blocks output the access requests to designate the given bank, the high-priority processing block (the imaging input unit 222 according to the sixth embodiment) whose access requests are not accepted by the memory controller 260 further changes the designation sequence of the banks. Accordingly, in the memory access device according to the sixth embodiment of the present invention, it is not necessary to keep the acceptance of the access requests from the imaging input unit 222 waiting until the bank-busy state of the given bank designated by the display-processing unit 252 is canceled. Accordingly, according to the memory access device according to the sixth embodiment of the present invention, the efficiency of the access to the DRAM 30 by each high-priority processing block can be improved, and the bus band width for both of the imaging input unit 222 and the display-processing unit 252 to access the DRAM 30 can be secured.

According to the sixth embodiment, the memory access device (memory access device 202) is configured to have the access selection unit (access selection unit 2222) which is configured to further change the designation sequence of the banks according to the changed operation information (bank-busy-state signal) during the period when the access requests output by the access selection unit is not accepted by the memory controller (memory controller 260).

As described above, the memory access device according to the sixth embodiment of the present invention is configured by combing each of the plurality of high-priority processing blocks and the memory controller 260. In the memory access device according to the sixth embodiment of the present invention, each of the high-priority processing blocks determines the designation sequence of the banks according to the bank-busy-state signals so as to not to designate the banks in the bank-busy-state (avoid the access to the banks in the bank-busy-state). At this time, in the memory access device according to the sixth embodiment of the present invention, even if the plurality of high-priority processing blocks output the access requests to designate the given bank, the high-priority processing block whose access request is not accepted by the memory controller 260 further changes the designation sequence of the banks. Accordingly, in the memory access device according to the sixth embodiment of the present invention, it is not necessary to keep the acceptance of the access requests with respect to the duplicated-designated bank waiting until the bank-busy state of the given bank is canceled. Accordingly, in the memory access device according to the sixth embodiment of the present invention, similar to the memory access device 200 according to the first embodiment, the efficiency of the access to the DRAM 30 by each high-priority processing block can be improved, and the bus bandwidth for each high-priority processing block to access the DRAM 30 can be secured.

As described above, the memory access device according to the sixth embodiment of the present invention is described using the configuration example of the two memory access devices including the memory access device configured by the combination of the imaging input unit 222 (high-priority processing block) and the memory controller 260 and the memory access device configured by the combination of the display-processing unit 252 (high-priority processing block) and the memory controller. However, in the memory access device according to the sixth embodiment of the present invention, similar to the memory access device according to the first embodiment, the high-priority processing block varies due to the operation mode of the imaging device 1. Accordingly, in the memory access device according to the sixth embodiment of the present invention, similar to the memory access device according to the first embodiment, the combination of the high-priority processing block and the memory controller 260 configuring the memory access device is not limited to the two combinations configuring the memory access device described above. In the memory access device according to the sixth embodiment of the present invention, similar to the memory access device according to the first embodiment, even if the memory access device is configured by the combination of different high-priority processing block and the memory controller 260, the operation thereof can be easily considered according to the operations of the two memory access devices described above.

In the memory access device according to the sixth embodiment of the present invention, regarding the configuration of the plurality of high-priority processing blocks, it is described that in the case in which the plurality of high-priority processing blocks output the access requests to designate the given bank, the high-priority processing block whose access request is not accepted by the memory controller 260 further changes the designation sequence of the banks. However, the access requests with respect to the given bank are not generated only in the memory access device having the plurality of high-priority processing blocks. For example, in the case in which the access requests from the low-priority processing block cannot be accepted for a long time, a defect may occur in the operation of the imaging device operating as a system since the processing of the low-priority processing block is not finished. Accordingly, it is considerable to change the priority of the low-priority processing block to be higher than that of the high-priority processing block so as to make the data transmission according to the access request of the low-priority processing block to have the highest priority. In this case, it is considerable that the low-priority processing block whose priority is raised and the high-priority processing block output the access requests to designate the given bank; however, by applying the scope of the memory access device according to the sixth embodiment of the present invention, the high-priority processing block can further change the designation sequence of the banks.

### (Memory Controller)

According to the first embodiment to the sixth embodiment of the present invention, the timing of noticing the operation information of the DRAM 30 (bank-busy-state signal and bank-busy count) output by the memory controller configuring the memory access device is not described. The predetermined processing time is necessary for the memory controller to arbitrate the access to the DRAM 30 and perform the actual data delivery with the DRAM 30. That is, predetermined delay period (time lag) occurs in the access to the DRAM 30 by the memory controller. Accordingly, the processing of changing the designation sequence of the banks by the memory access device according to the first embodiment to the sixth embodiment of the present invention may not be appropriately executed.

For example, even if the bank to be designated by the memory access device according to the first embodiment to the sixth embodiment of the present invention is in the bank-busy state at the present time, it is possible that the bank-busy state is canceled during the delay period (time lag) until the actual access to the DRAM 30. In this case, the high-priority processing block and the data transmission block configuring the memory access device according to the first embodiment to the sixth embodiment of the present invention can transmit the bank data to the DRAM 30 without changing the designation sequence of the banks, and it is not necessary to keep the access request waiting.

On the other hand, in the case in which the bank to be designated by the memory access device according to the first embodiment to the sixth embodiment of the present invention is not in the bank-busy state at the present time, it is possible that the bank enters the bank-busy state in response to the access requests from the low-priority processing block during the delay period (time lag) until the actual access to the DRAM 30. In this case, the actual access to the DRAM 30 is kept waiting until the bank-busy state is canceled even if the high-priority processing block and the data transmission block configuring the memory access device according to the first embodiment to the sixth embodiment of the present invention change the designation sequence of the banks.

Accordingly, a configuration configured to notice (output) the operation information of the DRAM 30 at the timing which is determined in consideration of the necessary processing time of each of the memory controller configuring the memory access device according to the first embodiment to the sixth embodiment of the present invention, that is, in consideration of the necessary processing time (time lag) of the actual access to the DRAM 30.

The operation of the memory controller configuring the memory access device according to the first embodiment to the sixth embodiment of the present invention will be described. As described above, the memory controller configuring the memory access device according to the first embodiment to the sixth embodiment of the present invention notices (outputs) the operation information of the DRAM 30 according to the processing time of the actual access to the DRAM 30. In the description below, the operation of the memory controller 260 configuring the memory access device according to the first embodiment of the present invention representing the memory controller configuring the memory access device according to the first embodiment to the sixth embodiment of the present invention will be described.

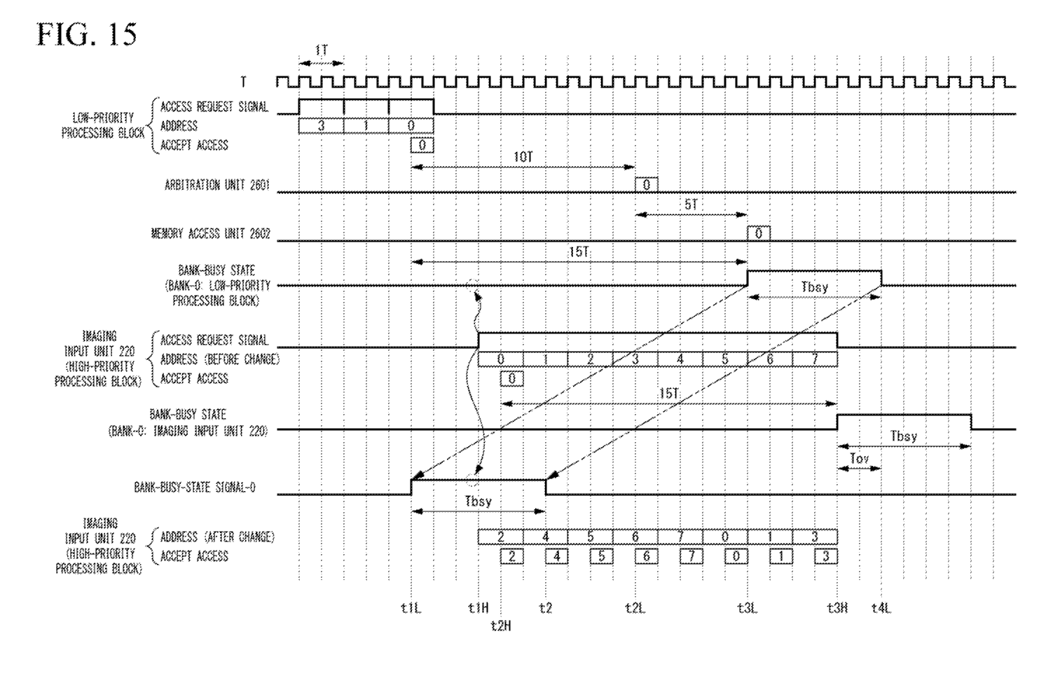

FIG. 15 is a timing chart showing the example of the operation timing of the memory controller (memory controller 260 configuring the memory access device according to the first embodiment of the present invention) configuring the memory access device according to the present invention. In FIG. 15, the examples of the timing when the DRAM 30 actually enters the bank-busy state and the timing when the memory controller 260 outputs the bank-busy-state signal are shown in the case in which the imaging input unit 220 as the high-priority processing block and the low-priority processing block (for example, the image-processing block 230 and the JPEG-processing block 240) output the access requests to the DRAM 30 by the DMA transmission. More specifically, in FIG. 15, the examples of the timing of the “access request signal” output at the time when the imaging input unit 220 and the low-priority processing block make the access requests to the DRAM 30, and the timing of the “address” for designating the banks are shown. Similar to the example in the timing chart in the memory access device 200 according to the first embodiment shown in FIG. 4, the access request signal at the “High” level indicates that the access to the DRAM 30 is requested, and the access request signal at the “Low” level indicates that the access to the DRAM 30 is not requested. In FIG. 4, the banks to which the access requests output from each of the imaging input unit 220 and the low-priority processing block and accepted by the memory controller 260 are shown as “ACCEPT ACCESS”. As described above, in the imaging input unit 220, the access selection unit 2202 equipped in the imaging input unit 220 changes the designation sequence of the banks according to the bank-busy-state signal output from the memory controller 260. Accordingly, in FIG. 15, similar to the example of the timing chart in the memory access device 200 according to the first embodiment shown in FIG. 4, as the addresses output by the imaging input unit 220, the addresses before the access selection unit 2202 changes the sequence are shown as the “ADDRESSES (BEFORE CHANGE)”, and the addresses after the access selection unit 2202 changes the sequence are shown as the “ADDRESSES (AFTER CHANGE)”. In FIG. 15, the timing when the arbitration unit 2601 configuring the memory controller 260 outputs the accepted information of the bank to the memory access unit 2602, and the timing when the memory access unit 2602 configuring the memory controller 260 controls the DRAM 30 according to the accepted information of the bank output from the arbitration unit 2601 are shown.

In FIG. 15, the timing when the bank of the DRAM 30 enters the bank-busy state in response to the control (access) with respect to the bank that is output from the memory controller 260 (more specifically, the memory access unit 2602) is shown. Regarding the bank-busy state of the bank in the DRAM 30, the “High” level indicates the bank-busy state, and the “Low” level indicates the state rather than the bank-busy state. In FIG. 15, the “bank-busy-state” signal output to the imaging input unit 220 by the memory controller 260 is shown. Regarding the bank-busy-state signal, similar to the example of the timing chart in the memory access device 200 according to the first embodiment shown in FIG. 4, the “High” level indicates the bank-busy state, and the “Low” level indicates the state rather than the bank-busy state.

In FIG. 15, a cycle of the time T at each timing is shown in the form of a clock signal. In the description below, the operation of the memory controller 260 will be described that the time (time lag) for the processing of arbitrating the access requests input by the arbitration unit 2601 is assumed to be 10T (10 clocks), and the time (time lag) for the processing of accessing the DRAM 30 by the memory access unit 2602 is assumed to be 5T (5 clocks). In the description below, in order to make the description easy to understand, the access to the bank-0 of the DRAM 30 will be focused.

Firstly, the operation in response to the access request from the low-priority processing block will be described. The arbitration unit 2601 outputs the accepted information of the bank-0 to the memory access unit 2602 at the timing t2L after the timing t1L by the time lag (equal to 10T), wherein the access request signal with respect to the bank-0 and output from the low-priority processing block is accepted at the timing t1L. Then, the memory access unit 2602 begins the control of the DRAM 30 at the timing t3L after the timing t2L by the time lag (equal to 5T). Accordingly, the bank-0 of the DRAM 30 enters the bank-busy state in response to the access request from the low-priority processing block and accepted by the memory controller 260 at the timing t3L. That is, the bank-0 of the DRAM 30 actually enters the bank-busy state at the timing t3L after the timing t1L when the access request signal with respect to the bank-0 and output from the low-priority processing block is accepted by the arbitration unit 2601, by the period (equal to 10T+5T, equal to 15T) of the sum of the time lags due to the arbitration unit 2601 and the memory access unit 2602.

Subsequently, the operation in response to the access request from the imaging input unit 220 will be described. As described above, the imaging input unit 220 changes the designation sequence of the banks according to the bank-busy-state signal output from the memory controller 260. At this time, assuming that the memory controller 260 outputs the actual bank-busy state of the bank-0 in the DRAM 30 as the bank-busy-state signal-0 corresponding to the bank-0 to the imaging input unit 220, the bank-busy-state signal-0 is at the “Low” level immediately before the timing t1H when the designation sequence of the banks is determined by the imaging input unit 220 so as to indicate that the bank-0 is not in the bank-busy state. Accordingly, the imaging input unit 220 outputs the access request signal for designating the bank-0 to the memory controller 260. In the case in which the memory controller 260 accepts the access request signal with respect to the bank-0, the bank-0 of the DRAM 30 actually enters the bank-busy state at the timing t3H after the timing t2H when the arbitration unit 2601 accepts the access request signal with respect to the bank-0 output from the imaging input unit 220 by the period (equal to 15T) of the sum of the time lags due to the arbitration unit 2601 and the memory access unit 2602.

Here, the bank-busy state of the bank-0 in the DRAM 30 due to accept the access request from the low-priority processing block is canceled at the timing t4L, that is, the bank-0 of the DRAM 30 is in the bank-busy state during the period Tbsy between the timing t3L to the timing t4L. The period Tbsy during when the bank-0 of the DRAM 30 is in the bank-busy state is the same in the case in which the access request from the imaging input unit 220 is responded. In this case, as shown in FIG. 15, with regard to the bank-0 of the DRAM 30 during the period Tov between the timing t3H and the timing t4L, the period of the bank-busy state in response to the access request from the low-priority processing block and the period of the bank-busy state in response to the access request from the imaging input unit 220 are duplicated. It means that the access request from the imaging input unit 220 is kept waiting unit the timing t4L.

As described above, when the memory controller 260 outputs the actual bank-busy state of the bank-0 in the DRAM 30 to the imaging input unit 220 as the bank-busy-state signal-0 corresponding to the bank-0, the imaging input unit 220 cannot appropriately execute the processing of changing the designation sequence of the banks.

Thus, as shown in FIG. 15, in consideration of the time lag due to the arbitration unit 2601 and the memory access unit 2602, the memory 260 advances the generation of the bank-busy state of the bank-0 in the DRAM 30 in response to the access request from the low-priority processing block and outputs the bank-busy-state signal-0. More specifically, the memory controller 260 outputs the bank-busy-state signal-0 indicating the bank-busy state during period from the timing t1L when the arbitration unit 2601 accepts the access request signal with respect to the bank-0 and output from the low-priority processing block to the timing t2 indicating the period Tbsy when the bank-0 of the DRAM 30 is in the bank-busy state. In other words, the memory controller 260 outputs the bank-busy-state signal-0 indicating the predetermined period (certain period equal to the period Tbsy) when the bank-0 is inaccessible from the timing t1L when the access request signal with respect to the bank-0 is accepted.

Accordingly, the bank-busy-state signal-0 is at the “High” level immediately before the timing t1H when the imaging input unit 220 determines the designation sequence of the banks, and the imaging input unit 220 can confirm that the bank-0 is in the bank-busy state. The imaging input unit 220 can change the designation sequence of the banks according to the bank-busy-state signal-0 output from the memory controller 260. That is, the imaging input unit 220 can change the designation sequence of the banks at the timing t1H so as to avoid the access to the bank-0 (postpone the access to the bank-0) and firstly designate the banks not in the bank-busy state indicated by the bank-busy-state signal. In FIG. 15, similar to the example of the timing chart of the memory access device 200 according to the first embodiment shown in FIG. 4, the example of the imaging input unit 220 designating each bank in the sequence from the bank-2 to the bank-4, the bank-5, the bank-6, the bank-7, the bank-0, the bank-1, and the bank-3 at last is shown.

In such a manner, the memory controller 260 generates and outputs the bank-busy-state signal at the advanced timing in consideration of the necessary processing time (time lag) of the actual access to the DRAM 30. That is, the memory controller 260 outputs the information of the bank which will be in the bank-busy state as the operation information of the DRAM 30. The operation of the DRAM 30 is also the information of the bank which is presently in the bank-busy state until the bank-busy state is canceled. Accordingly, the imaging input unit 220 as the high-priority processing block can appropriately execute the processing of changing the designation sequence of the banks by confirming whether the bank is in the bank-busy state at the timing of the actual access with respect to the DRAM 30 in advance.

In the description above, the operation of the memory controller 260 configuring the memory access device according to the first embodiment of the present invention is described representing the memory controller configuring the memory access device according to the first embodiment to the sixth embodiment of the present invention. However, in the memory controller configuring the memory access device according to the second embodiment to the sixth embodiment of the present invention, the operation thereof is the same. In the description above, the operation information of the DRAM 30 is described as the bank-busy-state signal; however, in the case in which the operation information of the DRAM 30 is the bank-busy count, it is possible to consider in the same manner. In the case in which the operation information of the DRAM 30 is the bank-busy count, the count value being subtracted as time passes is output from the timing when the bank-busy-state signal is generated and output in advance.

According to the present embodiment, the memory access device is configured to have the memory controller configured to output the operation information indicating the predetermined period (bank-busy state) when the given bank is inaccessible from the timing when the access request is accepted.

As described above, the memory controller configuring the memory access device according to the first embodiment to the sixth embodiment of the present invention is configured to generate and output the operation information of the DRAM 30 (bank-busy-state signal, bank-busy count) in advance, in consideration of the necessary processing time (time lag) of the actual access to the DRAM 30. Accordingly, the high-priority processing block configuring the memory access device according to the first embodiment to the sixth embodiment of the present invention can appropriately execute the processing of changing the designation sequence of the banks by confirming whether the bank is in the bank-busy state at the timing of the actual access with respect to the DRAM 30 in advance. Accordingly, in the memory access device according to the first embodiment to the sixth embodiment of the present invention, the bank-busy state of the bank designated in the access request by the high-priority processing block is canceled when the DRAM 30 is actually accessed, that is, the bank is in the immediately accessible state. Accordingly, in the memory access device according to the first embodiment to the sixth embodiment of the present invention, the efficiency of the access to the DRAM 30 by the high-priority processing block can be improved, and the bus band width can be secured.

As described above, according to the embodiments of the present invention, the memory controller configuring the memory access device of the present invention outputs the information (operation information) indicating the operation state of the connected DRAM to the high-priority processing block with a high priority and configuring the memory access device of the present invention. According to the embodiments of the present invention, the processing blocks having the high priority and configuring the memory access device of the present invention change the designation sequence of the banks of the connected DRAM according to the information indicating the operation state of the connected DRAM and being output by the memory controller configuring the memory access device of the present invention, when the access request with respect to the connected DRAM is output by the high-priority processing blocks. More specifically, according to the embodiments of the present invention, the processing blocks having the high priority and configuring the memory access device of the present invention determine the sequence (sequence of bank address) for accessing each bank included in the DRAM by the DMA transmission and output the access requests for requesting the data transmission with the DRAM in the determined sequence of the bank address so as to avoid the access with respect to the banks in the bank-busy state. Therefore, according to the embodiments of the present invention, the efficiency of the access to the DRAM 30 by the processing blocks having the high priority and configuring the memory access device of the present invention can be improved, and the bus band width for the data transmission with the DRAM can be secured. According to the embodiment of the present invention, performance of the image-processing device having the memory access device of the present invention can be secured. Also, according to the embodiment of the present invention, functions of the imaging device having the image-processing device with the memory access device of the present invention can be realized.

According to the embodiments of the present invention, it is described that the memory access device according to the present invention is included in the image-processing device equipped in the imaging device. However, the system having the memory access device configured to transmit the data with the DRAM can be configured by other various systems besides the image-processing device and the imaging device shown in the embodiments of the present invention. Accordingly, the processing device and the system being configured by the memory access device according to the scope of the present invention are not particularly limited. That is, the scope of the memory access device of the present invention can be applied to any processing device and system configured to transmit data with the DRAM. Also, the same effect as that of the memory access device according to the present invention can be achieved.

In the embodiments of the present invention, the memory controller configuring the memory access device of the present invention is described as the configuration to generate and output the information (operation information such as bank-busy-state signal, bank-busy count) indicating the operation state of the DRAM according to the control with respect to the DRAM in response to the access request output from the processing blocks. However, in the case in which the DRAM has the function of outputting the information indicating the operation state of the memory region (bank) of the DRAM 30, the information same with the information generated and output by the memory controller configuring the memory access device of the present invention may be generated inside the DRAM and output. In this case, the processing blocks with the high priority configuring the memory access device can change the designation sequence of the banks of the DRAM in the same manner with that of the processing blocks with the high priority configuring the memory access device of the present invention to achieve the same effect with that of the memory access device of the present invention.

The embodiments of the invention have been described above with reference to the drawings, but specific structures of the invention are not limited to the embodiments and may include various modifications without departing from the scope of the invention. The invention is not limited to the above-mentioned embodiments and is limited only by the accompanying claims.

What is claimed is:

1. A memory access device configured to control access to a memory by a plurality of processing blocks connected to a common data bus, wherein the plurality of processing blocks are configured to output access requests for requesting accesses to the memory whose address space is divided into a plurality of banks, comprising:
at least one processing block designated as a high-priority processing block configured to have a higher priority to perform a high priority processing than other processing blocks among the plurality of processing blocks;
a memory controller connected to the data bus, the memory controller being configured to control access to the connected memory in response to the accepted access requests while outputting operation information indicating an operation state of the memory; and
an access selection unit configured to change a designation sequence of the banks among the plurality of banks according to the operation information at the time when the high-priority processing block continuously accesses the plurality of banks of the memory and output the access requests of the high-priority processing block designating the banks among the plurality of banks in the changed sequence to the memory controller,
wherein the access selection unit is configured to further change the designation sequence of the banks according to the changing operation information during a period when the access requests output by the access selection unit are not accepted by the memory controller.

2. The memory access device according to claim 1, wherein the access selection unit is configured to change the designation sequence of the banks among the plurality of banks according to the operation information when the high-priority processing block continuously accesses each of the plurality of banks.

3. The memory access device according to claim 1,
wherein the memory controller is configured to output a plurality of operation information indicating the operation states of the memory, and
wherein the access selection unit is configured to change the designation sequence of the banks among the plurality of banks according to the plurality of operation information.

4. The memory access device according to claim 1, further comprises a buffer configured to temporarily store data transmitted between the high-priority processing block and the memory in correspondence with each of the plurality of banks and parallelly request transmission of the stored data in correspondence with each of the plurality of banks,
wherein the access selection unit is configured to change the designation sequence of the banks among the plurality of banks according to the operation information when the data is parallelly transmitted to the plurality of banks from the buffer as requested.

5. The memory access device according to claim 4, wherein the buffer and the access selection unit are configured in the high-priority processing block.

6. The memory access device according to claim 4, wherein the buffer and the access selection unit are configured outside of the high-priority processing block.

7. The memory access device according to claim 1, wherein the memory controller is configured to output the operation information indicating a predetermined period during which access to the given bank is unavailable after the access request is accepted.

8. The memory access device according to claim 1,
wherein the operation information indicates whether the bank is in a predetermined period during which access to the given bank is unavailable in each of the plurality of banks, and
wherein the access selection unit is configured to change the designation sequence of the banks among the plurality of banks so as to avoid the access to the bank which is in the predetermined period during which access to the given bank is unavailable according to the operation information.

9. The memory access device according to claim 1,
wherein the operation information indicates a necessary time until the predetermined period during which access to the given bank is unavailable elapses in each of the plurality of banks, and
wherein the access selection unit is configured to change the designation sequence of the banks among the plurality of banks according to the operation information so as to
refrain from avoiding the access to the given bank when the necessary time is shorter than a predetermined threshold value, and
avoid the access to the given bank when the necessary time is equal to or longer than the predetermined threshold value.

10. The memory access device according to claim 1,
wherein the memory controller comprises:
an arbitration unit configured to arbitrate the access requests output from the plurality of processing blocks; and
a memory access unit configured to control access to the memory in response to the access requests accepted by the arbitration unit, and
wherein the operation information is output by either or both of the arbitration unit and the memory access unit.

11. An image-processing device, comprising:
a plurality of processing blocks connected to a common data bus, the plurality of processing blocks being configured to output access requests for requesting accesses to a memory whose address space is divided into a plurality of banks, and at least one processing block among the plurality of processing blocks being designated as a high-priority processing block configured to have a higher priority to perform a high priority processing than other processing blocks among the plurality of processing blocks;
a memory controller connected to the data bus, the memory controller being configured to control access to the connected memory in response to the accepted access requests while outputting operation information indicating an operation state of the memory; and
an access selection unit configured to change a designation sequence of the banks among the plurality of banks according to the operation information at the time when the high-priority processing block continuously accesses the plurality of banks of the memory and output the access requests of the high-priority processing block designating the banks among the plurality of banks in the changed sequence to the memory controller,
wherein the access selection unit is configured to further change the designation sequence of the banks according to the changing operation information during a period when the access requests output by the access selection unit are not accepted by the memory controller.

12. An imaging device, comprising:
an image sensor configured to capture an object, generate an image signal and output the image signal;
an image-processing device configured to perform image processing with respect to the image signal so as to generate an image of the object;
a memory configured to store data processed during the image processing; and
a display configured to display the image of the object,
wherein the image-processing device comprising:
a plurality of processing blocks connected to a common data bus, the plurality of processing blocks being configured to output access requests for requesting accesses to a memory whose address space is divided into a plurality of banks, and at least one processing block among the plurality of processing blocks being designated as a high-priority processing block configured to have a higher priority to perform a high priority processing than other processing blocks among the plurality of processing blocks;
a memory controller connected to the data bus, the memory controller being configured to control access to the connected memory in response to the accepted access requests while outputting operation information indicating an operation state of the memory; and
an access selection unit configured to change a designation sequence of the banks among the plurality of banks according to the operation information at the time when the high-priority processing block continuously accesses the plurality of banks of the memory and output the access requests of the high-priority processing block designating the banks among the plurality of banks in the changed sequence to the memory controller, and
wherein the access selection unit is configured to further change the designation sequence of the banks according to the changing operation information during a period when the access requests output by the access selection unit are not accepted by the memory controller.
